(19) United States
(12) Patent Application Publication
(10) Pub. No.: US 2026/0156574 A1
(43) Pub. Date: Jun. 4, 2026

(54) ENERGY SAVINGS IN WIRELESS SYSTEMS VIA DISCONTINUOUS OPERATION

(71) Applicant: Samsung Electronics Co., Ltd., Suwon-si (KR)

(72) Inventors: Ebrahim MolavianJazi, San Jose, CA (US); Aristides Papasakellariou, Houston, TX (US); Hongbo Si, Allen, TX (US)

(21) Appl. No.: 19/378,219

(22) Filed: Nov. 3, 2025

Related U.S. Application Data
(60) Provisional application No. 63/722,999, filed on Nov. 20, 2024.

(51) Int. Cl. H04W 52/02; H04L 5/00; H04W 72/231; H04W 72/51

(52) U.S. Cl. CPC H04W 52/0235; H04L 5/0053; H04W 72/231; H04W 72/51

(57) ABSTRACT

Apparatuses and methods for energy savings in wireless systems via discontinuous operation. A method for a user equipment (UE) includes receiving first information for time resources and for frequency resources of candidates for a sequence-based downlink wake-up signal (DL WUS), receiving second information for a first search space set group (SSSG) and for a second SSSG, and receiving the candidates for the DL WUS within the time resources and within the frequency resources. The method further comprises determining whether a candidate from the candidates provides the DL WUS, stop physical downlink control channel (PDCCH) receptions based on the first SSSG and start PDCCH receptions based on the second SSSG, when the candidate provides the DL WUS, and continue the PDCCH receptions based on the first SSSG when the candidate does not provide the DL WUS.

### CROSS-REFERENCE TO RELATED AND CLAIM OF PRIORITY

The present application claims priority under 35 U.S.C. § 119(e) to U.S. Provisional Patent Application No. 63/722,999 filed on Nov. 20, 2024, which is hereby incorporated by reference in its entirety.

### TECHNICAL FIELD

The present disclosure relates generally to wireless communication systems and, more specifically, the present disclosure is related to apparatuses and methods for energy savings in wireless systems via discontinuous operation.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to energy savings in wireless systems via discontinuous operation.

In one embodiment, a method for a user equipment (UE) is provided. The method includes receiving first information for time resources and for frequency resources of candidates for a sequence-based downlink wake-up signal (DL WUS), receiving second information for a first search space set group (SSSG) and for a second SSSG, and receiving the candidates for the DL WUS within the time resources and within the frequency resources. The method further comprises determining whether a candidate from the candidates provides the DL WUS, stop physical downlink control channel (PDCCH) receptions based on the first SSSG and start PDCCH receptions based on the second SSSG, when the candidate provides the DL WUS, and continue the PDCCH receptions based on the first SSSG when the candidate does not provide the DL WUS.

In another embodiment, a UE is provided. The UE includes a transceiver configured to receive first information for time resources and for frequency resources of candidates for a sequence-based DL WUS, receive second information for a first SSSG and for a second SSSG, and receive the candidates for the DL WUS within the time resources and within the frequency resources. The UE further includes a processor operably coupled with the transceiver. The processor is configured to determine whether a candidate from the candidates provides the DL WUS. The transceiver is further configured to stop PDCCH receptions based on the first SSSG and start PDCCH receptions based on the second SSSG, when the candidate provides the DL WUS, and continue the PDCCH receptions based on the first SSSG when the candidate does not provide the DL WUS.

In yet another embodiment, a base station is provided. The base station includes a transceiver configured to transmit first information for time resources and for frequency resources of candidates for a sequence-based DL WUS, transmit second information for a first SSSG and for a second SSSG, and transmit the candidates for the DL WUS within the time resources and within the frequency resources. The base station further includes a processor operably coupled with the transceiver. The processor is configured to determine whether a candidate from the candidates provides the DL WUS. The transceiver is further configured to stop PDCCH transmissions based on the first SSSG and start PDCCH transmissions based on the second SSSG, when the candidate provides the DL WUS, and continue the PDCCH transmissions based on the first SSSG when the candidate does not provide the DL WUS.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure using orthogonal frequency division multiplexing (OFDM) according to embodiments of the present disclosure;

FIG. 6 illustrates an example of a receiver structure using OFDM according to embodiments of the present disclosure;

FIG. 7 illustrates an example encoding structure for a downlink control information (DCI) format according to embodiments of the present disclosure;

FIG. 8 illustrates an example decoding structure for a downlink control information (DCI) format according to embodiments of the present disclosure; and

FIG. 9 illustrates an example method performed by a UE in a wireless communication system according to embodiments of the present disclosure.

### DETAILED DESCRIPTION

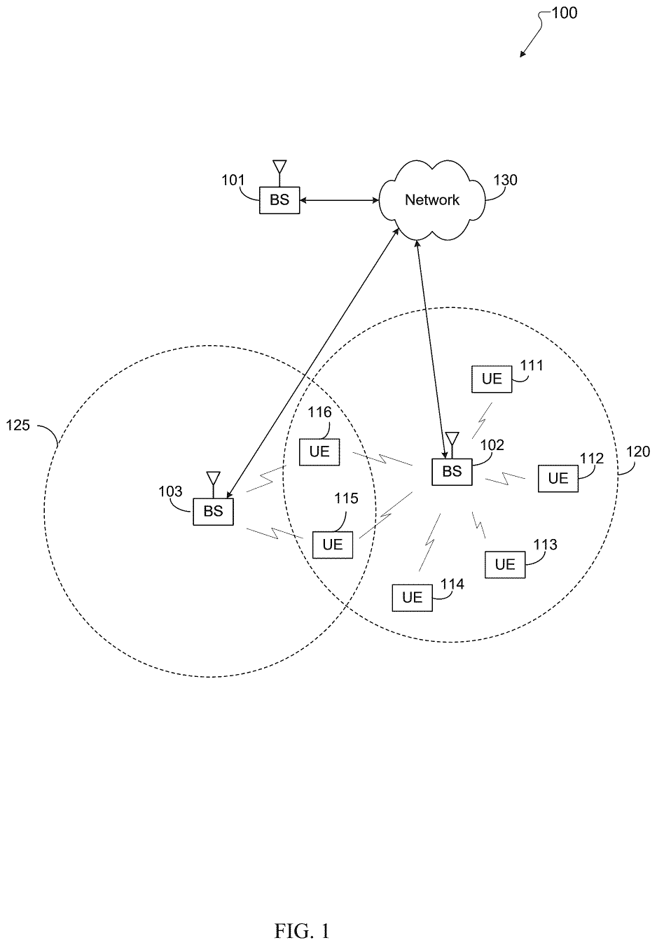

FIGS. 1-9, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [REF 1]3GPP TS 38.211 Rel-18 v18.4.0, “NR; Physical channels and modulation;” [REF 2]3GPP TS 38.212 Rel-18 v18.4.0, “NR; Multiplexing and channel coding;” [REF 3]3GPP TS 38.213 Rel-18 v18.4.0, “NR; Physical layer procedures for control;” [REF 4]3GPP TS 38.214 Rel-18 v18.4.0, “NR; Physical layer procedures for data;” [REF 5]3GPP TS 38.215 Rel-18 v18.4.0, “NR; Physical layer measurements;” [REF 6]3GPP TS 38.321 Rel-18 v18.3.0, “NR; Medium Access Control (MAC) protocol specification;” [REF 7]3GPP TS 38.331 Rel-18 v18.3.0, “NR; Radio Resource Control (RRC) protocol specification;” and [REF 8]3GPP TS 38.300 Rel-18 v18.3.0, “NR; NR and NG-RAN Overall Description; Stage 2.”

FIGS. 1-3 below describe various embodiments implemented in wireless communications systems and with the use of OFDM or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof to utilize energy savings in wireless systems via discontinuous operation. In certain embodiments, one or more of the gNBs 101-103 include circuitry, programing, or a combination thereof to support energy savings in wireless systems via discontinuous operation.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

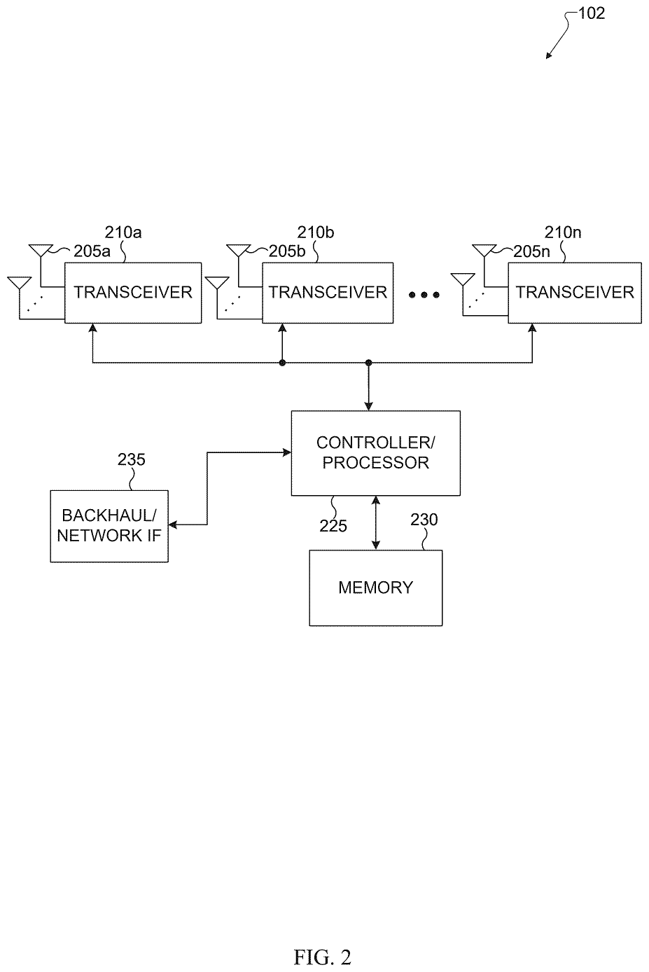

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting energy savings in wireless systems via discontinuous operation. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

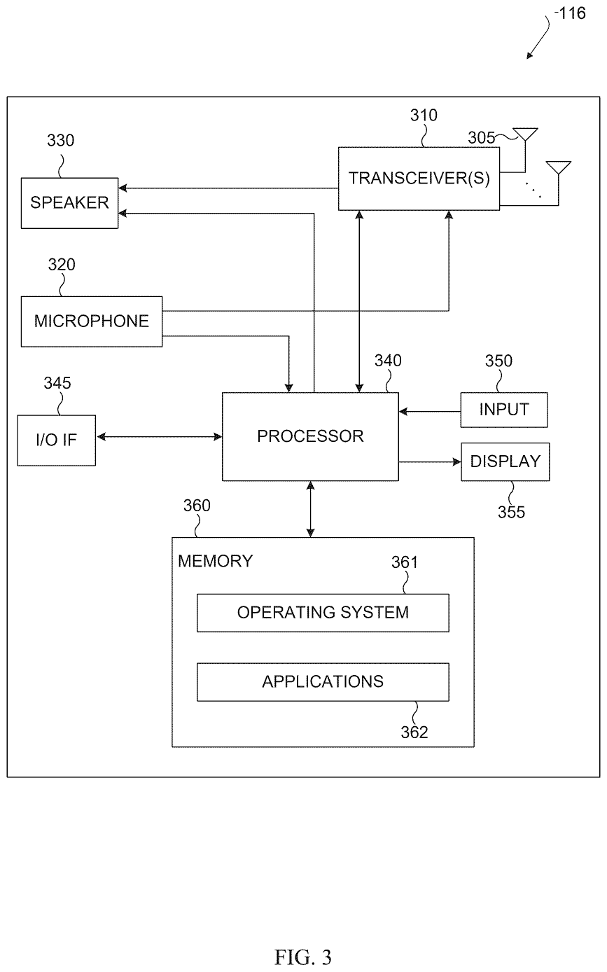

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to utilize energy savings in wireless systems via discontinuous operation as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include volatile memory such as a random-access memory (RAM), and another part of the memory 360 could include non-volatile memory a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

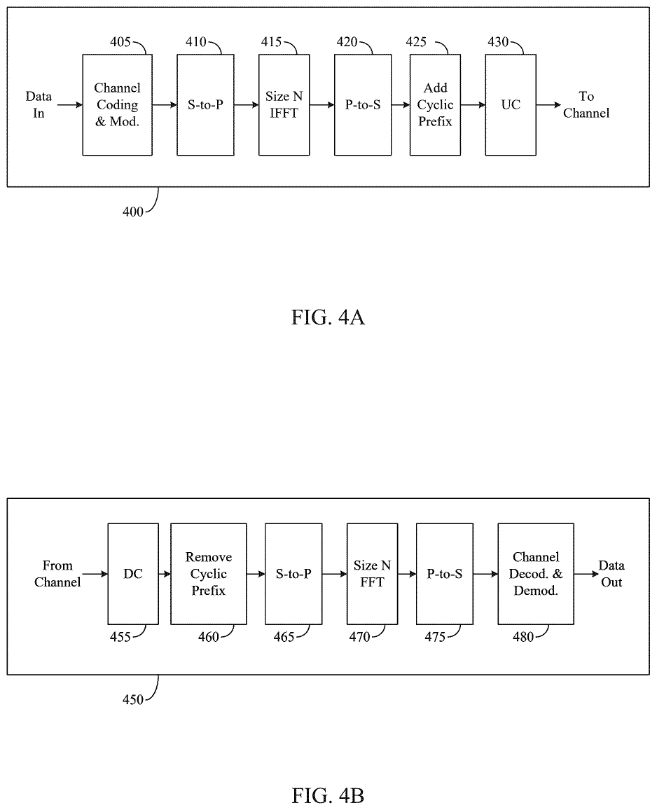

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured for energy savings in wireless systems via discontinuous operation as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted, and additional components can be added according to particular needs. Also, FIGS. 4A and 4B are meant to illustrate examples of the types of transmit and receive paths that can be used in a wireless network. Any other suitable architectures can be used to support wireless communications in a wireless network.

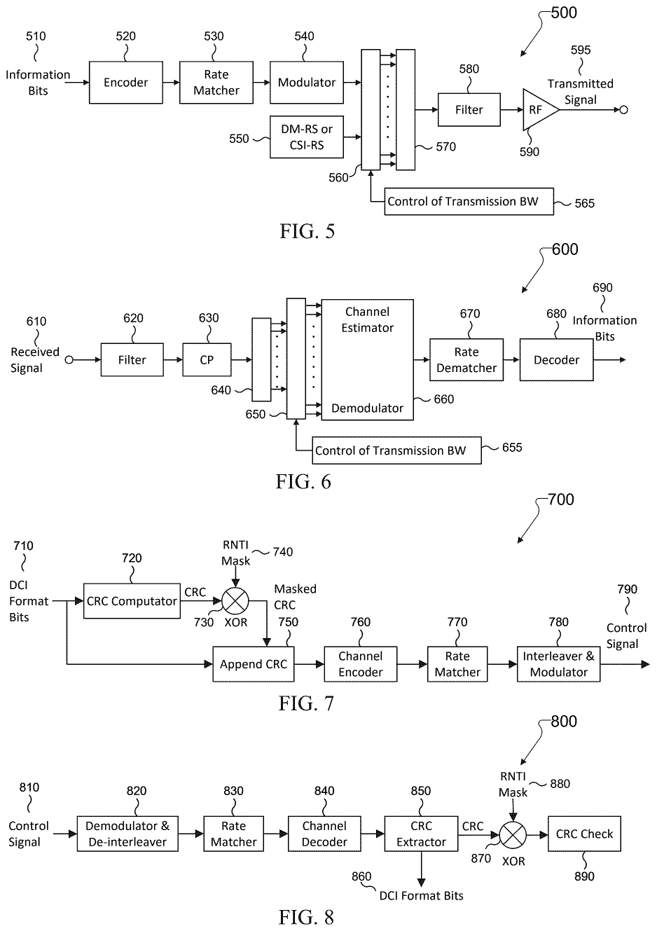

FIG. 5 illustrates an example of a transmitter structure 500 using OFDM according to embodiments of the present disclosure. For example, transmitter structure 500 using OFDM can be implemented in gNB 102 of FIG. 1. This example is for illustration only and other embodiments can be used without departing from the scope of the present disclosure.

Information bits, such as DCI bits or data bits 510, are encoded by encoder 520, rate matched to assigned time/frequency resources by rate matcher 530, and modulated by modulator 540. Subsequently, modulated encoded symbols and demodulation reference signal (DM-RS) or channel state information reference signal (CSI-RS) 550 are mapped to REs 560, an inverse fast Fourier transform (IFFT) is performed by filter 570. A BW selector unit 565, a filter 580, a radio frequency (RF) amplifier 590, and transmitted signal 595 are also included.

FIG. 6 illustrates an example of a receiver structure 600 using OFDM according to embodiments of the present disclosure. For example, receiver structure 600 using OFDM can be implemented by any of the UEs 111-116 of FIG. 1. This example is for illustration only and other embodiments can be used without departing from the scope of the present disclosure.

A received signal 610 is filtered by filter 620, a CP removal unit removes a CP 630, a filter 640 applies a fast Fourier transform (FFT), RE de-mapping unit 650 de-maps REs selected by BW selector unit 655, received symbols are demodulated by a channel estimator and a demodulator unit 660, a rate de-matcher 670 restores a rate matching, and a decoder 680 decodes the resulting bits to provide information bits 690.

With reference to FIG. 5, an example transmitter structure using OFDM according to this disclosure is shown.

With reference to FIG. 6, an example receiver structure using OFDM according to this disclosure is shown.

FIG. 7 illustrates an example encoding structure 700 for a downlink control information (DCI) format according to embodiments of the present disclosure. For example, encoding structure 700 can be implemented in gNB 102 of FIG. 1. This example is for illustration only and other embodiments can be used without departing from the scope of the present disclosure.

A gNB separately encodes and transmits each DCI format in a respective physical downlink control channel (PDCCH). When applicable, a radio network temporary identifier (RNTI) for a UE (e.g., the UE 116) that a DCI format is intended for masks a cyclic redundancy check (CRC) of the DCI format codeword in order to enable the UE to identify the DCI format. For example, the CRC can include 16 bits or 24 bits and the RNTI can include 16 bits or 24 bits. Otherwise, when a RNTI is not included in a DCI format, a DCI format type indicator field can be included in the DCI format.

The CRC of (non-coded) DCI format bits 710 is determined using a CRC computation unit 720, and the CRC is masked using an exclusive OR (XOR) operation unit 730 between CRC bits and RNTI bits 740. The XOR operation is defined as XOR(0,0)=0, XOR(0,1)=1, XOR(1,0)=1, XOR(1,1)=0. The masked CRC bits are appended to DCI format information bits using a CRC append unit 750. An encoder 760 performs channel coding, such as polar coding, followed by rate matching to allocated resources by rate matcher 770. Interleaving and modulation units 780 apply interleaving and modulation, such as QPSK, and the output control signal 790 is transmitted.

FIG. 8 illustrates an example decoding structure 800 for a DCI format according to embodiments of the present disclosure. For example, decoding structure 800 for a DCI format can be implemented by any of the UEs 111-116 of FIG. 1. This example is for illustration only and other embodiments can be used without departing from the scope of the present disclosure.

A received control signal 810 is demodulated and de-interleaved by a demodulator and a de-interleaver 820. A rate matching applied at a gNB transmitter is restored by rate matcher 830, and resulting bits are decoded by decoder 840. After decoding, a CRC extractor 850 extracts CRC bits and provides DCI format information bits 860. The DCI format information bits are de-masked 870 by an XOR operation with a RNTI 880 (when applicable) and a CRC check is performed by unit 890. When the CRC check succeeds (check-sum is zero), the DCI format information bits are regarded to be valid. When the CRC check does not succeed, the DCI format information bits are regarded to be invalid.

With reference to FIG. 7, an example encoding process for a DCI format according to this disclosure is shown.

With reference to FIG. 8, an example decoding process for a DCI format for use with a UE according to this disclosure is shown.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes hybrid automatic repeat request (HARQ) acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see NR specification), of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a time division duplexing (TDD) system, an SRS transmission can also provide a PMI for DL transmission. Additionally, in order to establish synchronization or an initial higher layer connection with a gNB, a UE can transmit a physical random-access channel (PRACH as shown in NR specifications).

In the following, unless otherwise noted, a parameter referenced in italics is provided by higher layers such as by RRC.

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as synchronization signal blocks (SSBs)) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are quasi co-location (QCL) with QCL type A, type D (when applicable) and average gain. The UE may further assume that no DM-RS collides with the SS/PBCH block.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

The UE receives a MAC-CE activation command to map up to [N] (e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot

$$( n + 3 {N}_{slot}^{subframe , μ} ) .$$

In some examples, the term ‘beam’ is used to refer to a spatial filter for transmission or reception of a signal or a channel. For example, a beam (of an antenna) can be a main lobe of the radiation pattern of an antenna array, or a sub-array or an antenna panel, or of multiple antenna arrays, sub-arrays or panels combined, that are used for such transmission or reception. In various examples, a beam such as a Tx beam or an Rx beam is referred to as a spatial filter, such as a spatial transmission filter or a spatial reception filter.

In the following and throughout the disclosure, various embodiments of the disclosure may be also implemented in any type of UE including, for example, UEs with the same, similar, or more capabilities compared to 5G NR UEs. Although various embodiments of the disclosure discuss 3GPP 5G NR communication systems, the embodiments may apply in general to UEs operating with other RATs and/or standards, such as next releases/generations of 3GPP, IEEE WiFi, and so on.

In the following, unless otherwise explicitly noted, providing a parameter value by higher layers includes providing the parameter value by MIB or a system information block (SIB), such as a SIB1, or by a common RRC signaling, or by UE-specific RRC signaling.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with SCells or additional secondary cell groups (SCGs) by an IE ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of an master cell group (MCG) or secondary cell group (SCG). A TDD UL-DL frame configuration designates a slot or symbol as one of types ‘D’, ‘U’ or ‘F’ using at least one time-domain pattern with configurable periodicity.

In the following, for brevity of description, slot format indication (SFI) refers to a slot format indicator as example that is indicated using higher layer provided IEs such as slotFormatCombination or slotFormatCombinationsPerCell and which is indicated to the UE by group common DCI format such as DCI F2_0 where slotFormats are defined in [REF3, TS 38.213].

The Synchronization Signal and PBCH block (SSB) includes primary and secondary synchronization signals (PSS, SSS), each occupying 1 symbol and 127 subcarriers, and PBCH spanning across 3 OFDM symbols and 240 subcarriers, but on one symbol leaving an unused part in the middle for SSS. The possible time locations of SSBs within a half-frame are determined by sub-carrier spacing and the periodicity of the half-frames where SSBs are transmitted is configured by the network. During a half-frame, different SSBs may be transmitted in different spatial directions (i.e., using different beams, spanning the coverage area of a cell).

Within the frequency span of a carrier, multiple SSBs can be transmitted. The physical cell IDs (PCIs) of SSBs transmitted in different frequency locations do not have to be unique, i.e. different SSBs in the frequency domain can have different PCIs. However, when an SSB is associated with an remaining minimum system information (RMSI), the SSB is referred to as a Cell-Defining SSB (CD-SSB). A PCell is associated to a CD-SSB located on the synchronization raster.

Polar coding is used for PBCH. The UE may assume a band-specific sub-carrier spacing for the SSB unless a network (e.g., the network 130) has configured the UE to assume a different sub-carrier spacing. PBCH symbols carry its own frequency-multiplexed demodulation reference signal (DMRS). QPSK modulation is used for PBCH.

Measurement time resource(s) for SSB-based reference signal received power (RSRP) measurements may be confined within a SSB Measurement Time Configuration (SMTC). The SMTC configuration provides a measurement window periodicity/duration/offset information for UE radio resource management (RRM) measurement per carrier frequency. For intra-frequency connected mode measurement, up to two measurement window periodicities can be configured. For RRC_IDLE, a single SMTC is configured per carrier frequency for measurements. For inter-frequency mode measurements in RRC_CONNECTED, a single SMTC is configured per carrier frequency. Note that if RSRP is used for L1-RSRP reporting in a CSI report, the measurement time resource(s) restriction provided by the SMTC window size is not applicable. Similarly, measurement time resource(s) for received signal strength indicator (RSSI) are confined within SMTC window duration. If no measurement gap is used, RSSI is measured over OFDM symbols within the SMTC window duration. If a measurement gap is used, RSSI is measured over OFDM symbols corresponding to overlapped time span between SMTC window duration and minimum measurement time within the measurement gap.

Link adaptation (AMC: adaptive modulation and coding) with various modulation schemes and channel coding rates is applied to the PDSCH. The same coding and modulation is applied to groups of resource blocks belonging to the same L2 protocol data unit (PDU) scheduled to one user within one transmission duration and within a MIMO codeword.

For channel state estimation purposes, the UE may be configured to measure CSI-RS and estimate the downlink channel state based on the CSI-RS measurements. The UE feeds the estimated channel state back to the gNB to be used in link adaptation.

Measurement reports are required to enable the scheduler to operate in both uplink and downlink. These include transport volume and measurements of a UEs radio environment.

Cell search is the procedure by which a UE acquires time and frequency synchronization with a cell and detects the Cell ID of that cell. NR cell search is based on the primary and secondary synchronization signals, and PBCH DMRS, located on the synchronization raster.

The Master Information Block (MIB) on PBCH provides the UE with parameters (e.g. CORESET #0 configuration) for monitoring of PDCCH for scheduling PDSCH that carries the System Information Block 1 (SIB1). PBCH may also indicate that there is no associated SIB1, in which case the UE may be pointed to another frequency from where to search for an SSB that is associated with a SIB1 as well as a frequency range where the UE may assume no SSB associated with SIB1 is present. The indicated frequency range is confined within a contiguous spectrum allocation of the same operator in which SSB is detected.

System Information (SI) includes a MIB and a number of SIBs, which are divided into Minimum SI and Other SI (OSI):
Minimum SI comprises basic information required for initial access and information for acquiring any other SI. Minimum SI includes:
   MIB contains cell barred status information and essential physical layer information of the cell required to receive further system information, e.g., CORESET #0 configuration. MIB is periodically broadcast on BCH.
   SIB1 defines the scheduling of other system information blocks and contains information required for initial access. SIB1 is also referred to as Remaining Minimum SI (RMSI) and is periodically broadcast on DL-SCH or sent in a dedicated manner on DL-SCH to UEs in RRC_CONNECTED.
Other SI (OSI) encompasses SIBs not broadcast in the Minimum SI. Those SIBs can either be periodically broadcast on DL-SCH, broadcast on-demand on DL-SCH (i.e., upon request from UEs in RRC_IDLE, RRC_INACTIVE, or RRC_CONNECTED), or sent in a dedicated manner on DL-SCH to UEs in RRC_CONNECTED (i.e., upon request, if configured by the network, from UEs in RRC_CONNECTED or when the UE has an active BWP with no common search space configured or when the UE configured with inter cell beam management is receiving DL-SCH from a TRP with PCI different from serving cell's PCI).

Paging allows the network to reach UEs in RRC_IDLE and in RRC_INACTIVE state through Paging messages, and to notify UEs in RRC_IDLE, RRC_INACTIVE and RRC_CONNECTED state of system information change and ETWS/CMAS indications through Short Messages. Both Paging messages and Short Messages are addressed with paging RNTI (P-RNTI) on PDCCH, but while the former is sent on paging control channel (PCCH), the latter is sent over PDCCH directly (see clause 6.5 of TS 38.331).

The present disclosure recognizes that existing designs in 5G NR include multiple frameworks with different signaling for realizing the objective of UE power saving (UEPS) or network energy saving, while detailed signaling and UE procedures are partially inconsistent, and in cases not efficient.

For example, DRX operation such as UE C-DRX (or possibly also I-DRX or e-DRX) operation mostly depends on RRC configuration with limited dynamic adaptation, or PDCCH skipping designs that are L1-based have certain limitations such as no efficient support for cell-group indication/operation, or limited consideration for CG PUSCH retransmission, or the necessity for indication or adaptation along with data scheduling. In addition, both PDCCH skipping and (to some extent, also) DRX mostly concern adaptation of PDCCH monitoring and do not fully consider adaptation of various other UE procedure that consume power.

Moreover, with DRX and PDCCH skipping, there is limited support for overriding previous UE power saving indications (such as DRX or PDCCH skipping), for example, when latency-sensitive services seek fast resumption of UE operation and PDCCH monitoring.

Accordingly, embodiments of the present disclosure recognize that there is a need to enhance and unify DRX and PDCCH skipping procedures to enable better adaptation with the UE traffic, more efficient and flexible signaling, and wider application to UE procedures beyond only PDCCH monitoring.

The present disclosure provides methods and apparatuses to enable increased UE power saving by adaptation and unification of DRX and PDCCH skipping procedures.

The embodiments may apply to any deployments, verticals, or scenarios including in FR1, FR2 (FR2-1), FR3, FR4 (or FR2-2), with eMBB, URLLC and HoT, mMTC and IoT including LTE NB-IoT or NR IoT or Ambient IoT (A-IoT), with AI/ML operation, with sidelink/V2X communications, in unlicensed/shared spectrum (NR-U), for non-terrestrial networks (NTN), for aerial systems such as unmanned aerial vehicles (UAVs) such as drones, for private or non-public networks (NPN), for operation with reduced capability (RedCap) UEs, multicast broadcast services (IBS), with integrated sensing and communication (ISAC) operation, and so on.

Various methods and examples throughout the present disclosure are generally described without reference to an RRC state or with reference to a certain RRC state. Such methods or examples can apply to a UE in various RRC states, such as RRC Connected mode/state or to a UE in IDLE/INACTIVE mode/state or a UE performing initial/random access before camping on a cell or before establishing RRC configuration. For example, various procedures can be based on signaling from MIB or SIB such as SIB1 or other SIBx (x>1), instead of RRC configuration. For example, various procedures can be based on signaling from other higher layer signaling, such as an RRC configuration that the UE receives during RRC connection or at a time for RRC connection suspension/release before the UE transitions to RRC IDLE/INACTIVE state.

Various methods or examples are described in terms of “SSB”. Such methods or examples can apply based on any other synchronization signal, such as only PSS or only SSS or only PSS+SSS, without a broadcast channel such as PBCH, or other SSB variations in 6G radio (6GR), wherein the PSS or SSS or PBCH can be same as or different from those in 5G NR, such as with different periodicity, or different sequence generation/parameters, or different number of RBs, or different structure/patterns, and so on. Such methods or examples can apply based on other synchronization signal, such as cell-defining SSB (CD-SSB), or non-cell-defining SSB (NCD-SSB), or tracking reference signal (TRS) or discovery reference signal (DRS) or low-power synchronization signal (LP-SS), or variations or combinations thereof.

Various methods or examples are described in terms of “configuration” or “indication” or “higher layer signaling”, or variations or combinations of such terms. Such methods or example can be based on system information such as MIB/SIB/SIB1/SIBx (x>1) or based on RRC signaling, such as cell-specific RRC or UE-group-specific RRC or dedicated/UE-specific RRC, wherein such attributes can correspond to one or both of information contents of RRC message or signaling methods of the RRC message.

Various methods or examples are described in terms of “L1/L2 signaling” or “indication”, or variations or combinations of such terms. Such methods or examples can be based on signaling or indication by an L2/MAC signaling such as a MAC-CE or by an L1/PHY signaling, such as a PDCCH/DCI format that can be cell-specific or UE-group-specific or UE-specific, or such as other DL/UL channels, such as PDSCH or PUSCH or PUCCH, or such as a sequence-based signal, for example, a DL WUS/LP-WUS/DRS, that can be cell-specific or UE-group-specific or UE-specific, and so on.

Various methods or examples throughout the present disclosure are described in terms of “cell” or “cells” or variations thereof. Herein, cells can refer to one or more serving cell, or one (or more) camped cells, or one or more non-serving cells or non-camped cells, such as neighbor cells, or candidate cells, such as for inter-cell beam management procedures, or for mobility/LTM procedures, or for CSI/RRM/mobility/handover procedures, and so on. Herein, cells can include various types or functionalities of cells, such as a PCell or an SCell or a coverage cell/carrier or an anchor cell/carrier or a non-anchor cell/carrier or a capacity or date cell/carrier or a multi-carrier cell possibly over fragmented spectrum or possibly over contiguous/non-fragmented spectrum. For example, cells can include DL-only cells or UL-only cells or DL+UL cells, or cells with asymmetric or flexible DL/UL association or decoupling, such as a cell with DL receptions on a first number of frequency carriers/bands/ranges and with UL transmissions on a second number of frequency carriers/bands/ranges, and wherein such first and second number of frequency carriers/bands/ranges may be predetermined or can be configured by higher layers or can be indicated or updated by L1/L2 signaling or based on timers or counters. For example, a cell can be associated with a single TRP or multiple TRPs, such as one or multiple central units (CUs) or distributed units (DUs) or remote/radio/RF units (RUs) or antenna units (AUs), and so on. For example, various methods or examples described in terms of cells can also apply with “cell” replaced by “carrier” or “TRP” or other frequency/spatial NW entity and so on.

Various procedures or examples are described in terms of PCells. Such procedures or examples can also apply to other cells, such as SCells, PSCells, SPCells, PUCCH SCells, special SCells (sSCells), coverage cells/carriers or capacity cells/carriers. For example, a UE can have a separate DL PCell and an UL PCell that can be on different frequency carriers/bands/ranges. For example, functionalities of various cells can be predetermined in the specifications of system operation or can be configured by higher layers. For example, MIB or SIB or RRC can configured whether or not a certain method or procedure or signaling is supported on a cell. Therefore, various restrictions that a certain DL/UL signal or channel applies to only certain cells, such as only a PCell, may be void or may be predetermined in the specifications of system operation or may be enabled or disabled by higher layers or may also apply to other cells, such as SCells, possibly when enabled by higher layer signaling.

While procedures and examples in the present disclosure are described in terms of DRX such as UE DRX/UE C-DRX, various procedures and examples can also apply to other DRX or DTX operations, such as Cell DTX/DRX operation.

Various methods and examples throughout the present disclosure are described in terms of a WUS, such as a sequence-based WUS, for example, a low-power WUS (LP-WUS) based on OOK waveform or based on OFDM-overlaid OOK waveform or an OOK-overlaid OFDM waveform. Such methods and examples can apply wherein the WUS is a sequence-based DL WUS based on OFDM waveform or wherein the WUS is a channel-coding-based WUS, for example, a PDCCH-based WUS (throughout the present disclosure, the terms channel-coding-based WUS and PDCCH-based WUS are used interchangeably). For example, the DL WUS can be based on a synchronization signal, such as PSS or SSS or PSS+SSS, based on 5G NR designs or other variations such as for 6GR, or can be based on other synchronization sequences or can be based on the sequences or signals, such as m-sequence, or pseudo-random sequence, or ZC sequence, or golden sequence, or other sequences. For example, DL WUS may include built-in timing, such as a sequence parameter, that indicates a time/frequency correction, such as a symbol/slot index modulo M or an RE/RB index module N, wherein M and NR have predetermined values or are configured by higher layers. Therefore, the UE can use such correction term to achieve finer granularity time/frequency synchronization. In another example, DL WUS can may accompany a separate synchronization signal, such as a PSS or an SSS or an SSB or an LP-SS or a TRS that is adjacent in time/frequency domain to (e.g., immediately consecutive symbols or RBs, before or after) the DL WUS, that can be TDM or FDM with the DL WUS, or possibly with a predetermined or configured time-domain or frequency domain gap. For example, the UE can receive the DL WUS together such separate synchronization signal.

When using a DL WUS/LP-WUS, information can be carried on various sequence/signal parameters, such as:
root sequence index, scrambling, randomization or hash function, amplitude/phase/frequency or corresponding offsets or shift or delay or scaling, including small shift or large shift, cyclic shift, cover code including orthogonal cover code (OCC), correlation or auto-correlation parameters such as auto-correlation zone, and so on, or
time or frequency resources or resource sets or candidate resources for such DL WUS/LP-WUS, or such as periodicity or frame/slot/symbol offset, monitoring occasions, or RB/RE level offset, for the corresponding time/frequency resources, or
power domain parameters, for example, EPRE, or relative EPRE with respect to EPRE of sync signal or of PSS/SSS or of LP-SS or of CSI-RS, and so on, or
spatial domain association for the DL WUS/LP-WUS such as spatial domain filter, or spatial filter, or same QCL assumption relative to a sync-signal index or an SSB index or an LP-SS index, or a CSI-RS or an SRS or a tracking reference signal (TRS) or a discovery reference signal (DRS), and so on.

Information contents/fields or number of information payload for LP-WUS, sequence-based DL WUS, and PDCCH-based WUS can be same in one option, while in another option different signaling mechanisms can accommodate different sizes or different fields. In addition, some (limited size) data payload may be included or multiplexed or modulated on one or more of such WUS. Such field or data can correspond to a single UE or a single cell/carrier/TRP or can correspond to multiple UEs or multiple cells/carriers/TRPs, such as separate payload/data for different cells/UEs, or a same/shared payload or data applicable to a group or sub-group of UEs or a group or sub-group of cells/carriers/TRPs.

For example, to improve UE energy efficiency, the UE may use only certain radio components, such as certain RF/baseband components, to receive the sequence-based WUS or the PDCCH-based WUS, while some other radio/RF/baseband components are switched off or operating in energy-efficient mode. For example, to improve network (NW) energy efficiency, the NW may use only certain radio components, such as certain RF/baseband components, to transmit the sequence-based WUS or the PDCCH-based WUS, while some other radio/RF/baseband components are switched off or operating in energy-efficient mode.

Various methods and examples throughout the present disclosure are described in terms of a WUS in relation with a DRX/DTX procedure, such as a UE DRX/DTX procedure or a Cell DTX/DRX procedure, for example for indicating or modifying parameters of such DTX/DRX procedures. Such methods or examples can apply wherein the WUS operates independent of such DRX/DTX procedure, for example, when start or resumption or stop or termination of various UE/cell procedures or UE/cell states is based on reception of or indication by such WUS, possibly without any DRX/DTX procedure, or in addition to or independent of such DRX/DTX procedures. Herein, UE/cell procedures can include one or more of: PDCCH monitoring or RRM measurement or CSI measurement or reporting (including CSI for link adaptation, CSI for beam management, CSI for channel/interference/mobility measurement, and so on) or SPS PDSCH reception or CG PUSCH transmission or RACH procedure or SRS transmission, and so on. Herein, UE/cell states can include cell activation or deactivation or dormancy or other high-power/performance state of UE/cell or energy-efficient state of UE/cell, and so on, wherein a state for a cell/carrier/UE can configure or indicate which signals/channels/transmissions/receptions are performed (for example, with nominal/full UE capability), or which other signals/channels/transmissions/receptions are disabled or suspended or adapted in time/frequency/spatial/power/code/sequence domains.

Various methods or examples throughout the present disclosure are described in terms of timing durations associated with a DRX procedure or timing durations associated with a PDCCH skipping procedure, such as “outside DRX active time” or “within a PDCCH skipping time duration”, and so on. Such methods or examples can apply to time durations for various other procedures or operation modes/states, for example, a time duration associated with a cell/UE with high/full power or performance operation mode or a time duration associated with a cell/UE with energy-efficient operation mode, such as a “dormancy period” or a “deactivation period” and so on. Such UE procedures or operation modes/states or associated time durations can be configured by higher layer signaling or can be indicated by L1/L2 signaling, such as a MAC-CE or a DCI or a sequence-based RS such as a WUS, or can be based on start/stop/resumption/reset/expiry of corresponding timers or counters.

Embodiments of the disclosure are summarized in the following and are fully elaborated further below. Combinations of the embodiments are also applicable but are not described in detail for brevity.

Various embodiments, methods, and examples in the present disclosure are described in terms of downlink control channel, such as PDCCH/DCI. Similar methods can apply to various other downlink or uplink channels or signals, such as PUCCH/UCI, PRACH, SSB, CSI-RS, SRS, and so on. For example, for PUCCH transmission, one or more of 16-QAM or 64-QAM or other modulation types or modulation orders may be supported for PUCCH reception, in addition to or as an alternative for QPSK modulation. For example, for a UE in RRC_CONNECTED mode, the UE can be configured/indicated which modulation type/order to apply for a PUCCH resource or resource set, at least for dedicated PUCCH resources. For example, for a UE before RRC connection, or for a UE in IDLE/INACTIVE state operation, or for common PUCCH resources, the UE may only use QPSK for PUCCH transmission, or may be provided pre-configuration for an applicable modulation type/order, or the UE may receive a cell-specific or UE-group-specific L1/L2 signaling, such as a paging DCI format or a WUS PDCCH or a sequence-based WUS, to indicate an applicable modulation type/order.

In one embodiment (related to L1/L2 signaling to indicate DRX parameters), a UE can be provided L1/L2 signaling to indicate or update/overwrite parameters of a UE DRX procedure, including at least one or both of a DRX-ON timer and DRX Inactivity timer. Such UE procedure can be beneficial, for example, to adapt the DRX pattern with the traffic pattern. L1/L2 signaling can include a GC-DCI format, such as DCI format 2_6 (or a different GC-DCI format), or a DL signal such as an LP-WUS or a DL WUS, that provides indication of wake-up/no-wake-up for next DRX cycles and/or information of DRX parameters, possibly also including jointly or separately information for or indication of PDCCH skipping or SSSG switching or adaptation or ON/OFF for CORESEs or TRPs or indication or update of cell state as subsequently described. Alternatively, such information can be provided in a UE-specific, scheduling DCI format, such as by a PDCCH adaptation field that jointly indicates both or various combinations of PDCCH skipping and/or SSSG switching indication as well DRX parameter indication, possibly including other adaptations, such as CORESET parameter adaptation or CORESET group/TRP adaptation or cell state adaptation, while in another option separate fields may be used for indication or update of one or more of DRX parameter update/indication, PDCCH skipping, SSSG switching, CORESET adaptation, CORESET group/TRP adaptation, or cell state adaptation. Various of the aforementioned methods may also include L1/L2 indication of associated CORESET parameters. The UE may provide HARQ-ACK information in response to such L1/L2 signaling. The UE can apply the DRX parameters indicated by L1/L2 signaling upon reception of such signaling, or after a processing time from a time of reception of the L1/L2 signaling or transmission of an associated HARQ-ACK.

In one embodiment (related to LP-WUS or DL WUS for indication or extension or termination of PDCCH skipping or DRX), a UE (at least in RRC_CONNECTED state, or possibly also for RRC_IDLE or RRC_INACTIVE state) can receive an LP-WUS or a sequence-based DL WUS (or possibly a PDCCH-based WUS such as a GC-DCI format or a DCP) for the purpose of PDCCH monitoring adaptation, such as for indication or update of PDCCH skipping or indication of search space set group (SSSG) switching or for indication of ‘wake-up’ or ‘no-wake-up’ for a configured DRX procedure in one or more next DRX cycles, or for indication of other adaptations, such as CORESET parameter adaptation, or CORESET group/TRP adaptation or disabling, or cell state indication/update/adaptation. A same/single DL WUS may indicate multiple of the aforementioned indications using different parameters/fields, or separate DL WUS occasions or separate DL WUS processes may provide one or more of such different indications. PDCCH skipping may indicate a certain number of slots or a certain time duration for no PDCCH monitoring (and possibly various other DL/UL transmission), or may indicate that PDCCH monitoring (and possibly various other DL/UL transmission) is suspended until a next L1/L2 indication such as a DL WUS or an LP-WUS is received that indicates start/resumption of PDCCH monitoring. An LP-WUS or DL WUS may also apply as a ‘forced ON’ indication to override a configured DRX or previously configured/indicated DRX parameters or a previously indicated PDCCH skipping, such that LP-WUS can trigger the UE to terminate a DRX cycle (e.g., corresponding inactive time) or a PDCCH skipping duration, and start PDCCH monitoring as if start of a next DRX cycle (e.g., corresponding Active time) or as if no PDCCH skipping. An LP-WUS or a DL WUS can, additionally or alternatively, indicate termination of Active/ON duration for PDCCH monitoring, such as Active/ON duration of UE DRX, upon reception of such indication by the LP-WUS or DL WUS. In another variation, regardless of whether or not a DRX procedures is configured or activated, a DL WUS may be monitored separate from/independent of DRX procedure, for example, to indicate start/resumption of PDCCH monitoring (and possibly various other DL/UL transmissions). When a UE does not receive an LP-WUS or DL WUS in a configured monitoring occasion for LP-WUS, the UE can operate PDCCH monitoring per search space set configurations and per the configured DRX procedure or per an indicated PDCCH skipping, or per a previously configured or indicated search space sets or SSSG or per a default/reference SSSG such as SSSG with index 0. Alternatively, the UE can continue to apply a last indication of LP-WUS until a different indication is received in a later LP-WUS or in a different L1/L2 signaling. In another option, when the UE does not receive a DL WUS/LP-WUS, or when the UE receives a DL WUS/LP-WUS that indicates ‘no-wake-up’, a UE may not wake up from inactive time of DRX or from a previously indicated PDCCH skipping or from a previously configured or indicated dormant period/state. In a variation, an L1/L2 signaling may provide indication or update for parameters associated with monitoring of the same L1/L2 signaling, such as a DL WUS or an LP-WUS in a first occasion with first parameters providing an indication to monitor the DL WUS or the LP-WUS in second occasions or using second parameters, such as with increased or decreased periodicity. In a variation, when a UE starts PDCCH monitoring (and possibly other DL/UL transmissions) based on a ‘wake-up’ indication by a DL WUS/LP-WUS, the UE may stop or suspend monitoring of DL WUS/LP-WUS, or the UE may continue both PDCCH monitoring and DL WUS/LP-WUS monitoring.

In one embodiment (related to generalized indications by PDCCH skipping or DCP), a UE can receive a same signaling such as a same L1/L2 signaling, to indicate (jointly or separately) more than one UE power saving indications, such as more than one of DRX wake-up/no-wake-up, and PDCCH skipping, and SSSG switching. Such indications can include, additionally or alternatively, adaptation of CORESET parameters, CORESET groups/TRPs, or adaptation of cell state in time/frequency/spatial/power/code domains. In addition, the UE may receive such signaling at any time, or in monitoring occasions (MOs) in any time interval, such as within or outside DRX Active time, or within or outside a PDCCH skipping duration. Such signaling can be included in a GC-DCI format, or a scheduling DCI format that may or may not schedule a PDSCH reception or a PUSCH transmission, or a WUS such as an LP-WUS or an OFDM-based sequence-based DL WUS. Additionally, the signaling can provide an indication for a group of cells, and the UE applies the indication to the group of cells, or for a group of UEs and a UE applies a respective indication for the UE. In a variation, a UE can received a DCI format (e.g., a last DCI after a DL/UL buffer is empty) that indicates start of PDCCH skipping or start of DRX non-active time or start of a first cell state (with or without indication of a time duration or starting a corresponding timer or counter), while the UE can receive a DL WUS/LP-WUS to indicate start/resumption of PDCCH monitoring or start of Active time of DRX or start of a different/second cell state. In a variation, a UE can request start of PDCCH monitoring via an SR in a PUCCH or via a PRACH transmission, or the NW can indicate to the UE via a DL WUS or an LP-WUS to start or resume PDCCH monitoring, with or without indication of an applicable SSSG, and possibly also other UE procedures, e.g., measurements or activation of SPS PDSCH or CG PUSCH. The UE can continue PDCCH monitoring based on a first timer, for example until expiry of an ON timer that may or may not be extended by a second timer, such as an Inactivity timer, and/or until a field in a scheduling DCI (or a DCI without PDSCH/PUSCH scheduling or possibly a GC-DCI format) indicates to the UE to stop or suspend PDCCH monitoring and possibly also the aforementioned other UE procedures. The scheduling DCI can be a last DCI that completes serving of corresponding DL data for the UE or the UL buffer at the UE.

In one embodiment, various HARQ-related designs are provided for increased UE power saving, such as: (i) terminating an indicated PDCCH skipping due to HARQ retransmission of PUSCH such as a CG-PUSCH; (ii) inclusion of HARQ round-trip-time (RTT) in a timeline for terminating an indicated PDCCH skipping due to HARQ retransmission of PDSCH; and (iii) extending the DRX Active time for NACK values (and not for ACK values) associated with a PDSCH reception. Such methods can be extended beyond DRX or PDCCH skipping to generally any dormant period/state or any energy-efficient operation mode indicated by L1/L2 signaling such as a DCI or a DL WUS.

In one embodiment, transmission of a PUSCH, at least including a configured-grant PUSCH (CG PUSCH), can result in terminating a previously indicated PDCCH skipping (or generally terminating a previously indicated dormant period/state or an energy-efficient operation mode indicated by L1/L2 signaling such as a DCI or a DL WUS) and resuming PDCCH monitoring to monitor possible grants for a HARQ retransmission of the PUSCH/CG PUSCH. The UE resumes such PDCCH monitoring starting from a first slot that is after a certain time after the PUSCH/CG PUSCH transmission. The certain time can be based on HARQ-related timers, such as drx-HARQ-RTT-TimerUL (or another corresponding timer). In addition, such termination of PDCCH skipping to monitor possible grants for retransmissions of CG PUSCH can be enabled or disabled by RRC signaling or by an L1 signaling such as a DCI format that indicates PDCCH skipping, and may or may not apply to PDCCH other than PDCCHs for scheduling retransmissions of CG-PUSCH, such as PDCCHs for scheduling dynamically scheduled PUSCHs or for scheduling PDSCHs.

In one embodiment, when PDCCH skipping (or generally when terminating a dormant period or an energy-efficient operation mode indicated by L1/L2 signaling such as a DCI or a DL WUS) is terminated to monitor possible DL assignments for retransmissions of a PDSCH reception on a serving cell, at least including an SPS PDSCH, and if the UE does not successfully decode the PDSCH reception, the UE terminates the PDCCH skipping, starting from the beginning of a first slot that is after an expiry of a HARQ RTT timer, such as drx-HARQ-RTT-TimerDL (or another corresponding timer), for a HARQ process associated with the PDSCH reception. In a variation, whether or not to terminate PDCCH skipping due to HARQ retransmission of (SPS) PDSCH can be enabled or disabled based on higher layer signaling or based on an L1 signaling such as a DCI format or a DL WUS that indicates PDCCH skipping or that indicates the dormant/non-dormant period or state.

In one embodiment, the specifications of system operation can predetermine that a DRX Active time (or generally a dormant period/state or an energy-efficient operation mode indicated by L1/L2 signaling such as a DCI or a DL WUS) can be extended in response to a negative acknowledgement (NACK) for a PDSCH reception (such as SPS PDSCH), and not extended in response to a positive acknowledgement (ACK) associated with the PDSCH reception. In another example, whether or not such extension applies (e.g., in response to a NACK) can be enabled or disabled based on higher layer signaling or based on a WUS/GC-DCI/DL WUS/LP-WUS such as one that indicates the start/stop/update of DRX cycle or Active time or of the dormant/non-dormant period or state.

In one embodiment, outside DRX Active time or within a PDCCH skipping duration (or generally within a dormant period/state or an energy-efficient operation mode indicated by L1/L2 signaling such as a DCI or a DL WUS), a UE may suspend or adapt reception of DL reference signals or DL channels or DL channels or transmission of UL reference signals or UL channels that are configured on (an active DL/UL BWP of) a cell, such as a serving cell (or a camped cell or a non-serving cell, or a non-camped cell, such as a neighbor cell or a candidate cell or a group of cells) for the UE. Such disabling or adaptation can facilitate a broader framework for UE power saving, beyond only PDCCH monitoring, wherein various radio/PHY components can be set to power saving mode (e.g., low-power or turned off or adapted in time/frequency/spatial (T/F/S) domain or in power/code domain) in a time interval that can be referred to as a “dormant period” or in a UE/cell/carrier operation state the can be referred to as a “dormant” state or a generally a UE/cell/carrier state. Such dormant period or UE/cell/carrier state can be same as or an extension of a DRX Non-Active Time or of a time duration for PDCCH skipping, and corresponding start or stop or duration or parameters can be indicated or updated by L1/L2 signaling such as a DCI format or a WUS such as a DL WUS or LP-WUS. In addition, such dormant period or UE/cell/carrier state can be joint or separate from a “frequency-domain dormancy” or a “spatial-domain dormancy”, wherein certain or all DL/UL signals or channels are disabled for or adapted within a given frequency allocation, such as a BWP or a narrow-band (NB), or disabled for or adapted to a certain subset of beams or SSB indexes or TCI states or spatial relations. In a realization, a UE/cell/carrier state can include various such domains, including time/frequency/spatial/power/code/sequence domains, and can indicate enabling or disabling or adaptation of various DL/UL signals or channels or procedures. Such disabling or adaptation can apply to all or certain DL/UL reference signals or channels, with all or certain usage or configuration or associated with certain UE procedures. Such disabling or adaptation can be predetermined in the specifications of system operation or can be configured by higher layer signaling or can be indicated by L1/L2 signaling. Herein, adaptation of a DL/UL signal or channel or an UL signal or channel can refer to different parameters for reception or transmission of such DL/UL signal or channel, such as reception or transmission with reduced number of radio components/RF chains/receive antennas/transmit antennas or with reduced receive/transmit power levels, and so on. It can be specified or the UE can be configured by higher layers or indicated by L1/L2 signaling such as a DCI format or a sequence-based DL WUS or LP-WUS, to partially or fully override, suspend or cancel such disabling or adaptation, wherein (a) the UE can be triggered by the NW to receive or transmit some or all of such disabled or adapted DL/UL signals or channels periodically or for a number of occasions, and alternatively, or additionally, (b) the UE can initiate or request to receive or transmit some or all of such disabled or adapted DL/UL signals or channels periodically or for a number of occasions. Methods for disabling or adaptation of DL/UL reference signals are subsequently described herein, and methods for disabling DL/UL channels are subsequently described herein.

In one embodiment, outside DRX Active time or within a PDCCH skipping duration (or generally within a dormant period or an energy-efficient operation mode indicated by L1/L2 signaling such as a DCI or a DL WUS or an LP-WUS), a UE may suspend or adapt reception of some CSI-RS resources or resource sets (or corresponding CSI reporting) or transmission of some SRS resources or resource sets configured on (an active DL/UL BWP of) a cell, such as a serving cell (or a camped cell or a non-serving cell or a non-camped cell such as a neighbor cell or a candidate cell or a group of any such cells or a generic group of cells) for the UE. Such disabling or enabling/triggering or adaptation of CSI-RS reception/reporting or SRS transmission can be predetermined in the specifications of system operation, or can be based on higher layer signaling such as RRC, or can be based on L1/L2 signaling, for example, by a GC-DCI format for adaptation of DRX procedure, such as a DCI format 2_6 with CRC scrambled by PS-RNTI (DCP), or by a DCI format that indicates PDCCH skipping, or by a WUS such as a OFDM-based sequence-based DL WUS or an LP-WUS. Such disabling or adaptation can additionally or alternatively apply to other DL/UL signals, such as SSB, e.g., always-on SSB (AO-SSB) or on-demand SSB (OD-SSB), or TRS such as periodic TRS or aperiodic/on-demand TRS (AP-TRS or OD-TRS), or DL positioning reference signals (DL PRS), or discovery signal (DRS), or DL WUS/LP-WUS, or LP-SS, or other periodic or semi-persistent or aperiodic or on-demand DL/UL signals for synchronization or measurement and so on. It can be specified or higher layer/L1/L2 signaling can indicate which measurement modes or which transmission/reception modes are enabled or disabled in the aforementioned time durations. When CSI-RS/SRS is disabled for a certain UE procedure, the UE may cease performing the procedure, or the UE may perform the procedure using other reference signals, such as SSB(s) associated with the disabled CSI-RS/SRS, or other reference signals/SSB indexes that are indicated by higher layer or RRC signaling, for example, a same signaling that was used for disabling the CSI-RS/SRS or based on non-periodic RS, such as on-demand sync signal (e.g., OD-SSB) or aperiodic CSI-RS.

In one embodiment, outside DRX Active time or within a PDCCH skipping duration (or generally within a dormant period or an energy-efficient operation mode indicated by L1/L2 signaling such as a DCI or a DL WUS), a UE may suspend or adapt reception of DL channels such as SPS PDSCH (and corresponding HARQ-ACK transmission), or transmission of UL channels such as PUCCH (at least PUCCH with HARQ-ACK) or transmission or retransmission of a CG PUSCH that are configured on (an active DL/UL BWP of) a cell, such as a serving cell (or a camped cell or a non-serving cell or a non-camped cell such as a neighbor cell or a candidate cell or a group of cells/such cells) for the UE. Such disabling or adaptation of DL/UL channels can be predetermined in the specifications of system operation, or can be based on higher layer signaling such as RRC, or can be based on L1/L2 signaling, for example, by an activation DCI format for SPS PDSCH or for CG PUSCH, or by a MAC-CE for activation of SP PUCCH, or by a GC-DCI format such as one for adaptation of DRX procedure, such as a DCI format 2_6 with CRC scrambled by PS-RNTI (DCP), or by a same DCI format that indicates PDCCH skipping, or by a WUS such as a PDCCH-based/DCI format or a sequence-based DL WUS or an LP-WUS. When DL data channels (e.g., SPS PDSCH in addition to PDSCH receptions scheduled by a DCI format) are disabled for a UE, and there is DL traffic for the UE, the UE can be provided an L1/L2 signaling such as a DCI or a sequence-based DL WUS that terminates the DRX cycle or the PDCCH skipping duration. When both configured and scheduled data channels are disabled for a UE, and there is UL traffic for the UE, the DRX cycle or the PDCCH skipping duration may be terminated by the gNB such as a by a DCI or a by a DL WUS, with or without UE request such as SR in a PUCCH or a PRACH, or the UE/gNB may wait until the DRX cycle or the PDCCH skipping duration (or generally the dormancy period or the energy-efficient operation mode) is completed. Such disabling or adaptation of DL/UL channels or can be UE-specific or UE-type-specific or based on certain conditions such as timeline conditions or based on UE assistance information reported to the UE related to, for example, DL/UL buffer status, or DL/UL traffic type, or power headroom (PH) or UE battery status, and so on. Above methods may or may not apply to certain essential UL/DL channels, such as PRACH, or such as PDCCH reception for scheduling and reception of system information, paging, random access response (RAR), that are also referred to as PDCCH monitoring according to CSS sets Type-0/0A/1/1A/2/2A in 5G NR. Disabling or adaptation of DL/UL channels for a UE during initial/random access or a UE in IDLE/INACTIVE state can be based on a WUS such as a sequence-based DL WUS or based on PDCCH-based WUS with limited PDCCH monitoring, such as few/no blind decoding. For example, MIB or SIB or (cell-specific or UE-group-specific or UE-specific) RRC signaling can provide information of such sequence-based DL WUS or PDCCH-based WUS, for example, monitoring occasions or time/frequency candidates or candidate resource. For example, a PDCCH-based WUS can be predetermined to be in first N CCEs of a corresponding (cell-specific or UE-group-specific) CORESET, such as CORESET #0, or corresponding CCEs or PDCCH candidate can be configured by MIB/SIB or (cell-specific or UE-group-specific or UE-specific) RRC. Such disabling or adaptation of PDCCH monitoring or various other DL/UL transmissions can be subject to timeline conditions, so that the UE/NW have sufficient time to benefit from corresponding adaptation.

In one embodiment (related to two-stage design for DL WUS or LP-WUS), a UE can receive a WUS such as a DL WUS or an LP-WUS in two stages or two receptions, wherein the UE receives a first stage/reception in occasions/resources that are configured by higher layers, and with payload size/fields that are predetermined or configured by higher layers. The first stage/reception of DL WUS/LP-WUS can indicate whether the second stage/reception of LP-WUS is or is not present, and when indicated as present, can indicate parameters related to payload size/fields of the second stage/reception, or occasions/resources in which the UE can receive the second stage/reception, such as a time/frequency offset relative to the first stage/reception. The first stage can provide information for a number of UE groups or a number of UE sub-groups, while the second stage can provide UE-specific information, such as additional control information (e.g., DRX parameters, dormancy period parameters, applicable SSSG, CORESET parameters, CORESET group/TRP adaptation, cell or carrier state, information of disabled/adapted signals or channels, and so on) or SDT-like data/payload for a subset of UEs from a group/sub-group of UEs, such as a group or sub-group that is indicated to wake-up by the first stage. The first stage can be sequence-based DL WUS, while the second stage can be another sequence-based WUS or can be a PDCCH-based WUS possibly with limited or no blind decoding.

In the following, unless otherwise noted, providing a parameter value by higher layers includes providing the parameter value by MIB or a system information block (SIB), such as a SIB1, or by a common RRC signaling, or by UE-group-specific RRC signaling or by UE-specific RRC signaling.

In the following, unless otherwise noted, a parameter referenced in italics is provided by higher layers such as by MIB or SIB or RRC.

A set of PDCCH candidates for a UE to monitor is defined in terms of PDCCH search space sets. A search space set can be a CSS set or a USS set.

For each DL BWP configured to a UE in a serving cell, the UE can be provided by higher layer signaling with
P≤3 CORESETs if coresetPoolIndex is not provided, or if a value of coresetPoolIndex is same for CORESETs if coresetPoolIndex is provided
P≤5 CORESETs if coresetPoolIndex is not provided for a first CORESET, or is provided and has a value 0 for a first CORESET, and is provided and has a value 1 for a second CORESET

For each CORESET, the UE is provided the following by ControlResourceSet:
a CORESET index p, by controlResourceSetld or by controlResourceSetId-vl610, where
   0<p<12 if coresetPoolIndex is not provided, or if a value of coresetPoolIndex is same for CORESETs if coresetPoolIndex is provided;
   0<p<16 if coresetPoolIndex is not provided for a first CORESET, or is provided and has a value 0 for a first CORESET, and is provided and has a value 1 for a second CORESET;
a DM-RS scrambling sequence initialization value by pdcch-DMRS-ScramblingID;
a precoder granularity for a number of REGs in the frequency domain where the UE can assume use of a same DM-RS precoder by precoderGranularity;
a number of consecutive symbols provided by duration;
a set of resource blocks provided byfrequencyDomainResources;
CCE-to-REG mapping parameters provided by cce-REG-MappingType;
an antenna port quasi co-location, from a set of antenna port quasi co-locations provided by TCI-State, indicating quasi co-location information of the DM-RS antenna port for PDCCH reception;
an indication for a presence or absence of a transmission configuration indication (TCI) field for a DCI format, other than DCI format 1_0, that schedules PDSCH receptions or has associated HARQ-ACK information without scheduling PDSCH and is provided by a PDCCH in CORESET p, by tci-PresentInDCI or tci-PresentDCI-1-2.

When precoderGranularity=allContiguousRBs, a UE does not expect
to be configured a set of resource blocks of a CORESET that includes more than four subsets of resource blocks that are not contiguous in frequency
any RE of a CORESET to overlap with any RE determined from
   lte-CRS-ToMatchAround or LTE-CRS-PatternList, if the UE is not provided pdcchCandidateReception-WithCRSOverlap, or
   a SS/PBCH block.

For each DL BWP configured to a UE in a serving cell, the UE is provided by higher layers with S≤10 search space sets where, for each search space set from the S search space sets, the UE is provided the following by SearchSpace:
a search space set index s, 0<s<40, by searchSpaceId
an association between the search space set s and a CORESET p by controlResourceSetld or by controlResourceSetId-v1610
a PDCCH monitoring periodicity of kₛ slots and a PDCCH monitoring offset of oₛ slots, by monitoringSlotPeriodicityAndOffset or by monitoringSlotPeriodicityAndOffset-r17
a PDCCH monitoring pattern within a slot, indicating first symbol(s) of the CORESET for PDCCH monitoring within each slot where the UE monitors PDCCH, by monitoringSymbolsWithinSlot
a duration of Tₛ<kₛ indicating a number of slots that the search space set s exists by duration, or a number of slots in consecutive groups of slots where the search space set s can exist by duration-r17
a bitmap, by monitoringSlotsWithinSlotGroup, that applies per group of slots and provides a PDCCH monitoring pattern indicating slots in a group of slots for PDCCH monitoring
   a size of the group of slots is same as a size of monitoringSlotsWithinSlotGroup
   for a Type1-PDCCH CSS set provided by ra-SearchSpace in dedicated RRC signaling, or for a Type3-PDCCH CSS set, or for a USS set, the PDCCH monitoring pattern indicates only consecutive slots in the group of slots for PDCCH monitoring and, at least for one combination (Xₛ, Yₛ) indicated by the UE as a capability, a number of the consecutive slots is not larger than Yₛ
   for a Type1-PDCCH CSS set provided by ra-SearchSpace in SIB1, the PDCCH monitoring pattern indicates only up to 1 slot in the group of slots for PDCCH monitoring
   for a Type0-PDCCH CSS set or for a Type0A-PDCCH CSS set, or for a Type2-PDCCH CSS set, the PDCCH monitoring pattern indicates slots in the group of slots for PDCCH monitoring, and the slots are not restricted to be consecutive, and the number of those slots is not larger than the size of monitoringSlotsWithinSlotGroup
a number of PDCCH candidates

$${M}_{s}^{( L )}$$

per CCE aggregation level L by aggregationLevel1, aggregationLevel2, aggregationLevel4, aggYegationLeve18, and aggregationLevel16, for CCE aggregation level 1, CCE aggregation level 2, CCE aggregation level 4, CCE aggregation level 8, and CCE aggregation level 16, respectively
an indication that search space set s is either a CSS set or a USS set by searchSpaceType
if search space set s is a CSS set
   an indication by dci-Format0-0-AndFormat1-0 to monitor PDCCH candidates for DCI format 0_0 and DCI format 1_0
   an indication by dci-Format2-0 to monitor one or two PDCCH candidates, or to monitor one PDCCH candidate per RB set if the UE is provided freqMonitorLocations for the search space set, for DCI format 2_0 and a corresponding CCE aggregation level
   an indication by dci-Format2-1 to monitor PDCCH candidates for DCI format 2_1
   an indication by dci-Format2-2 to monitor PDCCH candidates for DCI format 2_2
   an indication by dci-Format2-3 to monitor PDCCH candidates for DCI format 2_3
   an indication by dci-Format2-4 to monitor PDCCH candidates for DCI format 2_4
   an indication by dci-Format2-6 to monitor PDCCH candidates for DCI format 2_6
   an indication by dci-Format2-9 to monitor PDCCH candidates for DCI format 2_9
   an indication by dci-Format4-0 to monitor PDCCH candidates for DCI format 4_0
   an indication by dci-Format4-1, or dci-Format4-2, or dci-Format4-1-AndFormat4-2 to monitor PDCCH candidates for DCI format 4_1, or DCI format 4_2, or for both DCI format 4_1 and DCI format 4_2, respectively
an indication by searchSpaceLinkingId that search space set s is linked to another search space set for which is provided a same value for searchSpaceLinkingId
if search space set s is a USS set,
   an indication by dci-Formats to monitor PDCCH candidates either for DCI format 0_0 and DCI format 1_0, or for DCI format 0_1 and DCI format 1_1, or
   an indication by dci-FormatsExt to monitor PDCCH candidates for DCI format 0_2 and DCI format 1_2, or for DCI format 0_1, DCI format 1_1, DCI format 0_2, and DCI format 1_2, or
   an indication by dci-FormatsMC to monitor PDCCH candidates for one or both of DCI format 0_3 and DCI format 1_3, or
   an indication by dci-FormatsSL to monitor PDCCH candidates for DCI format 0_0 and DCI format 1_0, or for DCI format 0_1 and DCI format 1_1, or for DCI format 3_0, or for DCI format 3_1, or for DCI format 3_0 and DCI format 3_1, on an indication by dci-Format-NCR to monitor PDCCH candidates for DCI format 2_8
a bitmap byfreqMonitorLocations, if provided, to indicate an index of one or more RB sets for the search space set s, where the most significant bit (MSB) k in the bitmap corresponds to RB set k−1 in the DL BWP. For RB set k indicated in the bitmap, the first PRB of the frequency domain monitoring location confined within the RB set is given by

$${RB}_{s 0 + k , DL}^{start , μ} + {N}_{RB}^{offset} ,$$

where

$${RB}_{s 0 + k , DL}^{start , μ}$$

is the index of first common RB of the RB set k [6, TS 38.214], and

$${N}_{RB}^{offset}$$

is provided by rb-Offset or

$${N}_{RB}^{offset} = 0$$

if rb-Offset is not provided. For each RB set with a corresponding value of 1 in the bitmap, the frequency domain resource allocation pattern for the monitoring location is determined based on the first

$${N}_{RBG , set 0}^{size}$$

bits in frequencyDomainResources provided by the associated CORESET configuration.

If the monitoringSymbolsWithinSlot indicates to a UE to monitor PDCCH in a subset of up to three consecutive symbols that are same in every slot where the UE monitors PDCCH for search space sets, the UE does not expect to be configured with a PDCCH SCS other than 15 kHz if the subset includes at least one symbol after the third symbol.

A UE does not expect to be provided a first symbol and a number of consecutive symbols for a CORESET that results to a PDCCH candidate mapping to symbols of different slots.

A UE does not expect any two PDCCH monitoring occasions on an active DL BWP, for a same search space set or for different search space sets, in a same CORESET to be separated by a non-zero number of symbols that is smaller than the CORESET duration.

A UE determines a PDCCH monitoring occasion on an active DL BWP from the PDCCH monitoring periodicity, the PDCCH monitoring offset, and the PDCCH monitoring pattern within a slot. If monitoringSlotsWithinSlotGroup is not provided, the UE determines that PDCCH monitoring occasions exist in a slot with number

$${n}_{s , f}^{μ}$$

[4, TS 38.211] in a frame with number n_{f} if

$$( {n}_{f} {N}_{slot}^{frame , μ} + {n}_{s , f}^{μ} - {o}_{s} ) mod {k}_{s} = 0 .$$

The UE monitors PDCCH candidates for search space set s for Tₛ consecutive slots, starting from slot

$${n}_{s , f}^{μ} ,$$

and does not monitor PDCCH candidates for search space set s for the next kₛ−Tₛ consecutive slots. If monitoringSlotsWithinSlotGroup is provided, for search space set s, the UE determines that the slot with number

$${n}_{s , f}^{μ}$$

[4, TS 38.211] in a frame with number n_{f} satisfying

$$( {n}_{f} {N}_{slot}^{f r a m e , μ} + {n}_{s , f}^{μ} - {o}_{s} ) mod {k}_{s} = 0$$

is the first slot in a first group of Lₛ slots and that PDCCH monitoring occasions exist in Tₛ/Lₛ consecutive groups of slots starting from the first group, where Lₛ is the size of monitoringSlotsWithinSlotGroup. The UE monitors PDCCH candidates for search space set s within each of the Tₛ/Lₛ consecutive groups of slots according to monitoringSlotsWithinSlotGroup, starting from slot

$${n}_{s , f}^{μ} ,$$

and does not monitor PDCCH candidates for search space set s for the next kₛ−Tₛ consecutive slots.

A USS at CCE aggregation level L∈{1, 2, 4, 8, 16} is defined by a set of PDCCH candidates for CCE aggregation level L.

If a UE is configured with CrossCarrierSchedulingConfig for a serving cell, the carrier indicator field value corresponds to the value indicated by cif-InSchedulingCell in CrossCarrierSchedulingConfig. If a UE is configured with MC-DCI-SetofCells for a set of serving cells, the UE is provided nCI-Value for the set of serving cells.

For an active DL BWP of a serving cell on which a UE monitors PDCCH candidates in a USS, if the UE is not configured with a carrier indicator field, the UE monitors the PDCCH candidates without carrier indicator field. For an active DL BWP of a serving cell on which a UE monitors PDCCH candidates in a USS, if a UE is configured with a carrier indicator field, the UE monitors the PDCCH candidates with carrier indicator field.

A UE does not expect to monitor PDCCH candidates on an active DL BWP of a secondary cell if the UE is configured to monitor PDCCH candidates for detection of DCI formats scheduling on that secondary cell in another serving cell. For a serving cell included in MC-DCI-SetofCells, if provided, the UE does not expect to monitor PDCCH candidates on more than one scheduling cell for detection of DCI formats scheduling on the serving cell. For the active DL BWP of a serving cell on which the UE monitors PDCCH candidates, the UE monitors PDCCH candidates at least for the same serving cell.

For a search space set s associated with CORESET p, the CCE indexes for aggregation level L corresponding to PDCCH candidate

$${m}_{s , {n}_{CI}}^{( L )}$$

of the search space set in slot

$${n}_{s , f}^{μ}$$

for an active DL BWP of a serving cell corresponding to carrier indicator field value n_{CI}, or corresponding to value n_{CI} of nCI-Value associated with a set of serving cells MC-DCI-SetofCells, are given by

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i$$

where

### for any CSS,

$${Y}_{p , {n}_{sf}^{μ}} = 0 ;$$

### for a USS,

$${Y}_{p , {n}_{s , f}^{μ}} = ( {A}_{p} \cdot {Y}_{p , {n}_{s , f}^{μ} - 1} ) mod D , {Y}_{p , - 1} = {n}_{RNTI} \neq 0 ,$$

Aₚ=39827 for pmod3=0, Aₚ=39829 for pmod3=1, Aₚ=39839 for pmod3=2, and D=65537;

$$i = 0 , … , L - 1 ;$$

N_{CCE,p} is the number of CCEs, numbered from 0 to N_{CCE,p}−1, in CORESET p and, if any, per RB set
for CORESET 0, the CCEs are obtained prior to puncturing, if any, of corresponding RBs [4, TS 38.211];
   n_{CI} is
the carrier indicator field value, if provided by cif-InSchedulingCell in CrossCarrierSchedulingConfig for the serving cell on which PDCCH is monitored, except for scheduling of the serving cell from the same serving cell in which case n_{CI}=0;
the nCI-Value provided for the set of serving cells MC-DCI-SetofCells, if MC-DCI-SetofCells is provided;
otherwise, including for any CSS, n_{CI}=0

$${m}_{s , {n}_{CI}}^{( L )} = 0 , … , {M}_{s , {n}_{CI}}^{( L )} - 1 ,$$

where

$${m}_{s , {n}_{CI}}^{( L )}$$

is the number of PDCCH candidates the UE is configured to monitor for aggregation level L of a search space set s for a serving cell corresponding to n_{CI};

### for any CSS,

$${M}_{s , max}^{( L )} = {M}_{s , 0}^{( L )} ;$$

### for a USS,

$${M}_{s , max}^{( L )}$$

is the maximum of

$${m}_{s , {n}_{CI}}^{( L )}$$

over configured n_{CI} values for a CCE aggregation level L of search space set s;
the RNTI value used for n_{RNTI} is the cell-radio network temporary identifier (C-RNTI).

For search space sets sᵢ and sⱼ that include searchSpaceLinkingId with same value, a UE monitors, in monitoring occasions with same index according to each of search space sets sᵢ and sⱼ in a slot, PDCCH candidates

$${m}_{{s}_{i} , {n}_{CI}}^{( L )} and {m}_{{s}_{j} , {n}_{CI}}^{( L )} , with {m}_{{s}_{i} , {n}_{CI}}^{( L )} = {m}_{{s}_{j} , {n}_{CI}}^{( L )} ,$$

for detection of a DCI format with same information. The UE expects

$${k}_{{s}_{i}} = {k}_{{s}_{j}} , {o}_{{s}_{i}} = {o}_{{s}_{j}} , {T}_{{s}_{i}} = {T}_{{s}_{j}} , {M}_{{s}_{i}}^{( L )} = {M}_{{s}_{j}}^{( L )} ,$$

and a same number of non-overlapping PDCCH monitoring occasions per slot based on corresponding monitoringSymbolsWithinSlot, for search space sets sᵢ and sⱼ. For CORESET pᵢ associated with the search space set sᵢ and for CORESET pⱼ associated with the search space set sⱼ, the UE is provided tci-PresentInDCI or tci-PresentDCI-1-2 for either none or both of CORESETs pᵢ and pⱼ. For CORESET pᵢ associated with the search space set sᵢ and for CORESET pⱼ associated with the search space set sⱼ, the UE is either not provided coresetPoolIndex value of 1 for any of the two CORESETs, or is provided coresetPoolIndex value of 1 for both CORESETs.

A UE can indicate by numBD-twoPDCCH-r17 a capability for counting PDCCH candidates

$${m}_{{s}_{i} , {n}_{CI}}^{( L )} and {m}_{{s}_{j} , {n}_{CI}}^{( L )}$$

either as 2 PDCCH candidates or as 3 PDCCH candidates.

A UE expects to monitor PDCCH candidates for up to 4 sizes of DCI formats that include up to 3 sizes of DCI formats with CRC scrambled by C-RNTI per serving cell. The UE counts a number of sizes for DCI formats per serving cell based on a number of configured PDCCH candidates in respective search space sets for the corresponding active DL BWP.

A UE does not expect to detect, in a same PDCCH monitoring occasion, a DCI format with CRC scrambled by a system information (SI-RNTI), random access RNTI (RA-RNTI), MsgB-RNTI, temporary cell RNTI (TC-RNTI), P-RNTI, C-RNTI, configured scheduling RNTI (CS-RNTI), modulation and coding scheme RNTI (MCS-RNTI), multicast control channel RNTI (MCCH-RNTI), group RNTI (G-RNTI), G-CS-RNTI, or multicast-MCCH-RNTI and a DCI format with CRC scrambled by a sidelink RNTI (SL-RNTI) or a SL-CS-RNTI for scheduling respective PDSCH reception and physical sidelink shared channel (PSSCH) transmission on a same serving cell.

DL transmissions or UL transmissions can be based on an orthogonal frequency division multiplexing (OFDM) waveform including a variant using DFT precoding that is known as DFT-spread-OFDM (see also REF 1).

A UE typically monitors multiple candidate locations for respective potential PDCCH receptions to decode one or more DCI formats in a slot, for example as described in REF 3. A DCI format includes cyclic redundancy check (CRC) bits in order for the UE to confirm a correct detection of the DCI format. A DCI format type is identified by a radio network temporary identifier (RNTI) that scrambles the CRC bits (see also REF 2). For a DCI format scheduling a PDSCH or a PUSCH to a single UE, the RNTI can be a cell RNTI (C-RNTI) and serves as a UE identifier. For a DCI format scheduling a PDSCH conveying system information (SI), the RNTI can be a SI-RNTI. For a DCI format scheduling a PDSCH providing a random access response (RAR), the RNTI can be a RA-RNTI. For a DCI format providing transmit power control (TPC) commands to a group of UEs, the RNTI can be a TPC-RNTI. Each RNTI type can be configured to a UE through higher-layer signaling such as RRC signaling (see also REF 5). A DCI format scheduling PDSCH transmission to a UE is also referred to as DL DCI format or DL assignment while a DCI format scheduling PUSCH transmission from a UE is also referred to as UL DCI format or UL grant.

A PDCCH transmission can be within a set of PRBs. A gNB (e.g., the BS 102) can configure a UE one or more sets of PRB sets, also referred to as control resource sets (CORESETs), for PDCCH receptions (see also REF 3). A PDCCH transmission can be in control channel elements (CCEs) of a CORESET. A UE determines CCEs for a PDCCH reception based on a search space set (see also REF 3). A set of CCEs that can be used for PDCCH reception by a UE define a PDCCH candidate location.

The PDCCH monitoring activity of the UE in RRC connected mode is governed by DRX, BA, DCP and cell DTX.

When DRX is configured, the UE does not have to continuously monitor PDCCH. DRX is characterized by the following:
on-duration: duration that the UE waits for, after waking up, to receive PDCCHs. If the UE successfully decodes a PDCCH, the UE stays awake and starts the inactivity timer;
inactivity-timer: duration that the UE waits to successfully decode a PDCCH, from the last successful decoding of a PDCCH, failing which it can go back to sleep. The UE shall restart the inactivity timer following a single successful decoding of a PDCCH for a first transmission only (i.e., not for retransmissions);
retransmission-timer: duration until a retransmission can be expected;
LP-WUS PDCCH monitoring timer: duration that the UE waits for, after woken up by LP-WUS, to receive PDCCH. In case this timer is configured the UE does not start the on-duration timer. If the UE successfully decodes a PDCCH, the UE stays awake and starts the inactivity timer;
cycle: specifies the periodic repetition of the on-duration followed by a possible period of inactivity;
active-time: total duration that the UE monitors PDCCH. This includes the “on-duration” of the DRX cycle, the time UE is performing continuous reception while the inactivity timer has not expired, the time when the UE is performing continuous reception while waiting for a retransmission opportunity and the time UE is performing continuous reception while the LP-WUS PDCCH monitoring timer has not expired.

A UE can be configured with LP-WUS for power saving in all RRC states. A LP-WUS is transmitted based on OOK and overlaid OFDM sequence(s) over OOK ON symbols and can carry up to 5 information bits and one codepoint out of up to 32 codepoints. A UE supports detection of LP-WUS information carried by OOK and/or overlaid OFDM sequences. In RRC_IDLE and RRC_INACTIVE, the same information is delivered by OOK and overlaid OFDM sequences. For LP-WUS, the number of OOK symbols within an OFDM symbol can be configured as 1, 2 or 4. For RRC_IDLE and RRC_INACTIVE, a UE monitors two codepoints for LP-WUS. In RRC_CONNECTED, a UE can be configured to monitor up to 8 codepoints for LP-WUS.

When BA is configured, the UE only has to monitor PDCCH on the one active BWP i.e., it does not have to monitor PDCCH on the entire DL frequency of the cell. A BWP inactivity timer (independent from the DRX inactivity-timer described above) is used to switch the active BWP to the default one: the timer is restarted upon successful PDCCH decoding and the switch to the default BWP takes place when it expires.

In addition, the UE may be indicated, when configured accordingly, whether it is required to monitor or not the PDCCH during the next occurrence of the on-duration by a DCP monitored on the active BWP. If the UE does not detect a DCP on the active BWP, it does not monitor the PDCCH during the next occurrence of the on-duration, unless it is explicitly configured to do so in that case.

A UE can only be configured to monitor DCP when connected mode DRX is configured, and at occasion(s) at a configured offset before the on-duration. More than one monitoring occasion can be configured before the on-duration. The UE does not monitor DCP on occasions occurring during active-time, measurement gaps, BWP switching, or when it monitors response for a CFRA preamble transmission for beam failure recovery, in which case it monitors the PDCCH during the next on-duration. If no DCP is configured in the active BWP, UE follows normal DRX operation.

When CA is configured, DCP or LP-WUS is only configured on the PCell.

One DCP can be configured to control PDCCH monitoring during on-duration for one or more UEs independently.

Power saving in RRC_IDLE and RRC_INACTIVE can also be achieved by UE relaxing neighbor cells RRM measurements when it meets the criteria determining it is in low mobility and/or not at cell edge. When UE is configured with both high speed measurements and RRM measurement relaxation as specified in TS 38.331, it is up to UE implementation whether to apply the FR1 high speed RRM requirements or the relaxed RRM requirements when the low mobility related criterion is configured and fulfilled as specified in TS 38.133.

Power saving in RRC_IDLE and RRC_INACTIVE can also be achieved by allowing UEs supporting LP-WUS to relax serving cell measurements on MR, further relax neighbor cell measurements on MR and/or offload serving cell measurements from MR to LR. Conditions for further relax neighbor and serving cell measurements are based on MR and optionally LR measurements as specified in TS 38.304. Entry condition for offloading serving cell measurements from MR to LR is based on MR and optionally LR measurements as specified in TS 38.304 [10]. Exit conditions for offloading serving cell measurements from MR to LR are based on LR measurements as specified in TS 38.304 [10].

For UE in RRC_IDLE and RRC_INACTIVE configured with LP-WUS, LP-SS is supported for UE LR to maintain synchronization and perform serving cell RRM measurements. LP-SS transmission is based on OOK with or without overlaid OFDM sequence. For UE capable of detecting overlaid OFDM sequence by LR, PSS/SSS can be used for UE LR to maintain synchronization and perform serving cell RRM measurements. For LP-SS, the number of OOK symbols within an OFDM symbol can be configured as 1, 2 or 4 and the number can be same or larger than LP-WUS. LP-SS is not supported in RRC_CONNECTED.

For UE in RRC_IDLE and RRC_INACTIVE configured with LP-WUS, the frequency resource of LP-WUS and LP-SS can be configured within or outside the initial DL BWP in the carrier where the UE monitors paging. For UE in RRC_CONNECTED, the frequency resource of LP-WUS can be configured within or outside the UE active DL BWP, where the support of LP-WUS monitoring outside active DL BWP is optional.

For UE in RRC_IDLE and RRC_INACTIVE configured with LP-WUS, three candidate values for wake-up delay are supported for UE to report via capability signaling, where wake-up delay is defined as the minimum time gap between the LP-WUS reception and MR to start PDCCH monitoring. A gNB can configure one or two time-offset values between the reference PF of the PO and the associated LP-WUS monitoring occasions. If at least one of the configured time offset values are no smaller than the wake-up delay that UE reports, the UE monitors LP-WUS monitoring occasions corresponding to the smallest time offset value that is no smaller than its reported wake-up delay, otherwise, the UE does not monitor LP-WUS and monitors PO.

UE is not required to support simultaneous reception using LR and MR, where LR is used for LP-WUS monitoring and MR is used for transmission and/or reception of all other NR signals/channels in RRC_CONNECTED within the same cell group.

It is up to UE implementation to implement LR in the same or different physical receiver as MR.

A UE configured with DRX mode operation and operating in the RRC_IDLE or RRC_INACTIVE state can be provided for LPSS/WUS reception
a number of OOK symbols per OFDM symbol, a first RB, and an overlaid OFDM sequence per OOK symbol for LPSS reception, and an EPRE ratio relative to SS/PBCH blocks, and
a number of OOK symbols per OFDM symbol, the first RB, and one or more overlaid OFDM sequences per OOK symbol for WUS reception, and an EPRE ratio relative to SS/PBCH blocks.

A UE assumes that an SCS configuration for LPSS/WUS receptions is same as an SCS of the initial DL BWP and an SCS configuration of an SS/PBCH block the UE used to obtain SIB1.

A UE receives an LPSS in consecutive symbols within a slot. The UE can be provided one or two first symbols for respective one or two LPSS reception occasions in the slot by lpss-StartSymbol. The UE determines slots for LPSS reception occasions based on a periodicity and a time offset, relative to a system frame with SFN 0, provided by lpss-periodicityoffset. Within a period of LPSS reception occasions, LPSS reception occasions are in a set of ┌K/L┐ consecutive slots that have all symbols indicated as downlink by tdd-UL-DL-ConfigurationCommon, if provided, and start from the first slot provided by the time offset in the period, where K is the number of transmitted SS/PBCH blocks indicated by ssb-PositionsInBurst in SIB1 and L is the number of LPSS reception occasions in a slot.

LPSS reception occasions are indexed sequentially in time. An LPSS reception at the k-th LPSS reception occasion is quasi co-located with the k-th transmitted SS/PBCH block, with respect to quasi co-location ‘typeC’ or ‘typeD’ properties when applicable, where 1≤k≤K.

If a UE is provided wus-LPSS-beamSubset, the UE receives LPSS/WUS based on the quasi co-location properties of transmitted SS/PBCH blocks indicated by wus-LPSS-beamSubset; otherwise, the UE receives LPSS/WUS based on the quasi co-location properties for transmitted SS/PBCH blocks indicated by ssb-PositionsInBurst in SIB1. A WUS occasion includes K·M WUS monitoring occasions that are indexed sequentially in time, where
K is the number of transmitted SS/PBCH blocks indicated by ssb-PositionsInBurst in SIB1, M is a number of WUS monitoring occasions associated with each of the K transmitted SS/PBCH blocks provided by MONumperLO, and
a WUS monitoring occasion with index (k−1)·M+m, where 1≤m≤M and 1≤k≤K, is quasi co-located with the k-th transmitted SS/PBCH block with respect to quasi co-location ‘typeC’ or ‘typeD’ properties, when applicable

A UE can be provided, by WUS_available_slot_IDLE/INACTIVE, a bitmap that corresponds to a set of time units that repeats continuously and indicates a subset of time units from the set of time units that is available for the UE to monitor WUS. A time unit includes one slot or two slots. The UE can be additionally provided, by WUS_available_symbol_IDLE/INACTIVE, an indication of symbols in each time unit from the subset of time units that is available for the UE to monitor WUS. If the UE is not provided WUS_available_slot_IDLE/INACTIVE, the UE assumes that all time units are available for the UE to monitor WUS. If the UE is not provided WUS_available_symbol_IDLE/INACTIVE, the UE assumes that, for a time unit that is available for the UE to monitor WUS, all symbols in the time unit are available for the UE to monitor WUS. The UE assumes that a symbol is not available to monitor WUS when
the symbol is indicated as uplink, by tdd-UL-DL-configurationCommon
the symbol is indicated for an SS/PBCH block transmission, by ssb-PositionsInBurst in SIB1, and the SS/PBCH block transmission would overlap in frequency with the WUS transmission
the symbol is indicated for PDCCH transmissions, by pdcch-ConfigSIB1, and CORESET 0 for the PDCCH transmissions would overlap in frequency with the WUS transmission

A WUS monitoring occasion is over a first number of symbols, provided by WUS_NominalMO_duration_IDLE/INACTIVE. If a number of available symbols for the UE to monitor WUS in a WUS monitoring occasion is smaller than a second number of symbols, provided by WUS_ActualMO_duration_IDLE/INACTIVE, the UE does not monitor WUS in the WUS monitoring occasion. The UE monitors WUS in a WUS monitoring occasion over the earliest available WUS_ActualMO_duration_IDLE/INACTIVE symbols in the WUS monitoring occasion. If a number of available symbols for the UE to monitor WUS in a WUS monitoring occasion includes a symbol for LPSS reception, the UE does not monitor WUS in the WUS monitoring occasion.

A UE assumes that WUS occasions occur with a periodicity equal to the I-DRX cycle in the RRC_IDLE/RRC_INACTIVE state. The UE determines WUS occasions associated with a paging occasion based on PO-to-LO association. A reference frame of a WUS occasion starts a number of frames prior to the first of a number of paging frames associated with the WUS occasion. Each number of frames is provided by LO-FrameOffsets. The first WUS monitoring occasion of a WUS occasion starts at an offset provided by offset_firstMO_withinLO relative to the start of the reference frame. If multiple values for the number of frames provided by LO-FrameOffsets are larger than or equal to the value of a higher layer parameter XYZ, the UE monitors WUS starting at a WUS occasion corresponding to the smallest of the multiple values. If all values for the number of frames provided by LO-FrameOffsets are smaller than the value of XYZ, the UE monitors PDCCH according to Type2-PDCCH CSS sets associated with the paging occasion and does not monitor WUS.

A paging occasion associated with a WUS occasion has index

$${i}_{P O} = ( ( UE\_ID mod N ) \cdot {N}_{S} + i\_s ) mod {N}_{P O}^{W O}$$

where

$${N}_{P O}^{WO}$$

is a number of paging occasions associated with a WUS occasion, N, N_{S}, i_{SG}, and i_s are defined in TS 38.304, and UE_ID is defined in clause 7.1 of TS 38.304. If a number of

$${N}_{S G}^{P O}$$

subgroups per paging occasion, provided by subgroupNumber-PO-WUS, is

$${N}_{S G}^{P O} > 1 ,$$

the codepoint for the subgroup index i_{SG} in a

$$PO {i}_{P O} is {i}_{P O} * ( {N}_{S G}^{P O} + 1 ) + {i}_{S G} ,$$

and the codepoint for all subgroups in the PO is

$$( {i}_{P O} + 1 ) * ( {N}_{S G}^{P O} + 1 ) - 1 ;$$

otherwise, the codepoint for the PO i_{PO} is i_{PO}.

If, in a WUS monitoring occasion, a UE determines a codepoint associated with the UE, the UE performs PDCCH monitoring according to Type2-PDCCH CSS sets for the paging occasion associated with the WUS monitoring occasion when a time from the end of the WUS reception to the start of the PDCCH monitoring occasion is not smaller than the value of XYZ; otherwise, the UE is not required to perform the PDCCH monitoring. The UE may also perform PDCCH monitoring for Type2A-PDCCH CSS sets for DCI format 2_7, if provided.

A UE configured with DRX mode operation and operating in the RRC_CONNECTED state can be provided for WUS reception on the primary cell of a cell group
a number of OOK symbols per OFDM symbol, a first RB, and overlaid OFDM sequences per OOK symbol for WUS reception, and
a number of codepoints provided for the UE by the WUS, by WUS-codepointCONNECTED

A UE assumes that a WUS is quasi co-located with an SS/PBCH block or a CSI-RS with respect to quasi co-location ‘typeC’ or ‘typeD’ properties, when applicable.

If a UE is provided ABC, the UE receives WUS based on the quasi co-location information of the TCI states indicated by a most recent DCI format or MAC CE, after a respective application time; otherwise, the UE receives WUS based on the quasi co-location information of the TCI states for a CORESET with controlResourceSetld value that is same as the one indicated by WUS_TCI_states_CONNECTED.

A UE assumes that an SCS configuration for WUS receptions is same as an SCS configuration for the active DL BWP.

A UE does not monitor a WUS during Active Time.

A UE does not monitor WUS during DTX inactive period for the primary cell.

A UE can be provided by WUS-MOCONNECTED-Option1-1 a periodicity, by periodicityMO-Option 1-1, and a time offset, by offsetMO-Option 1-1, relative to the start of a system frame with SFN 0, for the UE to determine WUS monitoring occasions. The UE starts to monitor WUS in a first WUS monitoring occasion that is not earlier than a first slot that is prior to a second slot where the drx-onDurationTimer would start by a time provided by timeOffsetCONNECTEDOption1-1, and monitors WUS for a number of monitoring occasions provided by numMO-Option 1-1. The UE reports a number of slots where the UE is not required to monitor WUS prior to the slot where the drx-onDurationTimer would start. The UE is not required to monitor WUS within the reported number of slots prior to the slot where the drx-onDurationTimer would start. If the UE determines to monitor PDCCH based on a detected WUS, the UE starts the drx-onDurationTimer.

A UE can be provided by WUS-MOCONNECTED-Option1-2 a periodicity, by periodicityMO-Option 1-2, and a time offset, by offsetMO-Option 1-2, relative to the start of a system frame with SFN 0, for the UE to determine first WUS monitoring occasions from a number of WUS monitoring occasions per periodicity, provided by numMO-perPeriodicity-Option 1-2. The UE reports a number of slots and expects that a time gap, from a last WUS monitoring occasion from the number of WUS monitoring occasions per periodicity to the slot where the wus-PDCCHMonitoringTimer would start, is no smaller than the reported number of slots. If the UE determines to monitor PDCCH based on a detected WUS, the UE starts wus-PDCCHMonitoringTimer after a time, provided by timeOffsetCONNECTEDOption1-2, with respect to the start of the first WUS monitoring occasion from the number of WUS monitoring occasions per periodicity.

A UE can be provided, by WUS_available_slot_CONNECTED, a bitmap that corresponds to a set of time units that repeats continuously and indicates a subset of time units from the set of time units that is available for the UE to monitor WUS [12, TS 38.331]. A time unit includes one slot or two slots. The UE can be additionally provided, by WUS_available_symbol_CONNECTED, an indication of symbols in each time unit from the subset of time units that is available for the UE to monitor WUS. If the UE is not provided WUS_available_slot_CONNECTED, the UE assumes that all time units are available for the UE to monitor WUS. If the UE is not provided WUS_available_symbol_CONNECTED, the UE assumes that, for a time unit that is available for the UE to monitor WUS, all symbols in the time unit are available for the UE to monitor WUS. The UE assumes that a symbol is not available to monitor WUS when
the symbol is indicated as uplink, by tdd-UL-DL-configurationCommon or tdd-UL-DL-ConfigurationDedicated
the symbol is indicated for transmission of SS/PBCH blocks, by ssb-PositionsInBurst in SIB1 or in ServingCellConfigCommon

A WUS monitoring occasion is over a first number of symbols, provided by WUS_NominalMO_duration_CONNECTED. If a number of available symbols for the UE to monitor WUS in a WUS monitoring occasion is smaller than a second number of symbols, provided by WUS_ActualMO_duration_CONNECTED, the UE does not monitor WUS in the WUS monitoring occasion. The UE monitors WUS in a WUS monitoring occasion over the earliest available WUS_ActualMO_duration_CONNECTED symbols in the WUS monitoring occasion.

If a UE detects a codepoint in a WUS reception, from the number of codepoints, on the primary cell of the cell group, the UE starts monitoring PDCCH on all applicable serving cells of the cell group.

UE power saving may be enabled by adapting the DL maximum number of MIMO layers by BWP switching.

Power saving is also enabled during active-time via cross-slot scheduling, which facilitates UE to achieve power saving with the assumption that it won't be scheduled to receive PDSCH, triggered to receive A-CSI or transmit a PUSCH scheduled by the PDCCH until the minimum scheduling offsets K0 and K2. Dynamic adaptation of the minimum scheduling offsets K0 and K2 is controlled by PDCCH.

Serving Cells of a MAC entity may be configured by RRC in two DRX groups with separate DRX parameters. When RRC does not configure a secondary DRX group, there is only one DRX group and all Serving Cells belong to that one DRX group. When two DRX groups are configured, each Serving Cell is uniquely assigned to either of the two groups. The DRX parameters that are separately configured for each DRX group are on-duration and inactivity-timer.

A UE configured with DRX in RRC_CONNECTED can be configured with LP-WUS. LP-WUS is monitored outside active-time. If LP-WUS is detected, the UE shall start the on-duration timer or LP-WUS PDCCH monitoring timer to start PDCCH monitoring and enter active-time:
If the UE is configured to start on-duration timer after LP-WUS reception, the UE monitors LP-WUS at occasion(s) at a configured offset before the on-duration, and the UE does not monitor LP-WUS when short DRX cycle is used. If the UE is unable to monitor the LP-WUS occasion, it shall start the on-duration timer.
If the UE is configured to start LP-WUS PDCCH monitoring timer after LP-WUS reception, the UE monitors LP-WUS at occasion(s) according to the configured periodicity and offset which can be same or different from the periodicity and offset configured for C-DRX cycle, and the UE monitors LP-WUS regardless of which DRX cycle is used. It the UE is unable to monitor the LP-WUS occasion(s), the LP-WUS PDCCH monitoring timer is not started.

Three candidate values for minimum time gap are supported for UE in RRC_CONNECTED to report via capability signaling, where the minimum time gap is between the LP-WUS reception and MR to start PDCCH monitoring. gNB configures the time offset between LP-WUS monitoring and the corresponding PDCCH monitoring.

When LP-WUS is configured, the next available uplink resources determined by the MAC entity (e.g. PUCCH resource for SR, PRACH occasion, and CG resource) occur when MR is activated.

UE power saving in RRC_IDLE/RRC_INACTIVE may be achieved by providing the configuration for TRS with CSIRS for tracking in TRS occasions. The TRS in TRS occasions may allow UEs in RRC_IDLE/RRC_INACTIVE to sleep longer before waking-up for its paging occasion. The TRS occasions configuration is provided in either SIB17 or SIB17bis. The availability of TRS in the TRS occasions is indicated by L1 availability indication. These TRSs may also be used by the UEs configured with eDRX.

UE power saving may be achieved by UE relaxing measurements for RLM/BFD. When configured, UE determines whether it is in low mobility state and/or whether its serving cell radio link quality is better than a threshold. The configuration for low mobility and good serving cell quality criterion is provided through dedicated RRC signaling.

RLM and BFD relaxation may be enabled/disabled separately through RRC Configuration. Additionally, RLM relaxation may be enabled/disabled on per Cell Group basis while BFD relaxation may be enabled/disabled on per serving cell basis.

The UE is only allowed to perform RLM and/or BFD relaxation when relaxed measurement criterion for low mobility and/or for good serving cell quality is met. If configured to do so, the UE shall trigger reporting of its RLM and/or BFD relaxation status through UE assistance information if the UE changes its respective RLM and/or BFD relaxation status while meeting the UE minimum requirements specified in TS 38.133.

UE power saving may also be achieved through PDCCH monitoring adaptation mechanisms when configured by the network, including skipping of PDCCH monitoring and Search space set group (SSSG) switching. In this case UE does not monitor PDCCH during the PDCCH skipping duration except for the cases as specified in TS 38.213, or monitors PDCCH according to the search space sets applied in SSSG.

To facilitate reducing gNB downlink transmission/uplink reception active time, UE can be configured with a periodic cell DTX/DRX pattern (i.e., active and non-active periods). The pattern configuration for cell DTX/DRX is common for the UEs configured with this feature in the cell. The cell DTX and cell DRX patterns can be configured and activated separately. A maximum of two cell DTX/DRX patterns can be configured per MAC entity for different serving cells. When cell DTX is configured and activated for the concerned cell, the UE may not monitor PDCCH in selected cases or does not monitor SPS occasions during cell DTX non-active duration. When cell DRX is configured and activated for the concerned cell, the UE does not transmit on CG resources or does not transmit a SR during cell DRX non-active duration. This feature is only applicable to UEs in RRC_CONNECTED state, and it does not impact Random Access procedure, SSB transmission, paging, and system information broadcasting. Cell DTX/DRX operation is only supported for single TRP scenario. Cell DTX/DRX can be activated/deactivated by RRC signaling or L1 group common signaling. Cell DTX/DRX is characterized by the following:
active duration: duration that the UE waits for to receive PDCCHs or SPS occasions, and transmit SR or CG. In this duration, the gNB transmission/reception of PDCCH, SPS, SR, CG, periodic and semi-persistent CSI report are not impacted for the purpose of network energy saving;
cycle: specifies the periodic repetition of the active-duration followed by a period of non-active duration.

Active duration and cycle parameters are common between cell DTX and cell DRX, when both are configured.

Once the gNB recognizes there is an emergency call or public safety related service, the network should ensure that there is no impact to that service (e.g., it may release or deactivate cell DTX/DRX configuration). The network should also ensure that there is at least partial overlapping between UE's connected mode DRX on-duration and cell DTX/DRX active duration, i.e., the UE's connected mode DRX periodicity is a multiple of cell DTX/DRX periodicity or vice versa.

A UE may support low-power synchronization signal (LP-SS) or low-power wake-up signal (LP-WUS), for example based on on-off keying (OOK) waveform, that are received by a low-power wake-up radio (LP-WUR) or a low-power radio (LR) for short. The following terminology may be used:
Main radio (MR): the Tx/Rx module operating for NR signals/channels apart from signals/channel related to low-power wake-up
LP-WUR (LR): The Rx module operating for receiving/processing signals/channel related to low-power wake-up.

Various methods can be used for UE power saving for paging monitoring. In order to reduce UE power consumption due to false paging alarms, the group of UEs monitoring the same PO can be further divided into multiple subgroups. With subgrouping, a UE shall monitor PDCCH in its PO for paging if the subgroup to which the UE belongs is paged as indicated via associated PEI and/or LP-WUS. If a UE cannot find its subgroup ID with the PEI and/or LP-WUS configurations in a cell or if the UE is unable to monitor the associated PEI and/or LP-WUS occasion corresponding to its PO, it shall monitor the paging in its PO. If the UE is configured with both LP-WUS and PEI, and it cannot find its subgroup ID with the LP-WUS or if the UE is unable to monitor the LP-WUS it monitors the following PEI or paging in its PO.

The gNB configures entry and exit conditions to monitor LP-WUS in system information. The UE may start monitoring LP-WUS when measurements using the MR are above the configured entry threshold(s), and the measurements using the LR are above the entry threshold(s), if configured. Exit conditions for LP-WUS monitoring are based on LR as specified in TS 38.304. LP-WUS monitoring can be disabled in the UE via NAS signalling. If this NAS signalling is absent LP-WUS monitoring is enabled.

On-demand SSB-based SCell operations are supported for UEs in RRC_CONNECTED configured with carrier aggregation (CA), applicable to both intra-band and inter-band CA configurations for FR1 and FR2 in non-shared spectrum. The OD-SSB transmission activation/deactivation command can only be transmitted to a UE configured with an SCell prior to or when receiving the SCell activation command. Both RRC and MAC-CE can be used for signalling the activation/deactivation state of OD-SSB transmissions. Additionally, the same MAC-CE can also update the transmission parameter of an activated OD-SSB after the SCell activation completion. The OD-SSB transmission deactivation can also be achieved implicitly based on the number of OD-SSB bursts to be transmitted configured by RRC. When there is no SSB on the SCell, the OD-SSB transmission is maintained while the SCell is activated. When SSB and OD-SSB have different center frequencies in the SCell, only a single OD-SSB on a different center frequency is supported. L3 measurement on OD-SSB can be supported.

To facilitate reducing gNB downlink transmissions, instead of always periodically transmitting SIB1, the gNB can provide on-demand SIB1, i.e., upon receiving an OD-SIB1 request from a UE supporting OD-SIB1. OD-SIB1 is supported for UEs in RRC_IDLE, RRC_INACTIVE and RRC_CONNECTED when T311 is running. A request for SIB1 triggers a random access procedure, where MSG1 is used for indicating OD-SIB1 request and the gNB acknowledges the request in MSG2. OD-SIB1 request configurations of one or more cells which support OD-SIB1 are included in SIB26, which can be broadcasted in any cell, including cell's own OD-SIB1 request configuration. UE may request SIB1 based on the OD-SIB1 request configuration from SIB26 in order to determine the suitability of a cell during and after cell reselection. A gNB may request neighbour gNB(s) over the Xn interface to transmit or stop transmitting the OD-SIB1 configuration for a cell supporting OD-SIB1. The neighbour gNB(s) deciding to stop the OD-SIB1 configuration transmission informs the requesting gNB over Xn.

For adaptation of paging in time domain, the value range for parameter N, which is the number of paging frames in one paging cycle, is extended to make it possible to have increased interval between PFs. The value range for Ns, which is the number of paging occasions within one paging frame, is increased to compensate the decrease in the number of PFs. UEs supporting paging adaption and PEI can monitor PEI according to the additional PEI configuration, if configured.

Adaptation of SSB in time domain is supported for SCells for UEs in RRC_CONNECTED configured with carrier aggregation (CA). SSB adaptation is indicated via DCI. Multiple SMTC configurations can be configured to the UE, and the UE selects one SMTC based on the SSB adaptation indication.

Adaptation of PRACH configurations in time domain is supported for 4-step RACH CBRA. Furthermore, additional PRACH resource 1-bit indication in PDCCH-order applies to both CFRA and CBRA in the serving cell. Additional RACH resources are configured together with the common RACH resources in the same set of RACH resources, and the network can indicate via DCI whether the additional RACH resources are available.

In various embodiments or examples throughout the present disclosure, a 6G base station (6G gNB) or a 5G/4G gNB can be replaced with other corresponding network nodes, such as 6G integrated access and backhaul (IAB) or 6G network-controlled repeater (NCR) or 6G reconfigurable intelligent surface (RIS), or such as 5G NCR or IAB node, or a 4G relay or repeater node. In various embodiments, a 6G UE or a 5G/4G UE can operate in relation with multiple network nodes corresponding to a certain RAT (same RAT as that for the UE, or different RAT than that for the UE), such as both a 6G gNB and a 6G IAB/NCR/RIS, or both a 5G gNB and a 5G IAB/NCR, or both a 4G eNB and 4G relay/repeater node.

In various embodiments and examples throughout the present disclosure, a 6G/5G gNB or a 4G eNB can refer to a central unit (CU) or a distributed unit (DU) or a remote unit (RU) or a transmission-reception point (TRP) or other architectural units or functional/logical entities for a corresponding base station, or a variation or collection or combination thereof.

Various embodiments, methods, and examples in the present disclosure are described in terms of downlink control channel, such as PDCCH/DCI. Similar methods can apply to various other downlink or uplink channels or signals, such as PUCCH/UCI, PRACH, SSB, CSI-RS, SRS, and so on.

In one embodiment, a UE can be provided L1/L2 signaling to indicate or update/overwrite parameters of a UE DRX procedure, including at least one or both of a DRX-ON timer and DRX Inactivity timer. Such UE procedure can be beneficial, for example, to adapt the DRX pattern with the traffic pattern. L1/L2 signaling can include a GC-DCI format, such as DCI format 26 (or a different GC-DCI format), or an DL signal such as LP-WUS, that provides indication of wake-up/no-wake-up for next DRX cycles, as well as information of DRX parameters. Alternatively, such information can be provided in a UE-specific, scheduling DCI format, such as by a PDCCH adaptation field that jointly indicates both PDCCH skipping and/or SSSG switching indication as well DRX parameter indication. The UE may provide HARQ-ACK information in response to such L1/L2 signaling. The UE can apply the DRX parameters indicated by L1/L2 signaling upon reception of such signaling, or after a processing time from a time of reception of the L1/L2 signaling or transmission of an associated HARQ-ACK.

For example, the UE can be configured 2 or 4 values (from a first predetermined set of 32 values) for drx-onDurationTimer or 2 or 4 values (from a second predetermined set of 32 values) for drx-InactivityTimer. For example, the UE can be configured a joint mapping with 2 or 4 codepoints, wherein each codepoint indicates both a value for drx-onDurationTimer and a value for drx-InactivityTimer. Similar can apply to other DRX parameters and timers, such as shortDRX or drx-LongCycleStartOffset.

For example, there may be an initial/default values that is predetermined in the specifications of system operation or is configured by higher layers. For example, a value indicated by L1/L2 signaling can overwrite such initial/default values or can overwrite a previously configured value.

For example, the UE can be provided more than one configuration (or sub-configuration) for DRX, such as 2 or 4 configurations (or sub-configurations) for DRX, providing value for various DRX parameters, and L1/L2 signaling can indicate an ‘active’ DRX configuration from such more than one configuration (or sub-configuration).

For example, the UE can monitor a DCI format, such as a group-common DCI (GC-DCI) format in a CSS, that indicates values for such DRX parameters. For example, the GC-DCI format can have a CRC that is scrambled by a D-RNTI that is commonly configured to a group of UEs. The GC-DCI can include a number of information blocks, with each block corresponding a UE from the group of UEs (such as block #1 for UE #1, block #2 for UE #2, and so on), as indicated for example by a positionInDCI, and indicating values of DRX parameters for a corresponding UE. A size of a GC-DCI format associated with D-RNTI can be configured by higher layers.

In another example, an L1/L2 indication for DRX extension (i.e., ‘wake-up’ or ‘no-wake-up’ indication) can also indicate DRX parameters. For example, a DCI format such as DCI format 2_6 or a DL signal such as a low-power wake-up signal (LP-WUS), that indicates to a UE whether to start or not start a DRX Active time in a next DRX cycle (such as DRX long cycle), can also indicate DRX parameters for future DRX cycle(s). For example, the DCI format 2_6 or the LP-WUS can provide an additional field/information with 1 or 2 bits to indicate the DRX parameters, at least when the UE is indicated to start the DRX Active time in the next DRX cycle. When the UE is indicated, by DCI format 26 or by the LP-WUS, to not start the DRX Active time in the next DRX cycle, such additional field/information is absent or is reserved or is reused for other indication (such as a number of DRX cycles that the UE can continue to ‘sleep’).

In another example, the UE can receive such indication of DRX parameters as a field in a UE-specific DCI format, such as a scheduling DCI format. For example, the indication can be joint with some other fields in the DCI format, such a PDCCH adaptation field. For example, specifications for system operation can include UE procedures, such those described in Table 1. For example, a value ‘0’ or ‘00’ of a PDCCH adaptation field of a scheduling DCI format, such as DCI format 0_1/0_2/0_3 or 1_0/1_1/1_2, can indicate a first value for PDCCH skipping or a first SSSG index for PDCCH monitoring, and also indicate a first value for DRX parameters. In another example, the UE-specific/scheduling DCI format can include a field for DRX parameter indication, separate from a PDCCH adaptation field.

TABLE 1
Example of joint UE procedure for PDCCH skipping and DRX procedure

| | PDCCH adaptation (PDCCH | |
|---|---|---|
| Codepoint | skipping or SSSG switching) | DRX parameter indication |
| 00 | No skipping or SSSG index 0 | First value(s) for drx-onDurationTimer |
| | | and/or drx-InactivityTimer |
| 01 | Skipping for a first duration | Second value(s) for drx-onDurationTimer |
| | or SSSG index 1 | and/or drx-InactivityTimer |
| 10 | Skipping for a second duration | Third value(s) for drx-onDurationTimer |
| | or SSSG index 2 | and/or drx-InactivityTimer |
| 11 | Skipping for a third duration | Fourth value(s) for drx-onDurationTimer |
| | SSSG index 3 (if configured) or | and/or drx-InactivityTimer |
| | reserved | |

Such example can be extended wherein higher layers provide a number of configurations, such as 2 or 4 configurations, for a number of parameters. For example, each configuration, from the number of configurations provide respective values for (one or) a combination of PDCCH skipping, applicable SSSG, UE DRX parameters, Cell DTX/DRX parameters, CORESET parameters, CORESET group/TRP adaptation, UE/cell/carrier state, enabled or disabled or adapted DL/UL signals or channels and corresponding parameters, and so on. For example, L1/L2 signaling such as a field in a DCI format or a parameter of a sequence-based DL WUS can indicate one value from 2 or 4 values (e.g., configuration index) to indicate a corresponding configuration from the 2 or 4 configurations. In a variation, more than one field or more than one parameter can be used in an L1/L2 signaling to indicate different combinations/subsets of such parameters, such as a first combination for PDCCH skipping, SSSG, UE DRX, and CORESET parameters, and a second combination for Cell DTX/DRX and UE/cell/carrier state and CORESET group/TRP adaptation or ON/OFF.

In one variation, a UE-specific DCI format can be a scheduling DCI format that does not schedule a PDSCH reception or a PUSCH transmission (for example, with some fields, such as FDRA, set to reserved values). In another variation, the UE-specific DCI format can be a standalone DCI format, with several fields that provide various control information to the UE, such as with first fields indicating DRX parameters, second fields indicating CORESET parameters, third fields indicating PDCCH skipping or SSSG switching information, and so on.

In another example, the UE can receive an indication of DRX parameters using a MAC-CE command.

For example, the UE can provide HARQ-ACK information in an UL channel, such as a PUCCH or a PUSCH, in response to reception of an L1/L2 signaling that indicates DRX parameters. For example, a PUCCH resource or PUCCH timing can be commonly configured to a same of UEs that are configured a common D-RNTI value (e.g., within configuration of a CSS that provides the D-RNTI value), or a PUCCH resource can be indicated by the GC-DCI format associated with D-RNTI. For example, the UL channel can be sequence-based, and a/each UE can be configured a dedicated cyclic shift or cover code to provide a separate HARQ-ACK information in a same time/frequency PUCCH resource. In another example, a HARQ-ACK can be in NACK only, for example, the UE only transmits a NACK when the UE does not receive a GC-DCI associated with D-RNTI in a monitoring occasion for the GC-DCI format, otherwise skips to transmit any HARQ-ACK information.

For example, the UE applies DRX parameters that are indicated by L1/L2 signaling upon reception of such L1/L2 signaling, or after a processing time or application time from reception of the L1/L2 signaling, or from transmission of an UL channel that provides HARQ-ACK information associated with the L1/L2 signaling. For example, the processing/application time can be in terms of an absolute time duration, such as a number of msec, or in terms of a number of symbols or slots in a certain SCS, such an SCS for reception of the L1/L2 signaling or an SCS for transmission of the UL channel with corresponding HARQ-ACK information. For example, the processing/application time can be predetermined in the specifications of system operation or can be indicated by higher layers.

In one example, only ACK feedback applies to reception of a DL WUS or a DCI format providing such indication for PDCCH skipping, SSSG switching, DRX parameter update, and so on. For example, the UE provides an ACK when the UE receives such DL WUS/DCI, and the UE does not provide any HARQ-ACK feedback when the UE does not receive any such DL WUS/DCI.

In another example, both ACK and NACK may apply to reception of a DL WUS or a DCI format providing such indication for PDCCH skipping, SSSG switching, DRX parameter update, and so on. For example, the UE provides an ACK when the UE receives such DL WUS/DCI, and the UE provide a NACK when the UE does not receive such DL WUS/DCI in a respective configured candidate occasion, such as a candidate occasion for the DL WUS or a monitoring occasion for a PDCCH/DCI. For example, the UE can be provided a separate search space set for the PDCCH/DCI (or possibly for the DL WUS) that provides such indication, from other search space sets for other PDCCH/DCI formats (or other DL WUS for other purposes).

Various methods can apply for an application time of an indication provided by a sequence-based DL WUS or a PDCCH-based WUS. For example, the UE applies indications or updates for one or more of PDCCH skipping, SSSG switching, UE DRX/DTX parameters, Cell DTX/DRX parameters, CORESET parameters, CORESET group/TRP/cell/carrier adaptation or ON/OFF, cell/carrier state, and so on, from a first symbol or slot that is:
after a last (or a first) symbol or slot, respectively, for reception of the DL WUS/LP-WUS or the DCI/PDCCH-based WUS, or
N symbols or slots after a last (or a first) symbol or slot, respectively, for reception of the DL WUS/LP-WUS or the DCI/PDCCH-based WUS,
after a last (or a first) symbol or slot, respectively, for transmission of an UL channel that provides a HARQ-ACK feedback in response to reception of the DL WUS/LP-WUS or the DCI/PDCCH-based WUS, or
M symbols or slots after a last (or a first) symbol or slot, respectively, for transmission of an UL channel that provides a HARQ-ACK feedback in response to reception of the DL WUS/LP-WUS or the DCI/PDCCH-based WUS.

Herein, a value of N or M can be same or different. Herein, values or N or M can be predetermined in the specifications of system operation or can be configured by higher layers or can be indicated by L1/L2 signaling, such as a same L1/L2 signaling that provides the indication, or can be based on a UE capability. Herein, a value of M can be based on a value for a HARQ-related timer, such as a one-side (one-way) timer or a two-sided (round-trip time or RTT) timer for HARQ-ACK feedback, for example, a DL/UL HARQ retransmission timer, or a DL/UL HARQ RTT timer.

For example, there can be an association between C-DRX parameter and SSSG index for PDCCH monitoring inside Active time. For example, the UE can be configured by higher layers or indicated by L1/L2 signaling an association between a first SSSG (for example, SSSG index 0) with first parameters for C-DRX (e.g., first values for ON duration timer, or inactivity timer), and an association between a second SSSG (for example, SSSG index 1) with second parameters for C-DRX (e.g., second values for ON duration timer, or inactivity timer).

In one embodiment, a UE (at least in RRC_CONNECTED state) can receive an LP-WUS for the purpose of PDCCH monitoring adaptation, such as for indication of PDCCH skipping or indication of search space set group (SSSG) switching or for indication of ‘wake-up’ or ‘no-wake-up’ for a configured DRX procedure in one or more next DRX cycles. An LP-WUS may also apply as a ‘[forced] ON’ indication to override a configured DRX or a previously indicated PDCCH skipping, such that LP-WUS can trigger the UE to terminate a DRX cycle or a PDCCH skipping duration, and start PDCCH monitoring as if start of a next DRX cycle or as if no PDCCH skipping. When a UE does not receive an LP-WUS in a configured monitoring occasion for LP-WUS, the UE can operate PDCCH monitoring per search space set configurations and per the configured DRX procedure. Alternatively, the UE can continue to apply a last indication of LP-WUS until a different indication is received in a later LP-WUS or in a different L1/L2 signaling.

For example, a UE can be configured to receive a 1-bit or 2-bit information field in an LP-WUS that indicates a duration from 1 or 3 configured durations for PDCCH skipping, using, for example, values ‘01’ or ‘10’ or ‘11’ to indicate a first/second/third configured duration. For example, one value of the information field such as ‘00’ can [be reserved to] indicate no PDCCH skipping (that is, a trigger for starting PDCCH monitoring), in which case, the UE starts PDCCH monitoring upon reception of the LP-WUS (or from a start of a next DRX cycle).

For example, the UE starts to skip PDCCH monitoring for the indicated duration starting from:
a first slot/symbol that is after a last symbol/slot in which the UE receives the LP-WUS with the PDCCH skipping indication, or
a starting symbol/slot of DRX Active time of a next DRX cycle, or
an earlier of (or a later of): a starting symbol/slot of DRX Active time of a next DRX cycle; and a first slot/symbol that is after a last symbol/slot in which the UE receives the LP-WUS with the PDCCH skipping indication.

In a variation, the starting time for PDCCH skipping duration can be offset (from the last symbol (or slot) in which the UE receives the LP-WUS with the PDCCH skipping indication) by one or both of a PDCCH skipping offset value configured by higher layers or by a processing/application time that can be based on UE capability or can be predetermined in the specifications of system operation.

For example, a UE can be configured to receive a 1-bit or 2-bit information field in an LP-WUS that indicates an SSSG index from 2 or 3 configured SSSGs for PDCCH monitoring. For example, the UE can be configured 2 SSSGs, and 1-bit in LP-WUS can indicate PDCCH monitoring according to SSSG index 0 or SSSG index 1. For example, the UE can be configured 3 SSSGs, and 2 bits in LP-WUS can indicate PDCCH monitoring according to SSSG index 0 or SSSG index 1 or SSSG index 2, for example, using values ‘00’ or ‘01’ or ‘10’, respectively, while a fourth value such as ‘11’ can be reserved.

For example, the UE starts to monitor PDCCH according to an indicated SSSG starting from a first symbol/slot that is P symbols after:
a last symbol/slot in which the UE receives the LP-WUS with the SSSG switching indication, or
a starting symbol/slot of DRX Active time of a next DRX cycle, or
an earlier of (or a later of): a starting symbol/slot of DRX Active time of a next DRX cycle;
and a last symbol/slot in which the UE receives the LP-WUS with the PDCCH skipping indication.

For example, the P symbols can be a processing/application time that can be based on UE capability or can be predetermined in the specifications of system operation. For example, a starting time for an application of the SSSG switching indicated by the LP-WUS can be additionally offset by an offset value that is configured by higher layers.

For example, a UE can be configured to receive a 2-bit information field in an LP-WUS that indicates either or both of PDCCH skipping or SSSG switching. For example, first values of the 2-bit field, such as ‘00’ and ‘01’, can indicate an SSSG index (e.g., one of two SSSG indexes) and second values such as ‘10’ and ‘11’ can indicate a PDCCH skipping duration (e.g., no skipping vs. skipping, or first/second duration for PDCCH skipping).

Alternatively, an LSB of the 2-bit field in LP-WUS can indicate an SSSG index and an MSB can indicate a PDCCH skipping duration. For example, the UE starts to monitor PDCCH according to an indicated SSSG index after an indicated duration for PDCCH skipping (or possibly without any skipping, when no skipping is indicated).

In another example, the 2-bit field in LP-WUS can indicate a codepoint from 4 configured codepoints, wherein the/each codepoint indicates a pair/combination of SSSG index and PDCCH skipping duration. For example, a first codepoint indicates a first SSSG index and a first duration for PDCCH skipping, a second codepoint indicates a second SSSG index and a second duration for PDCCH skipping, and so on. For example, the UE monitors PDCCH according to the indicated SSSG index after an indicated duration for PDCCH skipping.

For example, a timeline for application for application of such mixed indication can be a corresponding timeline when the 2-bit field in LP-WUS indicates only one of the two operations (e.g., only PDCCH skipping, or only SSSG switching). For example, a timeline can be a longer timeline among the two timelines when the 2-bit field indicates both PDCCH skipping and SSSG switching operations, i.e., the UE starts to monitor PDCCH per the indicated indications after a later of the corresponding two timelines.

For example, a UE can be configured to receive a 1-bit indication in an LP-WUS that indicates ‘wake-up’ or ‘no-wake-up’ for a configured DRX procedure. For example, a value ‘0’ can indicate to not start a next long DRX cycle, and a value ‘1’ can indicate to start a next long DRX cycle.

For example, an indication can include 1 or 2 additional bits (i.e., a total of 2-3 bits) to indicate a number of long DRX cycles, from 2 or 4 configured numbers of long DRX cycles, that a UE applies the indicated ‘wake-up or ‘not wake-up’. For example, the UE will wake-up or will refrain from waking up for an indicated number of next long DRX cycles as indicated by LP-WUS.

For example, when a UE is outside DRX Active time, for example, when the UE has already started a (short or) long DRX cycle, or when the UE is within a PDCCH skipping duration, the UE can receive an indication by LP-WUS to terminate the (short or) long DRX cycle or the PDCCH skipping, and start PDCCH monitoring in a first symbol/slot after reception of the LP-WUS with DRX/skipping termination indication, or possibly after a predetermined or configured offset from reception of the LP-WUS with DRX/skipping termination indication.

In one variation, a UE may follow timing of DRX patterns, such as the configured ON timer or Inactivity timer, while a DL WUS/LP-WUS/PDCCH-based WUS can indicate whether the UE to wake-up or not wake-up for a next DRX cycle, for example to skip a next Active/ON time of the next DRX cycle. For example, the DL WUS/LP-WUS/PDCCH-based WUS may not indicate or update the DRX parameters.

In another variation, a UE may or may not be configured parameters for DRX operation, but when the UE receives (or is configured to receive) DL WUS/LP-WUS/PDCCH-based WUS, the UE ignores the DRX configuration, may not perform any DRX operation, and instead operate based on the DL WUS/LP-WUS/PDCCH-based WUS, and corresponding indications or timers. For example, upon reception of DL WUS/LP-WUS/PDCCH-based WUS, the UE start PDCCH monitoring according to configured/indicated search space sets or a configured/indicated/reference SSSG (and possibly apply other indications) for a time duration or a number of symbols or slots that is configured by higher layers or indicated by the DL WUS/LP-WUS/PDCCH-based WUS or until expiry of a timer associated with the DL WUS/LP-WUS/PDCCH-based WUS.

In yet another variation, a UE can be configured parameters for DRX operation, such as values for ON timer or Inactivity timer, and when the UE receives (or is configured to receive) a DL WUS/LP-WUS/PDCCH-based WUS, the does not ignore the configured DRX operation/parameters, and continues to operate based on the configured DRX operation, while the DL WUS/LP-WUS/PDCCH-based WUS can indicate start or stop a cycle of the configured DRX operation, such as start of DRX Active time or stop of DRX non-active time, or the DL WUS/LP-WUS/PDCCH-based WUS may additionally or alternatively indicate updated values for one or more of the DRX parameters.

In one example, a UE may (be configured to) monitor both PDCCH and LP-WUS/DL WUS in respective occasions of a certain time period, such as during DRX active time or during a general Active time based on a UE/cell/carrier state. In another example, the UE can be configured to monitor only one of PDCCH and LP-WUS/DL WUS. For example, when the UE is configured to monitors PDCCH, the UE is not expected to monitor LP-WUS/DL WUS, and when the UE is configured to monitor DL WUS/LP-WUS, the UE does not expect to monitor PDCCH. Herein, PDCCH may include any PDCCH or may include only PDCCH for scheduling PDSCH/PUSCH, or may include PDCCH associated only with certain RNTIs or certain DCI formats or certain search space sets or, such as UE-specific search space (USS) set or certain common search space (CSS) sets, such as Type-3 CSS sets for UE-group-common signaling. For example, PDCCH herein may or may not include PDCCH for broadcast/cell-specific signaling, such as for system information, paging, random access, and so on, such one or more of Type-0/0A/1/1A/2/2A CSS sets. For example, when the UE is configured to monitor DL WUS/LP-WUS, the UE may be configured to also monitor PDCCH according to a certain SSSG, such as a reference SSSG, for example, SSSG with index 0, or an SSSG with index configured by higher layers. For example, the UE may not monitor PDCCH according to other SSSGs. For example, an SSSG may include one or more of USS sets, or one or more of CSS sets, such as Type-3 CSS sets for UE-group signaling, or additionally or alternatively, CSS sets for broadcast PDCCH, such as Type-0/0A/1/1A/2/A CSS sets. For example, the UE may monitor or receive DL WUS/LP-WUS and such limited PDCCH using a separate receiver, such as a low-power receiver (LR), or using a subset (e.g., a strict subset) of radio/RF chain/antenna components of a same main receiver (MR) that is used when the UE monitors PDCCH without restriction (and possibly without DL WUS/LP-WUS monitoring).

For example, a UE can receive a sequence-based DL WUS/LP-WUS that can provide same information content as a PDCCH or DCI format, such as broadcast/fallback DCI format, for example, DCI format 0_0 or 1_0 for system information or for paging or for RAR, and so on. For example, the UE may not need to monitor PDCCH when the UE is configured to monitor such DL WUS/LP-WUS.

For example, an indication in the LP-WUS/DL WUS can indicate to the UE one of (a) continue to extend sleep/no-wake-up for an additional time duration, for example, for additional UE power saving, or (b) to terminate the sleep and get back on even though the ‘sleep cycle/duration’ (such as one based on DRX timers or based on PDCCH skipping indication or based on UE/cell/carrier state configuration or indication) is not complete yet. For example, the latter indication can be beneficial, for latency-sensitive or bursty traffic, such as for URLLC or XR or generative AI/token-based traffic. For example, an indication for (b) may be a positive indication, such as ‘wake-up’ indication (e.g., a 1 for a UE or a UE-group/sub-group), while an indication for (a) may be with a negative indication, such as ‘no-wake-up’ (e.g., a 0 for a UE or a UE-group/sub-group) or the UE may not receive any DL WUS/LP-WUS in monitoring occasions associated with the UE or the UE-group/sub-group. For example, the former method can be more beneficial for additional NW energy saving, while the latter method can be more beneficial for additional UE power saving.

For example, the UE may monitor or receive DL WUS/LP-WUS outside Active time of DRX or during PDCCH skipping or generally during a dormant state for a UE/cell/carrier. In another example, the UE may, additionally or alternatively, monitor or receive DL WUS/LP-WUS during Active time of DRX or after termination of PDCCH skipping or generally during an active state or any state for a UE/cell/carrier, or regardless of whether or not such DRX or skipping or UE/cell/carrier state is configured.

For example, first radio/PHY components, such as a main radio (MR), for PDCCH reception can be in ‘sleep’ mode during a (short or) long DRX cycle or within a PDCCH skipping duration, while second radio/PHY elements, such as a low-power radio (LR) also known as a low-power wake-up receiver (LP-WUR), can monitor and receive LP-WUS continuously or in certain configured monitoring occasions (MOs).

For example, LP-WUS MOs can overlap with (short or) long DRX cycle or with a PDCCH skipping duration. For example, for increased power saving, a first configuration for LP-WUS MOs outside DRX Active time or within PDCCH skipping duration can be different from (e.g., less LP-WUS MOs than) a second configuration for LP-WUS MOs within DRX Active time.

For example, the UE monitors LP-WUS according to the first configuration in order to receive an a DRX extension indication or a PDCCH skipping indication, and monitors LP-WUS according to the second configuration in order to receive an a DRX termination indication or a PDCCH skipping termination indication.

For example, the UE applies the first configuration starting from a first symbol/slot when the UE is outside DRX Active time, such as a first symbol/slot of a (short or) long DRX cycle, or starting from a first symbol/slot of a PDCCH skipping duration. For example, the UE applies the second configuration starting from a first symbol/slot when the UE is within DRX Active time, or starting from a first symbol/slot after a last symbol/slot of a PDCCH skipping duration.

In one example, LP-WUS can indicate a termination of a PDCCH skipping duration only when the PDCCH skipping duration is longer that a predetermined or configured threshold. For example, when a previously indicated PDCCH skipping indication, the UE does not expect to receive an indication by LP-WUS to terminate the PDCCH skipping duration, or the UE may discard the indication if the UE receives such indication by LP-WUS.

In one example, when a UE is configured monitoring occasion (MOs) for LP-WUS, and the UE does not receive an LP-WUS in a MO from the configured MOs, in one option, the UE continues to monitor or not monitor PDCCH same as when LP-WUS would not be configured. For example, the UE continues to monitor PDCCH according to search space configurations and suspends PDCCH monitoring according to DRX configurations and corresponding L1/L2 signaling, such as DCP (DCI format 2_6 associated with PS-RNTI) or DRX MAC CE, or according to PDCCH skipping or SSSG switching indications.

In another option, the UE continues to monitor or not monitor PDCCH based on a last/latest indication provided by LP-WUS for indication, extension, or termination of PDCCH skipping or DRX, until a different indication is received in a later LP-WUS or by other L1/L2 signaling. For example, when a first LP-WUS in a first/earlier LP-WUS MO indicates to the UE to wake-up for the next one or more (short or) long DRX cycles, and the UE does not receive an/any LP-WUS in a second/later LP-WUS MO, the UE determines to wake-up for the next one or more (short or) long DRX cycles as was indicated by the first LP-WUS. Similar holds for PDCCH skipping or for SSSG switching.

For example, it may be specified that a UE can interpret a joint indication for multiple of DRX wake-up/no-wake-up, PDCCH skipping, and SSSG switching in terms of a combination [or pattern] for such indications across multiple time intervals, such as multiple (short or) long DRX cycles. For example, an indication can be a codepoint that refers to multiple such indications for multiple (short or) long DRX cycles. For example, the UE can be configured a first mapping for a first number of DRX cycles, and a second mapping for a second number of DRX cycles. For example, the UE determines an applicable combination based on a mapping that corresponds to an indicted number of DRX cycles. In another example, the UE can be configured a single mapping that includes combinations for N DRX cycles (e.g., such as N=4 or N=8), such that each codepoint provides indications for N DRX cycles, and when an indicated number of DRX cycles is M≤N, the UE determines an applicable combination for the M DRX cycles based on a first M entries of an indicated codepoint in the single configured mapping.

In one example, the UE does not expect to receive different/conflicting LP-WUS indications for PDCCH skipping, SSSG switching, or DRX in different LP-WUS MOs. For example, when a first LP-WUS in a first LP-WUS MO indicates to wake-up (respectively, not-wake-up) for the next one or more (short or) long DRX cycles, the UE does not expect to receive a second LP-WUS, in a second LP-WUS MO that is after the first LP-WUS MO and is before the completion of the one or more (short or) long DRX cycles, to indicate no-wake-up (respectively, wake-up) for some of the same one or more (short or) long DRX cycles. Similar holds for PDCCH skipping or for SSSG switching.

In another example, the UE may receive such different/conflicting LP-WUS indications in different LP-WUS MOs, for example, to facilitate fast adaptation of PDCCH skipping, SSSG switching, or DRX. For example, a second indication by a first LP-WUS reception in a second/later LP-WUS MO can override a first indication by a first LP-WUS reception in a first/earlier LP-WUS MO.

In one example, when the UE does not receive an LP-WUS in an LP-WUS monitoring occasion, the UE continues a dormancy period, such as no wake-up for the next short/long DRX cycle, or extends a PDCCH skipping duration.

For example, when the UE does not receive an LP-WUS for a time duration that is longer than a first threshold or for a number of LP-WUS reception occasions that is larger than a second threshold, the UE stops monitoring the LP-WUS (e.g., switches off a low-power radio or LR), and starts monitoring PDCCH (e.g., resumes a main radio or MR). The time duration can be in absolute sense, such as millisecond or microseconds, or in terms of slots/sub-slots/symbols, and so on. The first threshold or the second threshold can be predetermined in the specifications of system operation or can be configured by higher layers or can be indicated by L1/L2 signaling, such as a group-common DCI (GC-DCI) format or a previous LP-WUS.

In one example, a DL WUS/LP-WUS/PDCCH-based WUS can include or indicate information of an applicable SSSG, such as a SSSG associated with infrequent PDCCH monitoring (e.g., with large periodicity for PDCCH monitoring), or an SSSG associated with frequency PDCCH monitoring (e.g., with short periodicity for PDCCH monitoring).

In another example, a DL WUS/LP-WUS/PDCCH-based WUS may not include or indicate information for an applicable SSSG. For example, the specifications of system operation can predetermine or higher layer signaling can configure an applicable SSSGs before or after reception of a DL WUS. For example, when a DL WUS/LP-WUS/PDCCH-based WUS indicates the UE to switch from no-wake-up/sleep mode to wake-up mode, the UE can be predetermined (or configured) to switch from an SSSG with very infrequent PDCCH monitoring (e.g., matched to paging or SIB updates) to an SSSG with frequent one. For example, the UE monitors a reference SSSG, such as SSSG with index 0, outside Active time of DRX or during PDCCH skipping, or during a dormant state of a UE/cell/carrier, such as one indicated by a DL WUS/LP-WUS/PDCCH-based WUS. For example, the UE receive a configured or a reference SSSG prior or reception of a DL WUS/LP-WUS/PDCCH-based WUS (that indicates wake-up).

In one example, a DL WUS/LP-WUS/PDCCH-based WUS can separately or jointly indicate or update CORESET parameters, such as a duration in number of OFDM symbols, a number of RBs, a symbol offset or an RE offset, an applicable modulation order or TCI state, a time or frequency domain mapping type or parameters, and so on. For example, such parameters can apply to a reference CORESET that the UE is predetermined (or configured) to monitor after wake-up as indicated by a DL WUS/LP-WUS/PDCCH-based WUS, or can apply to a CORESET associated with an SSSG that is predetermined or configured to be monitored after such wake-up, or to a CORESET whose index is indicated by the DL WUS/LP-WUS/PDCCH-based WUS, or to a CORESET that is associated with an SSSG that is indicated by the DL WUS/LP-WUS/PDCCH-based WUS. For example, a DL WUS/LP-WUS/PDCCH-based WUS can indicate parameters for more than one CORESETs, such as by indicating indexes of the one or more CORESETs, or by indicating a bitmap that is associated with all configured CORESETs, along with respective values for the respective CORESET parameters. For example, indication of CORESET parameters can be jointly or separate from indication of SSSG index/parameters.

In one example, a DL WUS/LP-WUS/PDCCH-based WUS can indicate indication of enabling or disabling (also known as, ON/OFF) or adaptation for a cell or a carrier or a TRP. For example, a DL WUS/LP-WUS/PDCCH-based WUS can indicate that a cell/carrier is activated (ON) or deactivated (OFF). For example, a DL WUS/LP-WUS/PDCCH-based WUS can indicate that different TRPs of a cell are activated/enabled (ON) or deactivated/dormant (OFF). For example, a TRP can be associated with a set or group of signals or channels, such an sync signal group for example SSB indexes or PSS/SSS indexes, or a group of CORESETs, such as a CORESET pool index, or a set of TCI states or spatial filters, and so on. For example, the DL WUS/LP-WUS/PDCCH-based WUS can indicate a TRP to be OFF by indicating that a certain/respective CORESET pool index is disabled (e.g., no PDCCH monitoring in respective CORESETs) or when corresponding SSB indexes or TCI states are deactivated or disabled or not transmitted/received.

For example, a DL WUS/LP-WUS/PDCCH-based WUS can indicate that only one of two TRPs are ON, or can switch between both TRPs being ON versus only first TRP (or only second TRP) being ON. For example, the indication can be by a different parameter/field of a same DL WUS/LP-WUS/PDCCH-based WUS that starts PDCCH monitoring, or can be using a separate DL WUS (before or after PDCCH enabling).

For example, a DL WUS/LP-WUS/PDCCH-based WUS can be dedicated to a certain UE via UE-specific signaling/transmission/reception/occasions, or can be UE-group-specific, using UE-group-specific signaling/transmission/reception/occasions. Similar holds for cell-specific DL WUS/LP-WUS/PDCCH-based WUS via cell-specific signaling/transmission/reception/occasions.

For example, before any RRC connection such as during cell search or initial/random access, or during RRC IDLE/INACTIVE state, a DL WUS/LP-WUS/PDCCH-based WUS can indicate arrival of SSB or SIB or paging or RAR or other broadcast/cell-specific or UE-group-specific PDCCH and so on. For example, a DL WUS/LP-WUS/PDCCH-based WUS can indicate whether PRACH or certain OD-SSB or OD-PRACH or aperiodic TRS or CSI-RS or SRS is enabled or disabled or whether such signals or channels are triggered and are to be received or transmitted.

For example, cross-cell/carrier operation can apply to DL WUS/LP-WUS/PDCCH-based WUS. For example, a UE can receive a DL WUS/LP-WUS/PDCCH-based WUS on a first cell that provides adaptation indication for a second cell. For example, a UE can receive a DL WUS/LP-WUS/PDCCH-based WUS on a first cell, wherein the DL WUS/LP-WUS/PDCCH-based WUS can include a second indication (such as a cell index or cell combination index or a bitmap for the configured cells) whether the adaptation indication applies to the first cell or applies to a second cell, different from the first cell, or to a number of cells, that include or exclude the first cell. For example, the adaptation indication can be for a number of cells such a group of cells or a set of cells. For example, certain parameters of an adaptation indication can be cell-common, such as wake-up or no-wake-up indication or a cell/carrier state that can apply to multiple cells or a group/set of cells, while certain other parameters of the adaptation indication can be cell-specific, such as an applicable SSSG, or applicable CORESET parameters, or CORESET group/TRP activation or deactivation, and so on.

Herein, the adaptation indication can include one or more of: wake-up or no-wake up for PDCCH monitoring (or various other DL/UL transmissions or receptions), or applicable SSSG, or PDCCH skipping indication or parameters, or DRX parameters, or Cell DTX/DRX parameters, or CORESET parameters, or CORESET group/TRP/carrier/cell activation or deactivation (ON/OFF) or adaptation, or carrier/cell/TRP state, and so on.

In one embodiment, a UE can receive a same signaling to indicate more than one UE power saving indications, such as more than one of DRX wake-up/no-wake-up, and PDCCH skipping, and SSSG switching. In addition, the UE may receive such signaling at any time, or in monitoring occasions (MOs) in any time interval, such as within or outside DRX Active time, or within or outside a PDCCH skipping duration. Such signaling can be included in a GC-DCI format, or a scheduling DCI format that may or may not schedule a PDSCH reception or a PUSCH transmission. Additionally, the signaling can provide an indication for a group of cells, and the UE applies the indication to the group of cells.

For example, an indication for PDCCH skipping can apply to a single cell, based on a cell index provided in the PDCC skipping indication or based on a USS/CSS set or a monitoring occasion or a WUS candidate occasion in which the UE received a PDCCH/DL WUS that provides the PDCCH skipping indication.

For example, an indication for PDCCH skipping can apply to multiple cells, such as a group of cells, or all configured/activated cells. For example, the UE can be configured two groups of cells for PDCCH skipping, and a DL WUS/LP-WUS/PDCCH-based WUS can indicate whether a PDCCH skipping applies to none or one or both of a first group of cells or a second group of cells.

In one realization, a field in a first DCI format, such as a PDCCH adaptation field in a DCI format 0_1/0_2/0_3 or 1_1/1_2/1_3, or a block of information in a DCI format 2_0 in NR, can indicate both PDCCH skipping or SSSG switching, and DRX wake-up/no-wake-up. For example, the UE receives such indication within a DRX Active time. For example, a number of DRX cycles applicable to the indication can be configured by higher layers or can be indicated by the first DCI format.

In a first method, the field in the first DCI format indicates a first value for PDCCH skipping or SSSG switching for an ongoing DRX Active time, and a second value to indicate wake-up or no-wake-up for a next one or more (short or) long DRX cycles. For example, the first value and the second value can be provided as separate sub-fields or bit strings of the field in the first DCI format, or can be provided by a single codepoint from a number (e.g., 4) codepoints, wherein each/the codepoint provides a pair or combination of a first values for PDCH skipping/SSSG switching and a second wake-up or no-wake-up indication, based on a joint encoding mapping.

In a second method, the field in the first DCI format indicates a first value for PDCCH skipping or SSSG switching indication and a second value for wake-up or no-wake-up indication, that are both applicable to a same DRX cycle or same multiple DRX cycles, such as next one or more (short or) long DRX cycles. For example, the indications provided by the field in the first DCI format do not apply to the ongoing DRX cycle, in which the UE receives the indication by the field in the DCI format. For example, the field of the first DCI format can indicate to the UE to wake-up in the next (short or) long DRX cycle, and to monitor PDCCH according to an indicated SSSG index after an indication duration for PDCCH skipping, or can indicate to the UE to no-wake-up for the next DRX cycle.

For example, fields in a second DCI format, such as DCI format 2_6 associated with PS-RNTI in NR (also referred to as a DCP), can indicate both DRX wake-up/no-wake-up, and PDCCH skipping or SSSG switching. For example, the UE receives such indication outside DRX Active time.

Various methods, such as those previously described under the first and second methods, can also apply with fields in the second DCI format, such as DCI format 2_6. For example, the fields of the second DCI format (e.g., 2_6) can indicate to the UE to wake-up in the next (short or) long DRX cycle, and to monitor PDCCH according to an indicated SSSG index after an indication duration for PDCCH skipping, or can indicate to the UE to no-wake-up for the next DRX cycle. Similar methods can apply to more than one next (short or) long DRX cycles, wherein a number of DRX cycles can be configured by higher layers or can be indicated by the second DCI format (e.g., 2_6).

In a variation, the UE can receive the first DCI format outside DRX Active time or within a PDCCH skipping duration, or the UE can receive the second DCI format within DRX Active time or outside a PDCCH skipping duration. For example, the first DCI format is same as the second DCI format.

In one realization, the first DCI format, such as a scheduling DCI format 0_1/0_2/0_3 or 1_1/1_2/1_3, that provides a PDCCH adaptation field (or more generally, the field for indication of more than one of DRX wake-up/no-wake-up, and PDCCH skipping, and SSSG switching) may not schedule a PUSCH transmission or a PDSCH reception.

For example, an FDRA field of the DCI format can include a reserved/invalid value, such as all 0s or all 1s. For example, an UL-SCH (or DL-SCH) indicator field of the DCI format has a value ‘0’ indicating no scheduled data. For example, certain first fields of the first DCI format may be additionally set to reserved values for verification or validation of the no scheduling.

For example, various second fields of the first DCI format that are normally associated with the scheduled PDSCH or PUSCH, such as one or more of {MCS, NDI, RV, HPN, antenna port (AP), SRI, TPMI, DMRS initialization} and so on, can be repurposed to provide a bitmap that indicate various parameters for DRX wake-up/no-wake-up, PDCCH skipping, SSSG switching, number of applicable DRX cycles, SCell dormancy indication, and so on.

For example, a bitmap that the UE determines from repurposing second fields of the first DCI format can correspond to UE power saving indications for multiple DRX cycles, such as a first one or more bits corresponding to a first DRX cycle, a second one or more bits corresponding to a second DRX cycle, and so on. For example, counting DRX cycles can start from an ongoing/current DRX cycle, or from an immediately next DRX cycle after an ongoing/current DRX cycle.

In another example, a bitmap that the UE determines from repurposing second fields of the first DCI format can correspond to UE power saving indications for multiple cells (including serving or non-serving cells), such as first bits for a first cell, second bits for a second cell, and so on.

For example, the first DCI format can be a GC-DCI format with a bitmap or a number of information fields/blocks, such that each bit in the bitmap or each information field/block indicates PDCCH skipping for a different cell. In another example, different bits or different information fields/blocks can indicate PDCCH skipping for different UEs.

In one realization, the first DCI format can provide a UE power saving indication for a group of cells. For example, a UE can be configured a list or group of cells for corresponding UE power saving indications. For example, the UE applies the power saving indications by the field (e.g., the PDCCH adaptation field) of the first DCI format to a configured group of cells that:
includes the scheduling cell on which the UE receives the first DCI format, or
includes a serving (or non-serving) cell at least when the first DCI format schedules a PDSCH reception or a PUSCH transmission on the serving (or non-serving) cell, or
whose cell group index is indicated by the first DCI format.

For example, a cell group configuration can correspond to PDCCH skipping. In another example, a cell group can be same for different UE power saving indications. For example, a cell group for PDCCH skipping can be same as a cell group that is configured for SSSG switching, such as cellGroupsForSwitchList, or for DRX procedure, such as primary and secondary DRX groups as configured by drx-ConfigSecondaryGroup.

For example, a cell group can be a master cell group (MCG) or a second cell group (SCG) or a primary or secondary PUCCH group, or serving cells of a MAC entity. For example, a cell group can be a collection of scheduled cells that are scheduled by a same scheduling cell, or are scheduled by different scheduling cells that share a same SCS configuration (on their respective active BWPs).

For example, a cell group configuration can be different for different UE power saving purposes. For example, the UE applies each indication to a respective cell groups, such as a first indication for DRX wake-up/no-wake-up indication to a respective DRX group, and a second indication for PDCCH skipping to a second cell group configured for PDCCH skipping, and a third indication for SSSG switching to a third cell group cellGroupsForSwitchList configured for SSSG switching. For example, the first and second and third cell groups can be (same or) different. For example, the UE can apply different conditions, as previously described, for determination of a respective cell group for each power saving indication.

In one example, a UE may be provided neither a DRX configuration nor an LP-WUS configuration. For example, UE power saving can be achieved by indications provided by PDCCH. For example, a UE can be provided:
a first indication for a first time-duration in which the UE can continue to monitor PDCCH (based on a certain SSSG index) and perform UE procedures, such as RS reception, RRM measurement, CSI reporting, and so on, or
a second indication for a second time-duration in which the UE can skip PDCCH monitoring, or can skip performing certain UE procedures such as certain RS reception, RRM measurement, CSI reporting, and so on, for example, as subsequently described herein.

For example, the first/second time duration can be an absolute time duration (e.g., in msec or micro-sec) or a number of slots/frames or a number of PDCCH monitoring occasions.

For example, the indication can be by a field such as a “PDCCH adaptation field” in a scheduling DCI or a block of information in a standalone/non-scheduling DCI, such as a group-common DCI (GC-DCI).

For example, when the second time duration is expired, the UE resumes PDCCH monitoring or resumes the UE procedures that were previously skipped during the second time duration.

For example, before the first time-duration is expired, the UE expects to receive another indication similar to the first indication to indicate continuing the PDCCH monitoring or UE procedures, or to receive the second indication for skipping PDCCH monitoring or certain UE procedures. For example, when the first time-duration is expired, and the UE receives none such indications, in one option, the UE continues to monitor PDCCH monitoring or perform UE procedures for a third time duration that is configured by higher layers, unless the UE receives one such indication that would override the third time duration. In another option, the UE continues skips PDCCH monitoring or skips performing certain UE procedures for a fourth time duration that is configured by higher layers, unless the UE receives one such indication that would override the fourth time duration.

In a variation, a UE can request start of PDCCH monitoring via an SR in a PUCCH or via a PRACH transmission, or the NW can indicate to the UE via a DL WUS or an LP-WUS to start or resume PDCCH monitoring, with or without indication of an applicable SSSG, and possibly also other UE procedures, e.g., measurements or activation of SPS PDSCH or CG PUSCH. The UE can continue PDCCH monitoring based on a first timer, for example until expiry of an ON timer that may or may not be extended by a second timer, such as an Inactivity timer, and/or until a field in a scheduling DCI (or a DCI without PDSCH/PUSCH scheduling or possibly a GC-DCI format) indicates to the UE to stop or suspend PDCCH monitoring and possibly also the aforementioned other UE procedures. The scheduling DCI can be a last DCI that completes serving of corresponding DL data for the UE or the UL buffer at the UE.

In one example, a UE can receive a DL WUS/LP-WUS/PDCCH-based WUS to start PDCCH monitoring that continues for a configured time period or for a time duration based on operation of one or more timers, such as an ON timer with or without operation of an Inactivity timer. For example, upon competition of the configured timer period or upon expiry of the corresponding timers, the UE stops PDCCH monitoring (at least for certain USS sets or CSS sets or SSSGs).

In another example, a UE can receive a DL WUS/LP-WUS/PDCCH-based WUS to start PDCCH monitoring. For example, the UE can be configured a time duration or timers for PDCCH monitoring. In addition, the UE can receive a DCI (or a DL WUS) that indicates PDCCH skipping, possibly before completion of the configured time period or before expiry of corresponding timers.

In yet another example, a UE can receive a DL WUS/LP-WUS/PDCCH-based WUS to start PDCCH monitoring. For example, the UE may not be configured a time duration or any timers for PDCCH monitoring. For example, the UE continues PDCCH monitoring (and various other DL/UL transmissions or receptions) until the UE receives a DCI format (or a DL WUS) that indicates PDCCH skipping (for a time duration or until reception of a next DL WUS/LP-WUS or PDCCH-based WUS).

In one embodiment, various HARQ-related designs are provided for increased UE power saving, such as: (i) terminating an indicated PDCCH skipping due to HARQ retransmission of PUSCH; (ii) including HARQ round-trip-time (RTT) in a timeline for terminating an indicated PDCCH skipping due to HARQ retransmission of PDSCH; and (iii) extending the DRX Active time for NACK values (and not for ACK values) associated with a PDSCH reception. Methods (i), (ii), and (iii) are subsequently described.

For example, when the UE identifies PDCCH skipping or DRX non-active time or any general dormant for a UE/cell/carrier/TRP, the UE determines that transmission of CG PUSCH is disabled. In addition, the UE does not expect to receive an UL grant/DCI that schedules a PUSCH, wherein the DCI or the corresponding PUSCH is after a time gap/offset before start of PDCCH skipping duration or start of DRX non-active time, or start of the dormant state of the UE/cell/carrier/TRP (e.g., because any corresponding HARQ retransmission of the PUSCH would fall inside such inactivity period).

For example, higher layer signaling or a DL WUS/LP-WUS/PDCCH-based WUS can indicate whether retransmissions of CG PUSCH are enabled or disabled or expected during PDCCH skipping duration or start of DRX non-active time, or start of the dormant state of the UE/cell/carrier/TRP.

In another example, the UE can be predetermined or configured or indicated by a DL WUS/LP-WUS/PDCCH-based WUS that the UE continues to monitor PDCCH according to first search space sets or SSSGs that are associated with retransmissions of CG PUSCH or SPS PDSCH (and for example, not according to second search space sets or SSSGs that associated with dynamically scheduled PUSCHs). For example, the first search space sets or SSSGs are separate from the second search space sets or SSSGs.

For example, a UE can be predetermined or configured or indicated via L1/L2 signaling such as a DL WUS/LP-WUS/PDCCH-based WUS of radio parameters for receptions or transmissions during an inactivity timer, such as a PDCCH skipping duration, or a non-active time of a DRX operation, or a dormant state of a UE/cell/carrier/TRP. For example, when the UE monitors WUS during such inactivity time, the UE can operate with a reduced number of antennas/RF chain or a subset of antennas/RF chains or a reduced transmit/receive power level compared to an Active time, such as Active time of the DRX operation, or after completion or termination of PDCCH skipping, or during a non-dormant state of a UE/cell/carrier/TRP. For example, such radio parameters can apply to various DL/UL transmissions. For example, when the UE receives DL WUS/LP-WUS/PDCCH-based WUS, the UE can receive SPS PDSCH or receives SSB or CSI-RS or PDCCH when/as applicable or generally any DL signal or channel (respectively, transmits CG PUSCH or PRACH or PUCCH or SRS or generally any UL signal or channel) with a first number of antennas/RF chains and with a first power level. For example, when the stops or suspends reception of a DL WUS/LP-WUS/PDCCH-based WUS, the UE can receive SPS PDSCH or PDCCH or receive SSB or CSI-RS or generally any DL signal or channel (respectively, transmit CG PUSCH or PRACH or PUCCH or SRS or generally any UL signal or channel) with a second number of antennas/RF chains and with a second power level, wherein the second number/level is larger than the first number/level. For example, a maximum number of Rx antennas during DL WUS reception can be 1 or 2, while a maximum number of Rx antennas during wake-up can be 2 or 4 or 8. For example, a maximum number of Tx antennas during DL WUS reception can be 1, while a maximum number of Tx antennas during wake-up can be 2 or 4. For example, such values can be separate UE capabilities for Tx and Rx antennas. Similar for Tx/Rx power levels.

In one embodiment, transmission of a PUSCH, at least including a configured-grant PUSCH (CG PUSCH), can result in terminating a previously indicated PDCCH skipping and resuming PDCCH monitoring to monitor possible grants for a HARQ retransmission of the PUSCH/CG PUSCH. The UE resumes such PDCCH monitoring starting from a first slot that is after a certain time after the PUSCH/CG PUSCH transmission. The certain time can be based on HARQ-related timers, such as drx-HARQ-RTT-TimerUL. In addition, such termination of PDCCH skipping to monitor possible grants for retransmissions of CG PUSCH can be enabled or disabled by RRC signaling, and may or may not apply to PDCCH other than that for scheduling retransmission of CG-PUSCH, such as PDCCH for scheduling dynamically scheduled PUSCH or for scheduling PDSCH.

For example, when a UE:
is provided an indication for PDCCH skipping for a time duration; and
transmits a PUSCH, such as a CG PUSCH, before or (if applicable) during the indicated time duration, such that the UE may [expect to] receive a DCI format scheduling a HARQ retransmission of the PUSCH (such as CG PUSCH) during the indicated time duration,
   the UE can terminate the PDCCH skipping and resume the PDCCH monitoring starting from a first slot that is after a certain time after the PUSCH (such as CG PUSCH) transmission.

For example, the PUSCH transmission correspond to a CG PUSCH transmission occasion that is within a time duration that is indicated for PDCCH skipping. For example, the PUSCH transmission can correspond to a CG PUSCH transmission occasion that is before the time duration that is indicated for PDCCH skipping, while one or both of an uplink HARQ round-trip time (UL HARQ RTT) and a timing for scheduling a HARQ retransmission of the CG PUSCH can result in PDCCH monitoring occasions that are within the time duration indicated for PDCCH skipping.

For example, the PUSCH transmission can correspond to a PUSCH that is scheduled by a scheduling DCI format, such as DCI format 0_0/0_1/0_2/0_3 in 5G NR, provided in a PDCCH received before the time duration indicated for PDCCH skipping. For example, the PUSCH transmission can be before the time duration for PDCCH skipping. For example, the PUSCH transmission can be, if supported or enabled, within the time duration for PDCCH skipping. For example, one or both of a uplink HARQ round-trip time (UL HARQ RTT) and a timing for scheduling a HARQ retransmission of the PUSCH can result in PDCCH monitoring occasions that are within the time duration indicated for PDCCH skipping.

In one option, the UE can terminate a previously indicated PDCCH skipping and resume PDCCH monitoring starting from a first/earliest slot (or a first/earliest symbol) that is after a last/ending symbol of the PUSCH (such as CG PUSCH) transmission.

In another option, the UE can start an UL HARQ RTT timer, such as drx-HARQ-RTT-TimerUL, for a corresponding HARQ process in a first/earliest slot (or symbol) after a last/ending symbol of the PUSCH transmission. For example, the UE can terminate a previously indicated PDCCH skipping and resume PDCCH monitoring starting from a first/earliest slot (or a first/earliest symbol) that is after the expiry of drx-HARQ-R TT-Timer UL.

For example, when the PUSCH transmission is transmitted in a bundle, such as with a number of repetitions, the last/ending symbol of the PUSCH transmission can be one of: a last/ending symbol of a first/earliest transmission within the bundle of PUSCH transmissions; or a last/ending symbol of a last/latest transmission within the bundle of PUSCH transmissions. For example, the specifications of system operation can predetermine the one, or higher layer signaling (e.g., x-LastTransmissionUL that is applicable only to PDCCH skipping or that is jointly applicable to both PDCCH skipping and DRX) can indicate the one.

For example, such termination of PDCCH skipping and resumption of PDCCH monitoring can be predetermined in the specifications of system operation, or can be enabled or disabled by higher layer signaling, such as disableCG-RetransmissionMonitoring, that is applicable only to PDCCH skipping or that is jointly applicable to both PDCCH skipping and DRX. For example, when such RRC IE is specified and not configured (or provided with value ‘false’), the UE does not terminate a previously indicated PDCCH skipping as previously described, or the UE does not start the drx-HARQ-RTT-TimerUL for the corresponding PUSCH/CG PUSCH transmission.

In one embodiment, when termination of PDCCH skipping to monitor possible grants for retransmissions of a PDSCH reception on a serving cell, at least including an SPS PDSCH, is enabled by RRC signaling, and if the UE does not successfully decode the PDSCH reception, the UE terminates the PDCCH skipping, starting from the beginning of a first slot that is after an expiry of a HARQ RTT timer, such as drx-HARQ-RTT-TimerDL, for a HARQ process associated with the PDSCH reception.

For example, when the UE is provided pdcchMornitoringResumptionAfterNack, after the UE detects a DCI format providing the PDCCH monitoring adaptation field indicating to the UE to skip PDCCH monitoring for the duration on the active DL BWP of the serving cell, if the UE transmits a PUCCH or a PUSCH providing a NACK value associated with a PDSCH reception that is scheduled by a DCI format in a PDCCH reception on the serving cell, the UE:
starts a HARQ RTT timer, such as drx-HARQ-RTT-TimerDL (that is applicable only to PDCCH skipping or that is jointly applicable to both PDCCH skipping and DRX), for a HARQ process associated with the PDSCH reception;
terminates PDCCH skipping, starting from the beginning of a first slot that is after an expiry of drx-HARQ-RTT-TimerDL.

Such method can be beneficial, for example, to avoid early termination of the PDCCH skipping, by considering a HARQ RRT time, and resuming the PDCCH monitoring only after an expected HARQ RTT time. It is noted that, drx-HARQ-RTT-TimerDL can be, for example, up to 56 symbols for lower SCS configurations, or up to 448 symbols for higher SCS configurations, such as 480 kHz or 960 kHz.

Such method may apply to SPS PDSCH, such as when a UE receives an SPS PDSCH reception within a PDCCH skipping duration. For example, the SPS PDSCH is activated by RRC or by an activation DCI format before the PDCCH skipping duration.

For example, the method may apply when an SPS PDSCH reception is before a PDCCH skipping duration, while one or both of a downlink HARQ round-trip time (DL HARQ RTT) and a timing for reception of a scheduling DCI for a HARQ retransmission of the SPS PDSCH can result in PDCCH monitoring occasions that are within the PDCCH skipping duration.

For example, the method may apply to a PDSCH reception that is scheduled by a DCI format before a PDCCH skipping duration, while one or both of a DL HARQ RTT and a timing for reception of a scheduling DCI for a HARQ retransmission of the PDSCH can result in PDCCH monitoring occasions that are within the PDCCH skipping duration. In another example, the UE expects that a value configured for the drx-InactivityTimer is not smaller than a sum of a value configured for drx-HARQ-RTT-TimerDL and a value configured for drx-RetransmissionTimerDL. Accordingly, PDCCH monitoring in such case is guaranteed, and no UE procedure based on HARQ-related timers is needed.

In one example, after a PUSCH (such as a PUSCH scheduled by a DCI format or a CG PUSCH) is successfully received by the gNB, the UE can receive a DCI format that schedules a retransmission of a last TB of the PUSCH (even though that was correctly received) and also indicates PDCCH skipping afterwards. In another example, the UE can receive a DCI format that does not schedule any PUSCH transmission/retransmission (or does not schedule a PDSCH reception) and indicates PDCCH skipping after reception of the DCI format.

In one embodiment, the specifications of system operation can predetermine that, a DRX Active time can be extended in response to a negative acknowledgement (NACK) for a PDSCH reception (such as SPS PDSCH), and not extended in response to a positive acknowledgement (ACK) associated with a PDSCH reception.

For example, when DRX is configured, the Active Time for Serving Cells in a DRX group includes (among other time duration corresponding to other conditions) the time while: drx-RetransmissionTimerDL, drx-RetransmissionTimerUL or drx-RetransmissionTimerSL is running on any Serving Cell in the DRX group.

For example, when the UE receives a PDSCH and does not successfully decode the PDSCH, the UE transmits an UL channel such as a PUCCH or a PUSCH that provides a NACK for the PDSCH, and the UE starts a drx-HARQ-RTT-TimerDL timer for a corresponding HARQ process upon finishing the transmission of the UL channel. For example, the UE starts a drx-RetransmissionTimerDL timer for the corresponding HARQ timer upon expiry of the corresponding drx-HARQ-RTT-TimerDL timer. For example, upon start of the corresponding drx-RetransmissionTimerDL timer, the UE is inside/within DRX Active time.

For example, when the UE receives and successfully decodes a PDSCH, the UE transmits an UL channel such as a PUCCH or a PUSCH that provides an ACK for the PDSCH, and the UE does not start a drx-HARQ-RTT-TimerDL timer for a corresponding HARQ process.

For example, when DRX is configured, the MAC entity shall:
1> if a MAC PDU is received in a configured downlink assignment for unicast, and if the data of the corresponding HARQ process/MAC PDU was not successfully decoded:
   2> start the drx-HARQ-RTT-TimerDL for the corresponding HARQ process in the first symbol after the end of the corresponding transmission carrying the DL HARQ feedback.
1> if a drx-HARQ-RTT-TimerDL expires:
   2> start the drx-RetransmissionTimerDL for the corresponding HARQ process in the first symbol after the expiry of drx-HARQ-RTT-TimerDL.

Such UE behavior applies at least to SPS PDSCH reception that has configured downlink assignment with SPS PDSCH occasions that can be outside/before DRX Active time or during DRX Active time.

For example, such UE behavior can also apply to a PDSCH reception that is scheduled by a DCI format that the UE receives within DRX Active time, and a corresponding PDSCH reception is outside/after DRX Active time, as a corresponding HARQ retransmission can be scheduled by a DCI format that resumes a DRX Active time based on DRX HARQ-related timers, as previously described. In another example, the UE expects that a value configured for the drx-InactivityTimer is not smaller than a sum of a value configured for drx-HARQ-RTT-TimerDL and a value configured for drx-RetransmissionTimerDL. Accordingly, PDCCH monitoring in such case is guaranteed, and no UE procedure based on HARQ-related timers is needed.

In one embodiment, outside DRX Active time or within a PDCCH skipping duration, a UE may suspend reception of DL reference signals or DL channels or transmission of UL reference signals or UL channels that are configured on (an active DL/UL BWP of) a cell, such as a serving cell (or a non-serving cell) for the UE. Such disabling can facilitate a broader framework for UE power saving, beyond only PDCCH monitoring, wherein various radio/PHY components can be set to power saving mode (e.g., low-power or turned off) in a time interval that can be referred to as a “dormant period”. Such disabling can apply to all or certain DL/UL reference signals or channels, with all or certain usage or configuration or associated with certain UE procedures. Such disabling can be predetermined in the specifications of system operation or can be configured by higher layer signaling or can be indicated by L1/L2 signaling. Methods for disabling DL/UL reference signals are subsequently described herein, and methods for disabling DL/UL channels are subsequently described herein.

For example, such dormant period can be extended to a general state for a UE/carrier/cell/TRP, wherein the state can be in various domains such as time or frequency domain or spatial domain or power domain or code/sequence domain. For example, the UE can switch OFF or deactivate or disable certain spatial directions, such as sync signal/SSB index or spatial beams or TCI states. For example, the UE may not receive corresponding SSB indexes or PDCCH/CORESETs associated with such TCI states or may not perform CSI-RS reception or measurement or CSI reporting associated with such SSB indexes or such TCI states or may not receive SPS PDSCH or CG PUSCH associated with such SSB indexes or TCI states. For example, the UE may not perform one or more of BFR/RLM/RLF measurements associated with such SSB indexes or TCI states. For example, such deactivation or disabling may or may not also apply to RRM measurements or to reception of system information or paging or broadcast PDCCH. For example, when the UE is supported to receive or transmit along such spatial directions, adaptation can be applied, such as a reduced value for a maximum number of layers or rank for PDSCH reception or for PUSCH transmission.

For example, higher layer signaling such as ssb-PositionsInBurst or L1/L2 signaling such as DL WUS/LP-WUS/PDCCH-based WUS can indicate which SSB indexes or TCI states or spatial directions are deactivated or disabled in a spatial dormancy state of a UE/cell/carrier/TRP.

For such operation state for cell/carrier/TRP can be UE-specific or can be UE-group-specific or can be cell-specific, or can be based on trigger conditions, or UE assistance information, such as buffer, PHR, battery level, traffic type (e.g., bursty traffic). For example, adaptation of DL/UL signals or channels in different operation states of a UE/cell/carrier/TRP can be associated with different number of repetitions or different time/frequency resources for the respective signals or channels.

For example, the UE can be configured a number of states, such as 2 or 4 operation states, wherein configuration for each state provides information of which DL/UL signals or channels are enabled or disabled, and which DL/UL signals or channels are adapted, for example, transmitted or received with different/reduced number of antennas/power levels/beams/number of repetitions/reduced resources, and so on, and corresponding parameters for various DL/UL signals or channels, such as applicable periodicity, (maximum) modulation order, (maximum) rank, and so on. For example, L1/L2 signaling such as a PDCCH/DCI format or a DL WUS/LP-WUS/PDCCH-based WUS can indicate a state from the number of (2 o 4) configured states. For example, the UE starts to operate based on the cell/carrier/TRP state from an application time after reception of the L1/L2 signaling or corresponding HARQ-ACK feedback that the UE transmits on an UL channel.

Such methods can be beneficial, for example, to develop DRX or PDCCH skipping as a general framework for UE power saving that is not limited only to PDCCH skipping. For example, if the UE suspends PDCCH monitoring due to DRX or PDCCH skipping, while still keeping the radios/RF chain/antennas ‘awake’ and running for reception or transmission of certain DL/UL signals or channels, a resulting UE power saving from no PDCCH monitoring may be limited. Therefore, the specifications of system operation can specify that the UE does not receive or transmit such DL/UL signals or channels. Alternatively, various signaling associated with the DRX procedure (or its adaptation, such as DCP or LP-WUS), or associated with PDCCH skipping can enable or disable some or all such DL/UL signals or channels, thereby adapting the UE power saving. As such, DRX or PDCCH skipping can be referred to as a generic ‘time-domain dormancy’ state or mode of operation or a ‘dormant period’ for a UE (beyond only PDCCH monitoring or not monitoring), that can also be associated with L1/L2 signaling, referred to as L1/L2-triggered dormancy (LTD). Such dormancy state can be extended to other domains, such as frequency, spatial, and code domain, for example, for a unified framework of joint dormancy in different domains.

Such methods can be also beneficial, for example, because disabling of the transmission of UL signals or channels can provide network energy saving (NES).

In one example, the UE can be configured a number of “dormancy states” for DRX or for PDCCH skipping or for any other “dormant period”, wherein there is an association among the dormancy states and the set of signals or channels that can be disabled or skipped during the dormant period. For example, the UE skips first UL/DL signals or channels in the dormant period when a corresponding dormancy state is a first dormancy state, and the UE skips second UL/DL signals or channels in the dormant period when a corresponding dormancy state is a second dormancy state. For example, the UE does not skip CG PUSCH and SPS PDSCH in the first dormancy state, while the UE skips CG PUSCH and SPS PDSCH in the second dormancy state. For example, the association is predetermined in the specifications of system operation or can be configured by higher layers. For example, an applicable dormancy state can be provided in higher layer configuration for the DRX or for PDCCH skipping, or can be indicated by L1/L2 signaling, such as by a DCI format 2_6 with PS-RNTI or an LP-WUS that indicates no-wake-up for the next DRX cycle. For example, the UE can operate with more than one DRX configurations, each with separate DRX parameters and with a separate dormancy state. For example, a PDCCH adaptation field in a scheduling DCI format or a stand-alone DCI format such as a GC-DCI format that indicates PDCCH skipping can also indicate a dormancy state applicable to the PDCCH skipping duration.

In one embodiment, outside DRX Active time or within a PDCCH skipping duration, a UE may suspend reception of some CSI-RS resources or resource sets (or corresponding CSI reporting) or transmission of some SRS resources or resource sets configured on (an active DL/UL BWP of) a cell, such as a serving cell (or a non-serving cell) for the UE. Such disabling or enabling/triggering of CSI-RS reception/reporting or SRS transmission can be predetermined in the specifications of system operation, or can be based on higher layer signaling such as RRC, or can be based on L1/L2 signaling, for example, by a GC-DCI format for adaptation of DRX procedure, such as a DCI format 2_6 with CRC scrambled by PS-RNTI (DCP), or by a same DCI format that indicates PDCCH skipping, or by an LP-WUS. When CSI-RS/SRS is disabled for a certain UE procedure, the UE may cease performing the procedure, or the UE may perform the procedure using other reference signals, such as SSB(s) associated with the disabled CSI-RS/SRS, or other reference signals/SSB indexes (or OD-SSB, or aperiodic CSI-RS, or periodic or aperiodic TRS, or DL positioning RS “PRS”) that are indicated by higher layer or RRC signaling, for example, a same signaling that was used for disabling the CSI-RS/SRS, such as a DL WUS/LP-WUS/PDCCH-based WUS.

It can be specified or higher layer/L1/L2 signaling can indicate which measurement modes or which transmission/reception modes are enabled or disabled in the aforementioned time durations, such as one or more of periodic CSI reporting, semi-persistent reporting, aperiodic CSI reporting (including one or more purpose, such as CSI reporting for link adaptation, or for beam management, or for antenna/carrier switching, and so on) or one or more of CSI-RS for CSI or CSI-RS for tracking reference signal (TRS) or SRS.

In addition, it can be specified or higher layer/L1/L2 signaling can indicate whether such disabling or adaptation applies to the target cell/carrier for such transmission or reception and/or to source cell/carrier for triggering or initiating such disabling or adaptation.

In one example, disabling or adaptation of CSI-RS reception or CSI reporting or SRS transmission applies to a first cell (or a first cell group) regardless of which cell initiates or triggers such CSI-RS reception or CSI reporting or SRS transmission.

In another example, disabling or adaptation of such CSI-RS reception or CSI reporting or SRS transmission on a first cell (or a first cell group) applies when triggered or initiated by the first cell (or a cell in the first cell group), while not applicable, i.e., enabled or not adapted, when triggered or initiated by a second cell (or a cell in a second cell group), or vice versa.

For example, cross-cell disabling can apply for various DL/UL signals or channels, wherein the UE receives an indication for such disabling on a first cell, while the indication for such disabling applies to a second cell. For example, the disabling can be provided by L1/L2 signaling such as by a DL WUS/LP-WUS/PDCCH-based WUS, or generally by a PDCCH/DCI format.

For example, such disabling of DL/UL signals or channels can be based on NW trigger or can be initiated by UE trigger, such as when an UL buffer of a UE is empty and the UE intends to save power by disabling certain transmissions or receptions. For example, the UE trigger or request can be via a PUCCH transmission or a PRACH transmission or by providing assistance information to the gNB, such as buffer status, or power status, and so on.

For example, such disabling of CSI-RS or SRS applies at least when such reference signals are associated with (non-configured) PDSCH receptions or PUSCH transmissions.

For example, outside DRX Active time or during PDCCH skipping, the UE may not expect to receive CSI-RS resources or resource sets configured, at least, for CSI reporting, such as semi-persistent CSI (SP CSI) reporting and possibly also periodic CSI reporting.

For example, a UE does not expect to receive semi-persistent CSI-RS (SP CSI-RS) resources or resource sets outside DRX Active time or within a PDCCH skipping duration, at least when the SP CSI-RS resources or resource sets are configured for CSI reporting on PUCCH or PUSCH. In one example, such UE behavior may hold for SP CSI-RS resources or resource sets with other configured usage, including for example, SP CSI-RS for beam management. For example, the UE may assume that an SP CSI-RS configuration (or corresponding PUCCH for SP CSI reporting) is deactivated outside DRX Active time or within a PDCCH skipping duration, such as after the DRX Active time (in the DRX cycle) is complete, for example, during a (short or) long DRX cycle, or is deactivated when a PDCCH skipping indication is received.

For example, different resources or resource sets can correspond to different UE/gNB panels, with or without multi-TRP, non-coherent joint transmission (NCJT), coherent joint transmission (CJT), multi-panel operation such as simultaneous transmission on multiple panels (sTxMP), and so on.

For example, a UE does not expect to receive first periodic CSI-RS resources or resource sets outside DRX Active time, at least when higher layer parameters such as ps-TransmitPeriodicL1-RSRP or ps-TransmitOtherPeriodicCSI are absent for a UE or are configured (e.g., with value ‘true’) to indicate disabling of periodic CSI reporting associated with the first periodic CSI-RS resources or resource sets. In one example, such UE behavior may hold for periodic CSI-RS resources or resource sets with other configured usage, including for example, SP CSI-RS for beam management.

For example, outside DRX Active time or during PDCCH skipping, the UE may not expect to transmit SRS resources or resource sets, such as periodic or semi-persistent SRS (P/SP SRS), that are associated, at least, with PUSCH transmission, such as codebook-based or non-codebook based PUSCH transmission. In one example, such UE behavior may hold for periodic SRS resources or resource sets with other configured usage, including for example, SRS for beam management or SRS for antenna/carrier switching.

For example, when a UE receives, within DRX Active time or before a PDCCH skipping duration, a DCI format that triggers aperiodic CSI (AP CSI) reporting on a PUSCH (wherein the PUSCH transmission is outside DRX Active time or within the PDCCH skipping duration), the UE may not expect the AP CSI reporting to be based upon aperiodic CSI-RS reception outside Active time or within the PDCCH skipping duration.

For example, a UE may receive a DCI format that triggers an aperiodic CSI (AP CSI) reporting on a PUSCH, wherein:
a PDCCH reception that provides the DCI format is within DRX Active time, such as before the DRX Active time (in a DRX cycle) is complete, for example, before entering a (short or) long DRX cycle, or the PDCCH reception is before reception of an indication for PDCCH skipping, and
the PUSCH transmission is outside DRX Active time, such as after the DRX Active time (in the DRX cycle) is complete, for example, during a (short or) long DRX cycle, or the PUSCH transmission is after receiving the indication for PDCCH skipping.

For example, a PDCCH skipping indication can indicate an offset value for the skipping duration, so that a DCI format for triggering AP CSI can also be received within such offset time (i.e., after PDCCH skipping indication, until PDCCH skipping duration starts).

For example, the UE does not expect such AP CSI report to depend upon measurements corresponding to (aperiodic) CSI-RS resource or resource sets that are outside Active time, such as after the DRX Active time (in the DRX cycle) is complete, for example, (aperiodic) CSI-RS reception during a (short or) long DRX cycle, or corresponding to (aperiodic) CSI-RS resource or resource sets that are within a PDCCH skipping duration. For example, the UE may determine such AP CSI report based on (aperiodic) CSI-RS resource or resource sets that are within Active time, for example, before a DRX Active time (in a DRX cycle) is complete, such as before entering a (short or) long DRX cycle, or based on (aperiodic) CSI-RS resource or resource sets that are before a duration for PDCCH skipping. For example, a DRX Active time can be based on SCI processing timeline.

For example, the UE may not expect to receive, within DRX Active time or before a PDCCH skipping duration, a DCI format that triggers aperiodic SRS transmission outside DRX Active time or within the PDCCH skipping duration.

For example, a UE may receive a DCI format that triggers aperiodic SRS (AP SRS) transmission, wherein:
a PDCCH reception that provides the DCI format is within DRX Active time, for example, before the DRX Active time (in a DRX cycle) is complete, such as before entering a (short or) long DRX cycle, or before reception of an indication for PDCCH skipping, and
the AP SRS transmission is outside DRX Active time, such as after the DRX Active time (in the DRX cycle) is complete, for example, during a (short or) long DRX cycle, or the AP SRS transmission is after receiving the indication for PDCCH skipping.

Disabling CSI-RS reception or SRS transmission can apply beyond purposes related to (link adaptation for) PDSCH reception or (beam/precoder selection for) PUSCH transmission. For example, the UE may not expect to receive, outside DRX Active time or within a PDCCH skipping duration, aperiodic CSI-RS/SRS resources or resource sets with other configured usage, including for example, aperiodic CSI-RS/SRS for beam management.

For example, for certain UE procedures, such as for setting UE's AGC, or for certain CSI-RS/SRS usage, such as RRM/RLF/mobility purposes or for antenna/carrier switching, the UE may (continue to) receive corresponding CSI-RS resources or resource sets or may (continue to) transmit corresponding SRS resources or resource sets, even outside DRX Active time or within a PDCCH skipping duration. In another example, CSI-RS reception or SRS transmission may be disabled even for such procedures or purposes.

Various approaches are provided for identification of such disabling of CSI-RS reception/reporting or SRS transmission.

In a first approach, various scenarios/conditions, methods and examples for disabling CSI-RS reception or SRS transmission, such as those previously described, can be predetermined in the specifications of system operation.

In a second approach, higher layer signaling such as RRC can enable or disable one or more of:
CSI-RS reception outside DRX Active time or within a PDCCH skipping duration; or
an application of CSI-RS receptions outside DRX Active time or within a PDCCH skipping duration for determination of a CSI report (e.g., AP CSI report), such as a CSI report on a PUSCH that is transmitted outside DRX Active time or within a PDCCH skipping duration; or
a PUSCH transmission (CG PUSCH or PUSCH scheduled by a DCI format) outside DRX Active time or within a PDCCH skipping duration that provides a CSI report (e.g., AP CSI report); or
SRS transmission outside DRX Active time or within a PDCCH skipping duration.

For example, such RRC-based enabling or disabling can be common (e.g., a single RRC parameter) for all of the one or more described purposes, or can be separate for each of the one or more described purposes. For example, such RRC signaling can provide information of the disabled CSI-RS or SRS, such as an applicable type (e.g., periodic or semi-persistent or aperiodic), or an applicable usage, (e.g., CSI reporting, codebook-based PUSCH, non-codebook-based PUSCH, beam management, RRM/RLF/mobility, antenna/carrier switching), or an applicable resource index or resource set index. For example, an RRC parameter for such disabling can be included in a respective configuration for the applicable CSI-RS or SRS.

For example, such RRC-based enabling and disabling of CSI-RS or SRS can be common (e.g., single RRC parameter) for both DRX procedure and PDCCH skipping, or separate RRC parameters can be configured for disabling in case of DRX and for disabling in case of PDCCH skipping.

For example, disabling in case of PDCCH skipping can apply when an indicated duration for PDCCH skipping is larger than a threshold. For example, corresponding CSI-RS receptions or SRS transmission are not disabled when the PDCCH skipping duration is smaller than a threshold. For example, such threshold can be configured by higher layers, or can be considered to be same as a short DRX cycle or a long DRX cycle, that is, drx-ShortCycle or drx-LongCycleStartOffset.

For example, when CSI-RS reception/reporting or SRS transmission is disabled by RRC signaling, the UE ignores a CSI request field or an SRS request field in a DCI format 0_1/0_2/0_3 or DCI format 1_1/1_2/1_3, or the UE assumes that such fields have zero bit-width in the DCI format.

In a third approach, L1/L2 signaling can enable or disable for CSI-RS reception/reporting, or SRS transmission, as previously described in the second approach.

For example, the indication can be one or both of a 1-bit flag for CSI-RS and a 1-bit flag for SRS, or a joint 1-bt flag can be used for both CSI-RS and SRS. For example, a value ‘1’ indicates enabled, and a value ‘0’ can indicate disabled. For example, the indication can include information of applicable type, usage, or index of CSI-RS or SRS resources or resources sets that are to be disabled, as previously described in the second approach.

For example, a scheduling DCI format, such as a DCI format 0_1/0_2/0_3 or DCI format 1_1/1_2/13, that indicates PDCCH skipping, such as by a PDCCH adaptation field, can also indicate such enabling or disabling of CSI-RS reception/reporting or SRS transmission.

For example, a DCI format, such as a DCI format 2_6 with CRC scrambled by PS-RNTI, can indicate whether CSI-RS reception/reporting or SRS transmission is enabled or disabled in a next DRX cycle or for any DRX cycle until a new indication is provided. For example, such indication can be present only when DCI format 2_6 indicates “no-wake-up” (or alternatively, only when DCI format 2_6 indicates “wake-up”).

For example, an LP-WUS (for a UE in RRC_CONNECTED state) can indicate ‘wake-up’ or ‘no-wake-up’ for PDCCH monitoring in a next DRX cycle, and can also indicate whether CSI-RS reception/reporting or SRS transmission is enabled or disabled in a next DRX cycle or for any DRX cycle until a new indication is provided. For example, such indication can be present only when LP-WUS indicates “no-wake-up” (or alternatively, only when LP-WUS indicates “wake-up”).

In various approaches, such as the first/second/third approach as previously described, when a UE is predetermined or configured by RRC or indicated by L1/L2 signaling to suspend certain CSI-RS reception/reporting or SRS transmission outside DRX Active time or within a PDCCH skipping duration, the UE may temporarily cases to perform a corresponding UE procedure associated with the certain CSI-RS reception (such as CSI reporting or beam management). Alternatively, the UE may perform certain corresponding UE procedures (such as RRM/RLF/mobility or beam management) based on other DL reference signals, such as SSB, for example, SSB(s) that are QCL with the disabled CSI-RS resources or resource sets. For example, higher layer or L1/L2 signaling that disables CSI-RS reception or SRS transmission can indicate information (e.g., index of resource or resource set) of a replacement RS, such as SSB index, that is to be used by the UE for performing such UE procedures.

The above methods can also apply to other DL/UL reference signals, such as positioning reference signal (PRS), SRS for positioning, tracking reference signal (TRS), phase-tracking reference signal (PTRS), and so on.

The above methods may also apply to certain SSB receptions, such as non-anchor SSB or on-demand SSB.

In one embodiment, outside DRX Active time or within a PDCCH skipping duration, a UE may suspend reception of DL channels such as SPS PDSCH (and corresponding HARQ-ACK transmission), or transmission of UL channels such as PUCCH (at least PUCCH with HARQ-ACK) or CG PUSCH that are configured on (an active DL/UL BWP of) a cell, such as a serving cell (or a non-serving cell) for the UE. Such disabling of DL/UL channels can be predetermined in the specifications of system operation, or can be based on higher layer signaling such as RRC, or can be based on L1/L2 signaling, for example, by an activation DCI format for SPS PDSCH or for CG PUSCH, or by a MAC-CE for activation of SP PUCCH, or by a GC-DCI format for adaptation of DRX procedure, such as a DCI format 2_6 with CRC scrambled by PS-RNTI (DCP), or by a same DCI format that indicates PDCCH skipping, or by an LP-WUS. When DL data channels (e.g., SPS PDSCH in addition to PDSCH receptions scheduled by a DCI format) are disabled for a UE, and there is DL traffic for the UE, the UE can be provided an L1/L2 signaling that terminates the DRX cycle or the PDCCH skipping duration. When both configured and scheduled data channels are disabled for a UE, and there is UL traffic for the UE, the DRX cycle or the PDCCH skipping duration may be terminated by the gNB, with or without UE request, or the UE/gNB may wait until the DRX cycle or the PDCCH skipping duration is completed. Above methods may not apply to certain essential UL/DL channels, such as PRACH, or such as PDCCH reception for scheduling and reception of system information, paging, random access response (RAR), that are also referred to as PDCCH monitoring according to CSS sets Type-0/0A/1/1A/2/2A in 5G NR, or such as PRACH.

In a first realization, outside DRX Active time or within a PDCCH skipping duration, a UE does not receive a SPS PDSCH or transmit a CG PUSCH on an associated cell, such as an associated serving cell (or a non-serving cell). For example, when an SPS PDSCH configuration or a CG PUSCH configuration is activated (by RRC signaling or by an activation DCI format) within a DRX Active time, or outside a PDCCH skipping indication duration, the UE may assume that the corresponding SPS PDSCH or CG PUSCH is deactivated.

For example, such deactivation of a corresponding SPS PDSCH or CG PUSCH configuration can start from a first symbol/slot after DRX Active time is completed or from a first symbol/slot that a PDCCH skipping duration starts.

In one option, such deactivation of a corresponding SPS PDSCH or CG PUSCH configuration can apply only outside DRX Active time or only within a PDCCH skipping duration, and the UE may assume that the corresponding SPS PDSCH or CG PUSCH configuration is re-activated in DRX Active time of a next DRX cycle, or after a PDCCH skipping duration is complete.

In another option, such deactivation of a corresponding SPS PDSCH or CG PUSCH configuration continues even in DRX Active time of a next DRX cycle, or after a PDCCH skipping duration is complete, until the UE receives an RRC signaling or a DCI format for re-activation of the SPS PDSCH or CG PUSCH configuration.

In a second realization, outside DRX Active time or within a PDCCH skipping duration, a UE does not transmit a PUCCH, at least when the PUCCH provides HARQ-ACK information for an associated cell, such as an associated serving cell (or a non-serving cell). For example, the UE may or may not transmit a PUCCH that provides a CSI report based on whether CSI-RS reception or CSI reporting is enabled or disabled for an associated cell, such as a serving cell in a same PUCCH group or an associated non-serving cell for mobility or LTM purposes.

For example, outside DRX Active time or within a PDCCH skipping duration, a UE may continue to transmit PUCCH for SR, when applicable, to indicate a presence of UL traffic.

For example, when PDCCH skipping is applied on a scheduling cell, the SPS PDSCH can be disabled on all scheduled cells that are configured to be scheduled by the scheduling cell. In another option, SPS PDSCH configurations on the scheduled cells can remain active within a PDCCH skipping duration.

Various approaches are provided for disabling of DL/UL channels.

In a first approach, such disabling of DL/UL channels, such as SPS PDSCH, CG PUSCH, and PUCCH, outside DRX Active time or within a PDCCH skipping duration, can be predetermined in the specifications of system operation, as previously described in the first and second realizations.

In a second approach, reception of DL channels or transmission of UL channels outside DRX Active time or within a PDCCH skipping duration can be enabled or disabled by higher layer signaling such as RRC configuration. For example, the UE can be provided an RRC information element (IE) within an SPS PDSCH configuration or within a CG PUSCH configuration that indicates whether a corresponding configuration is enabled or disabled outside DRX Active time or within a PDCCH skipping duration. For example, the UE can be provided an RRC IE within a PUCCH configuration that indicates whether a corresponding PUCCH is enabled or disabled outside DRX Active time or within a PDCCH skipping duration.

For example, such RRC-based disabling can be provided separately for each SPS PDSCH configuration on (an active BWP of) a cell or for each SPS PDSCH configuration on (an active BWP of) a cell, or a common RRC IE can be provided for different SPS PDSCH configurations on (an active BWP of) a cell or for different CG PUSCH configurations on (an active BWP of) a cell.

For example, such RRC-based disabling can be provided separately for each PUCCH resource or for each PUCCH resource set, or a common RRC IE can be provided for different PUCCH resources or for different PUCCH resource sets on (an active BWP of) a cell. For example, RRC disabling can apply only to periodic PUCCH resources or resource sets, or only to periodic and/or semi-persistent PUCCH resources or resource sets. In another example, RRC disabling also applies to aperiodic PUCCH resources or resource sets.

For example, such RRC-based disabling can be provided separately for each usage/purpose of PUCCH, such as PUCCH providing HARQ-ACK or PUCCH providing CSI or PUCCH providing SR. In another example, a common RRC IE can be provided for various usages/purposes of PUCCH. For example, a separate disabling of PUCCH for HARQ-ACK may not be provided, and the UE determines disabling of PUCCH for HARQ-ACK when the SPS PDSCH is disabled by RRC signaling. Such behavior can apply to a single cell or can be commonly applied to different cells in a PUCCH group.

In a third approach, reception of DL channels or transmission of UL channels outside DRX Active time or within a PDCCH skipping duration can be enabled or disabled by L1/L2 signaling, such as a DCI format or a MAC CE command.

For example, an activation DCI format for an SPS PDSCH configuration or for a CG PUSCH configuration can include a 1-bit flag to indicate whether the corresponding SPS PDSCH or CG PUSCH is to be deactivated or remain activated outside DRX Active time or within a PDCCH skipping duration.

For example, an DCI format or MAC-CE command for activation of a semi-persistent PUCCH (SP PUCCH) configuration/resource/resource set can include a 1-bit flag to indicate whether the corresponding SP PUCCH is to be deactivated or remain activated outside DRX Active time or within a PDCCH skipping duration.

For example, a GC-DCI format, such as a DCI format 2_6 associated with PS-RNTI that provides a wake-up or no-wake-up indication for a next (short or) long DRX cycle can also include one or more fields to indicate whether various SPS PDSCH configurations or CG PUSCH configurations or PUCCH configurations are to be deactivated or remain activated outside DRX Active time of the next (short or) long DRX cycle. Such field/indication can be same or separate for various SPS PDSCH/CG PUSCH/PUCCH configurations as previously described in the second approach.

For example, an LP-WUS (for a UE in RRC_CONNECTED state) can indicate ‘wake-up’ or ‘no-wake-up’ for PDCCH monitoring in a next DRX cycle, and can also indicate whether various SPS PDSCH configurations or CG PUSCH configurations or PUCCH configurations are to be deactivated or remain activated outside DRX Active time of the next (short or) long DRX cycle.

For example, a DCI format with PDCCH skipping indication, such as a UE-specific DCI format 0_1/0_2/0_3 or DCI format 1_1/1_2/1_3 with a PDCCH skipping indication field, can also include one or more fields to indicate whether various SPS PDSCH configurations or CG PUSCH configurations or PUCCH configurations are to be deactivated or remain activated within an indicated PDCCH skipping duration, with separate or common indication, as in the second approach.

For example, such additional indication, for disabling SPS PDSCH/CG PUSCH/PUCCH, in an activation DCI format or in a DCI format 2_6 or a DCI format with PDCCH skipping indication can be provided as separate fields, or can be a single field providing a codepoint that provides multiple indications jointly, such as a joint encoding of wake-up/no-wake with the disabling of UL/DL channels, or a joint encoding of a PDCCH skipping duration with the disabling of UL/DL channels.

For example, outside DRX Active time or within a PDCCH skipping duration, if:
DL data channels (such as SPS PDSCH in addition to PDSCH receptions scheduled by a DCI format) are disabled for a UE, and
there is DL traffic for the UE,
   the UE can be provided an L1/L2 signaling, such as an LP-WUS or a GC-DCI format, that terminates the DRX cycle or the PDCCH skipping duration. For example, such disabling can be configured by higher layers.

For example, outside DRX Active time or within a PDCCH skipping duration, if:
UL data channels (such as CG PUSCH, in addition to PUSCH transmissions scheduled by a DCI format) are disabled for a UE, and
there is UL traffic for the UE,
   the UE can transmit a PUCCH with SR, if enabled, or a PRACH for SR to terminate the DRX cycle or the PDCCH skipping duration. For example, such disabling can be configured by higher layers.

Such termination may apply at least when the DL/UL traffic has high priority or is latency-sensitive. For example, when the DL/UL traffic has low priority or is not latency-sensitive, the UE/gNB may wait until a start of a next DRX cycle, or until an indicated PDCCH skipping duration is complete.

For example, the UE may be allowed to cancel or discard an indication or determination for PDCCH skipping or for dormant state of a UE/cell/carrier/TRP when a respective time duration is less than a threshold, such a UE capability threshold for UE transition into dormant mode and transition out of dormant mode.

In one embodiment, a UE can receive an LP-WUS in two stages or two receptions, wherein the UE receives a first stage/reception in occasions/resources that are configured by higher layers, and with payload size/fields that are predetermined or configured by higher layers. The first stage/reception of LP-WUS can indicate whether the second stage/reception of LP-WUS is or is not present, and when indicated as present, can indicate parameters related to payload size/fields of the second stage/reception, or occasions/resources in which the UE can receive the second stage/reception, such as a time/frequency offset relative to the first stage/reception.

For example, time-frequency resources for the second stage WUS can be predetermined in the specifications, such as adjacent or with predetermine symbol/slot/RE/RB offset from the first stage WUS, or corresponding resources or offset values can be configured by higher layers such as SIB or RRC or can be indicated by L1/L2 signaling such as the first stage WUS. For example, the first stage WUS can be sequence-based DL WUS/LP-WUS. For example, the specifications of system operation can predetermine or higher layer signaling such as SUB or RRC can configure whether the second stage WUS is a sequence-based DL WUS/LP-WUS or a channel-coding-based WUS/PDCCH-based WUS. For example, the first stage WUS can provide information for a number of UEs or a number of cells/carriers/TRPs, while the second stage WUS can provide additional information (e.g., applicable SSSG, CORESET parameters, DRX parameters, Cell DTX/DRX parameters, PDCCH skipping parameters, signal or channel disabling or adaptation parameters, cell/carrier/TRP deactivation or adaptation, and so on) only for a subset of UEs/cells/carriers/TRPs, such as those that are indicated to wake-up in the first stage.

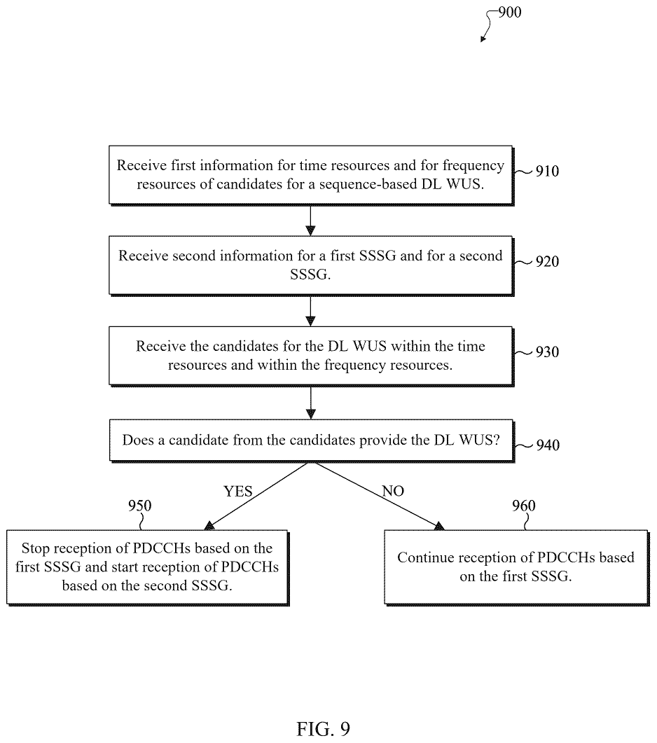

FIG. 9 illustrates an example method 900 performed by a UE in a wireless communication system according to embodiments of the present disclosure. The method 900 of FIG. 9 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 900 is for illustration only and other embodiments can be used without departing from the scope of the present disclosure.

The method 900 begins with the UE receiving first information for time resources and for frequency resources of candidates for a sequence-based DL WUS (910). The UE then receives second information for a first SSSG and for a second SSSG (920). The UE then receives the candidates for the DL WUS within the time resources and within the frequency resources (930).

The UE then determines whether a candidate from the candidates provides the DL WUS (940). When it is determined in (940) that the candidate provides the DL WUS, the UE stops reception of PDCCHs based on the first SSSG and starts reception of PDCCHs based on the second SSSG (950). When it is determined in (940) that the candidate does not provide the DL WUS, the UE continues reception of PDCCHs based on the first SSSG (960).

In various embodiments, the UE may also stop reception of the candidates for the DL WUS when the candidate provides the DL WUS and continue reception of the candidates for the DL WUS when the candidate does not provide the DL WUS.

In various embodiments, the UE receives a PDCCH based on the second SSSG that provides DCI. The UE may also start reception of the candidates for the DL WUS when the DCI indicates to stop reception of PDCCHs based on the second SSSG and to start reception of PDCCHs based on the first SSSG, and skips reception of the candidates for the DL WUS when the DCI indicates to continue reception of PDCCHs based on the second SSSG.

In various embodiments, the UE receives third information for a first CORESETs and for a second group of CORESETs. The candidate provides the DL WUS. The DL WUS provides an indication. PDCCHs are received in the first group of CORESETs when the indication has a first value. PDCCHs are received in both the first group of CORESETs and the second group of CORESETs when the indication has a second value.

In various embodiments, the UE receives a first signal or channel in first time resources based on a first number of antennas and receives a second signal or channel in second time resources based on a second number of antennas. The first time resources are prior to reception of the candidate, and the second time resources are after reception of the candidate. The first number of antennas is smaller than the second number of antennas. The candidate provides the DL WUS.

In various embodiments, the UE starts reception of a SPS PDSCH after reception of the candidate and the candidate provides the DL WUS.

In various embodiments, the UE transmits a channel that provides a ACK associated with reception of the candidate that provides the DL WUS. The reception of PDCCHs starts at a first symbol or slot that is N symbols or slots, respectively, after a last symbol or slot of the channel. A value of Nis predetermined or provided by higher layers or reported by a UE capability.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE), the method comprising:
receiving first information for time resources and for frequency resources of candidates for a sequence-based downlink wake-up signal (DL WUS);
receiving second information for a first search space set group (SSSG) and for a second SSSG;
receiving the candidates for the DL WUS within the time resources and within the frequency resources;
determining whether a candidate from the candidates provides the DL WUS;
stop physical downlink control channel (PDCCH) receptions based on the first SSSG and start PDCCH receptions based on the second SSSG, when the candidate provides the DL WUS, and
continue the PDCCH receptions based on the first SSSG when the candidate does not provide the DL WUS.

2. The method of claim 1, further comprising:
stop receiving the candidates for the DL WUS when the candidate provides the DL WUS; and
continue receiving the candidates for the DL WUS when the candidate does not provide the DL WUS.

3. The method of claim 1, further comprising:
receiving a PDCCH based on the second SSSG, wherein the PDCCH provides downlink control information (DCI);
start receiving the candidates for the DL WUS when the DCI indicates (a) to stop the PDCCH receptions based on the second SSSG and (b) to start the PDCCH receptions based on the first SSSG; and
skip receiving the candidates for the DL WUS when the DCI indicates to continue the PDCCH receptions based on the second SSSG.

4. The method of claim 1, further comprising:
receiving third information for a first group of control resource sets (CORESETs) and for a second group of CORESETs, wherein:
the candidate provides the DL WUS,
the DL WUS provides an indication,
the PDCCHs receptions based on the first SSSG are in the first group of CORESETs when the indication has a first value, and
the PDCCHs receptions based on the second SSSG are in both the first group of CORESETs and the second group of CORESETs when the indication has a second value.

5. The method of claim 1, further comprising:
receiving a first signal or channel in first time resources based on a first number of antennas; and
receiving a second signal or channel in second time resources based on a second number of antennas, wherein:
the first time resources are prior to receiving the candidate and the second time resources are after receiving the candidate,
the first number of antennas is smaller than the second number of antennas, and
the candidate provides the DL WUS.

6. The method of claim 1, further comprising:
start receiving a semi-persistent physical downlink shared channel (SPS PDSCH) after receiving the candidate, wherein the candidate provides the DL WUS.

7. The method of claim 1, further comprising:
transmitting a channel that provides a positive acknowledgment (ACK) associated with reception of the candidate, wherein:
the candidate provides the DL WUS,
the PDCCH receptions based on the first or second SSSG start at a first symbol or slot that is N symbols or slots, respectively, after a last symbol or slot of the channel, and
a value of N is predetermined or provided by higher layers or reported by a UE capability.

8. A user equipment (UE) comprising:
a transceiver configured to:
receive first information for time resources and for frequency resources of candidates for a sequence-based downlink wake-up signal (DL WUS),
receive second information for a first search space set group (SSSG) and for a second SSSG, and
receive the candidates for the DL WUS within the time resources and within the frequency resources; and
a processor operably coupled with the transceiver, the processor configured to determine whether a candidate from the candidates provides the DL WUS,
wherein the transceiver is further configured to:
stop physical downlink control channels (PDCCH) receptions based on the first SSSG and start of PDCCH receptions based on the second SSSG, when the candidate provides the DL WUS, and
continue the PDCCH receptions based on the first SSSG when the candidate does not provide the DL WUS.

9. The UE of claim 8, wherein the transceiver is further configured to:
stop reception of the candidates for the DL WUS when the candidate provides the DL WUS, and
continue reception of the candidates for the DL WUS when the candidate does not provide the DL WUS.

10. The UE of claim 8, wherein the transceiver is configured to:
receive a PDCCH based on the second SSSG, wherein the PDCCH provides downlink control information (DCI);
start reception of the candidates for the DL WUS when the DCI indicates (a) to stop the PDCCH receptions based on the second SSSG and (b) to start the PDCCH receptions based on the first SSSG; and
skip reception of the candidates for the DL WUS when the DCI indicates to continue the PDCCH receptions based on the second SSSG.

11. The UE of claim 8, wherein:
the transceiver is further configured to receive third information for a first group of control resource sets (CORESETs) and for a second group of CORESETs,
the candidate provides the DL WUS,
the DL WUS provides an indication,
the PDCCHs receptions based on the first SSSG are in the first group of CORESETs when the indication has a first value, and
the PDCCHs receptions based on the second SSSG are in both the first group of CORESETs and the second group of CORESETs when the indication has a second value.

12. The UE of claim 8, wherein:
the transceiver is further configured to:
receive a first signal or channel in first time resources based on a first number of antennas, and
receive a second signal or channel in second time resources based on a second number of antennas,
the first time resources are prior to reception of the candidate and the second time resources are after reception of the candidate,
the first number of antennas is smaller than the second number of antennas, and
the candidate provides the DL WUS.

13. The UE of claim 8, wherein:
the transceiver is further configured to start reception of a semi-persistent physical downlink shared channel (SPS PDSCH) after reception of the candidate, and
the candidate provides the DL WUS.

14. The UE of claim 8, wherein:
the transceiver is further configured to transmit a channel that provides a positive acknowledgment (ACK) associated with reception of the candidate,
the candidate provides the DL WUS,
the PDCCH receptions based on the first or second SSSG start at a first symbol or slot that is N symbols or slots, respectively, after a last symbol or slot of the channel, and
a value of N is predetermined or provided by higher layers or reported by a UE capability.

15. A base station comprising:
a transceiver configured to:
transmit first information for time resources and for frequency resources of candidates for a sequence-based downlink wake-up signal (DL WUS),
transmit second information for a first search space set group (SSSG) and for a second SSSG, and
transmit the candidates for the DL WUS within the time resources and within the frequency resources; and
a processor operably coupled with the transceiver, the processor configured to:
determine whether a candidate from the candidates provides the DL WUS;
wherein the transceiver is further configured to:
stop physical downlink control channels (PDCCH) transmissions based on the first SSSG and start PDCCH transmissions based on the second SSSG, when the candidate provides the DL WUS, and
continue the PDCCH transmissions based on the first SSSG when the candidate does not provide the DL WUS.

16. The base station of claim 15, wherein the transceiver is further configured to:
stop transmission of the candidates for the DL WUS when the candidate provides the DL WUS, and
continue transmission of the candidates for the DL WUS when the candidate does not provide the DL WUS.

17. The base station of claim 15, wherein the transceiver is configured to:
transmit a PDCCH based on the second SSSG, wherein the PDCCH provides downlink control information (DCI);
start transmission of the candidates for the DL WUS when the DCI indicates (a) to stop the PDCCH transmissions based on the second SSSG and (b) to start the PDCCH transmissions based on the first SSSG; and
skip transmission of the candidates for the DL WUS when the DCI indicates to continue the PDCCH transmissions based on the second SSSG.

18. The base station of claim 15, wherein:
the transceiver is further configured to transmit third information for a first group of control resource sets (CORESETs) and for a second group of CORESETs,
the candidate provides the DL WUS,
the DL WUS provides an indication,
the PDCCHs transmissions based on the first SSSG are in the first group of CORESETs when the indication has a first value, and
the PDCCHs transmissions based on the second SSSG are in both the first group of CORESETs and the second group of CORESETs when the indication has a second value.

19. The base station of claim 15, wherein:
the transceiver is further configured to:
transmit a first signal or channel in first time resources based on a first number of antennas, and
transmit a second signal or channel in second time resources based on a second number of antennas,
the first time resources are prior to transmission of the candidate and the second time resources are after transmission of the candidate,
the first number of antennas is smaller than the second number of antennas, and
the candidate provides the DL WUS.

20. The base station of claim 15, wherein:
the transceiver is further configured to start transmission of a semi-persistent physical downlink shared channel (SPS PDSCH) after transmission of the candidate, and
the candidate provides the DL WUS.
